(19) United States
(12) Patent Application Publication
(10) Pub. No.: US 2025/0016711 A1
(43) Pub. Date: Jan. 9, 2025

(54) METHOD OF UE, METHOD OF GEOGRAPHICALLY SELECTED AMF APPARATUS, UE, GEOGRAPHICALLY SELECTED AMF APPARATUS, AND METHOD OF COMMUNICATION TERMINAL

(71) Applicant: NEC Corporation, Minato-ku, Tokyo (JP)

(72) Inventors: Kundan TIWARI, Tokyo (JP); Toshiyuki TAMURA, Tokyo (JP); Iskren IANEV, Tokyo (JP)

(73) Assignee: NEC Corporation, Minato-ku, Tokyo (JP)

(21) Appl. No.: 18/697,516

(22) PCT Filed: Oct. 12, 2022
(86) PCT No.: PCT/JP2022/037967

§ 371 Date: Apr. 1, 2024

(30) Foreign Application Priority Data
Oct. 22, 2021 (IN) 202111048128

(51) Int. Cl. H04W 60/00; H04W 12/106; H04W 84/04

(52) U.S. Cl. CPC H04W 60/005; H04W 12/106; H04W 84/042

(57) ABSTRACT

The method includes sending a registration request message. The registration request message includes first 5G Globally Unique Temporary Identifier (5G-GUTI), a first Non-Access-Stratum (NAS) container, second 5G-GUTI, and a second NAS container. The first NAS container includes a first integrity protected registration request message. The first integrity protected registration request message is the registration request message which is integrity protected based on a first NAS security context. The second NAS container includes a second integrity protected registration request message. The second integrity protected registration request message is the registration request message which is integrity protected based on a second NAS security context.

### TECHNICAL FIELD

This present disclosure relates to a method of a UE, a method of a geographically selected AMF apparatus, a UE, a geographically selected AMF apparatus, and a method of a communication terminal.

### BACKGROUND ART

When a UE is registered to a PLMN over 3GPP access and non-3GPP access, in this case the UE is registered to a same AMF. When a UE is registered to two different PLMNs over 3GPP access and non-3GPP access, in this case the UE is registered to two different AMFs belonging to different PLMNs. The UE and a network maintain two independent 5GMM contexts and two independent 5GSM contexts, i.e. the UE and the network maintain 5GMM contexts and 5GSM contexts for the 3GPP access, and 5GMM contexts and 5GSM contexts for non-3GPP access. Services accessed over one access (e.g. 3GPP access) are independent from services accessed over another access (e.g. non-3GPP access). During mobility procedure when a UE moves from one registration area (e.g. old registration area) to another registration area (e.g. new registration area) or from one PLMN (e.g. an old PLMN) to another PLMN (e.g. a new PLMN), a UE context (e.g. 5GMM contexts or 5GSM contexts) are transferred from an old AMF serving the old registration area to a new AMF serving the new registration area when the old AMF successfully checks integrity of a NAS container that was transferred from the new AMF to the old AMF.

When a UE is registered to a PLMN via non-3GPP access only, then a N3IWF may choose a non-geographically selected AMF. Based on operator's policy, a GUAMI of an assigned 5-G-GUTI indicates whether the PLMN is served by non-geographically selected AMF or by geographically selected AMF. When the UE initiates registration procedure over 3GPP access while the UE has registered via the non-3GPP access with the non-geographically selected AMF, mobility from a non-geographically selected AMF to a geographically selected AMF is performed. In this case, for example during RRC connection establishment procedure, the UE sends, to a NG-RAN, a RRC setup complete message which includes a NAS registration request message including a 5G-GUTI. The NAS registration request message may be called as a registration request message in this disclosure. When the NG-RAN receives the 5G-GUTI and determines that the 5G-GUTI indicates the non-geographically selected AMF. Then the NG-RAN directs (or sends) the registration request message to a geographically selected AMF. In this case the geographically selected AMF initiates UE context transfer procedure with the non-geographically selected AMF. After the UE context transfer procedure is performed successfully at the geographically selected AMF, then the UE is registered with the geographically selected AMF over both the 3GPP access and the non-3GPP access.

### CITATION LIST

### Non Patent Literature

[NPL 1] 3GPP TR 21.905: “Vocabulary for 3GPP Specifications”. V16.0.0 (2019-06)
[NPL 2] GSM Association Official Document NG.116: “Generic Network Slice Template” V2.0 (2019-10)-https://www.gsma.com/newsroom/wp-content/uploads/NG.116-v2.0.pdf
[NPL 3] 3GPP TS 23.501: “System architecture for the 5G System (5GS)”. V17.2.0 (2021-09)
[NPL 4] 3GPP TS 23.502: “Procedures for the 5G System (5GS)”. V17.2.0 (2021-09).
[NPL 5] 3GPP TS 33.501: “Security architecture and procedures for 5G system” v 17.3.0 (2021-09)

### SUMMARY OF INVENTION

### Technical Problem

When a UE moves from one PLMN to another PLMN and mobility from a non-geographically selected AMF to a geographically selected AMF is performed, there is a case where the geographically selected AMF cannot obtain a UE context. This leads to loss of the services.

### Solution to Problem

In an aspect of the present disclosure, a method of a User Equipment (UE) includes initiating registration procedure. The method includes sending a registration request message. The registration request message includes first 5G Globally Unique Temporary Identifier (5G-GUTI), a first Non-Access-Stratum (NAS) container, second 5G-GUTI, and a second NAS container. The first NAS container includes a first integrity protected registration request message. The first integrity protected registration request message is the registration request message which is integrity protected based on a first NAS security context. The second NAS container includes a second integrity protected registration request message. The second integrity protected registration request message is the registration request message which is integrity protected based on a second NAS security context.

In an aspect of the present disclosure, a method of a geographically selected Access and Mobility Management Function (AMF) apparatus includes receiving a registration request message. The registration request message includes first 5G Globally Unique Temporary Identifier (5G-GUTI), a first Non-Access-Stratum (NAS) container, second 5G-GUTI, and a second NAS container. The first NAS container includes a first integrity protected registration request message which is integrity protected based on a first NAS security context. The second NAS container includes a second integrity protected registration request message which is integrity protected based on a second NAS security context. The method includes sending a first Namf_Communication_UEContextTransfer message. The first Namf_Communication_UEContextTransfer message includes the first 5G-GUTI and the first integrity protected registration request message. The method includes receiving a first Namf_Communication_UEContextTransfer response message. The first Namf_Communication_UEContextTransfer response message includes a first User Equipment (UE) context related to the first 5G-GUTI. The method includes sending a second Namf_Communication_UEContextTransfer message. The second Namf_Communication_UEContextTransfer message includes the second 5G-GUTI and the second integrity protected registration request message. The method includes receiving a second Namf_Communication_UEContextTransfer response message. The second Namf_Communication_UEContextTransfer response message includes a second UE context related to the second 5G-GUTI.

In an aspect of the present disclosure, a User Equipment (UE) includes means for initiating registration procedure. The UE includes means for sending a registration request message. The registration request message includes first 5G Globally Unique Temporary Identifier (5G-GUTI), a first Non-Access-Stratum (NAS) container, second 5G-GUTI, and a second NAS container. The first NAS container includes a first integrity protected registration request message. The first integrity protected registration request message is the registration request message which is integrity protected based on a first NAS security context. The second NAS container includes a second integrity protected registration request message. The second integrity protected registration request message is the registration request message which is integrity protected based on a second NAS security context.

In an aspect of the present disclosure, a geographically selected Access and Mobility Management Function (AMF) apparatus includes means for receiving a registration request message. The registration request message includes first 5G Globally Unique Temporary Identifier (5G-GUTI), a first Non-Access-Stratum (NAS) container, second 5G-GUTI, and a second NAS container. The first NAS container includes a first integrity protected registration request message which is integrity protected based on a first NAS security context. The second NAS container includes a second integrity protected registration request message which is integrity protected based on a second NAS security context. The geographically selected AMF apparatus includes means for sending a first Namf_Communication_UEContextTransfer message. The first Namf_Communication_UEContextTransfer message includes the first 5G-GUTI and the first integrity protected registration request message. The geographically selected AMF apparatus includes means for receiving a first Namf_Communication_UEContextTransfer response message. The first Namf_Communication_UEContextTransfer response message includes a first User Equipment (UE) context related to the first 5G-GUTI. The geographically selected AMF apparatus includes means for sending a second Namf_Communication_UEContextTransfer message. The second Namf_Communication_UEContextTransfer message includes the second 5G-GUTI and the second integrity protected registration request message. The geographically selected AMF apparatus includes means for receiving a second Namf_Communication_UEContextTransfer response message. The second Namf_Communication_UEContextTransfer response message includes a second UE context related to the second 5G-GUTI.

In an aspect of the present disclosure, a method of a communication terminal includes registering to first access in a first Public Land Mobile Network (PLMN). The method includes storing a first temporary identifier and a first Network Access Stratum (NAS) container for the first access related to a first core network apparatus in the first PLMN. The method includes registering to a second PLMN over second access. The method includes registering to the second PLMN over first access after the registration to the second PLMN over the second access. The method includes storing a second temporary identifier and a second NAS container for the second access related to a geographically selected core network apparatus in the second PLMN. The method includes sending, to the geographically selected core network apparatus, the first temporary identifier, the first NAS container, the second temporary identifier, and the second NAS container.

### BRIEF DESCRIPTION OF DRAWINGS

FIG. 1 is a signaling diagram of First aspect (Mobility procedure with AMF change, from non-geographically selected AMF to geographically selected AMF).

FIG. 2 is a signaling diagram of Second aspect (Combined registration procedure for a UE for 3GPP access and non-3GPP access).

FIG. 3 is a signaling diagram of Third aspect (Registration procedure to a PLMN which does not support simultaneous registration procedure over 3GPP access and non-3GPP access).

FIG. 4 is a signaling diagram of Fourth aspect

(Registration procedure with AMF relocation).

FIG. 5 is a diagram illustrating a system overview.

FIG. 6 is a block diagram illustrating a User equipment (UE).

FIG. 7 is a block diagram illustrating an (R)AN node.

FIG. 8 is a diagram illustrating System overview of
(R)AN node based on O-RAN architecture.

FIG. 9 is a block diagram illustrating a Radio Unit (RU).

FIG. 10 is a block diagram illustrating a Distributed Unit (DU).

FIG. 11 is a block diagram illustrating a Centralized Unit (CU).

FIG. 12 is a block diagram illustrating an Access and Mobility Management Function (AMF).

FIG. 13 is a block diagram illustrating a Unified Data Management (UDM).

FIG. 14 illustrates a registration procedure.

FIG. 15 illustrates a registration procedure.

FIG. 16 illustrates a registration with AMF re-allocation procedure.

### DESCRIPTION OF EMBODIMENTS

### Abbreviations

For the purposes of the present document, the abbreviations given in NPL 1 and the following apply. An abbreviation defined in the present document takes precedence over the definition of the same abbreviation, if any, in NPL 1.
4G-GUTI 4G Globally Unique Temporary UE Identity
5GC 5G Core Network
5GLAN 5G Local Area Network
5GS 5G System
5G-AN 5G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QOS Identifier
AF Application Function
AMF Access and Mobility Management Function
AMF-G Geographically selected Access and Mobility
Management Function
AMF-NG Non-Geographically selected Access and Mobility
Management Function
AS Access Stratum
ATSSS Access Traffic Steering, Switching, Splitting
ATSSS-LL ATSSS Low-Layer
AUSF Authentication Server Function
AUTN Authentication token
BMCABest Master Clock Algorithm
BSF Binding Support Function
CAG Closed Access Group
CAPIF Common API Framework for 3GPP northbound APIs
CHF Charging Function
CN PDB Core Network Packet Delay Budget
CP Control Plane
DAPS Dual Active Protocol Stacks
DL Downlink
DN Data Network
DNAI DN Access Identifier
DNN Data Network Name
DRX Discontinuous Reception
DS-TT Device-side TSN translator
ePDG evolved Packet Data Gateway
EBI EPS Bearer Identity
EPS Evolved Packet System
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLCGateway Mobile Location Centre
GPSI Generic Public Subscription Identifier
GUAMI Globally Unique AMF Identifier
GUTI Globally Unique Temporary UE Identity
HR Home Routed (roaming)
IAB Integrated access and backhaul
IMEI/TAC IMEI Type Allocation Code
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
MCC Mobile country code
MCX Mission Critical Service
MDBV Maximum Data Burst Volume
MFBR Maximum Flow Bit Rate
MICO Mobile Initiated Connection Only
MITM Man In the Middle
MNC Mobile Network Code
MPS Multimedia Priority Service
MPTCP Multi-Path TCP Protocol
N3IWF Non-3GPP InterWorking Function
N3GPP Non-3GPP access
N5CW Non-5G-Capable over WLAN
NAI Network Access Identifier
NAS Non-Access-Stratum
NEF Network Exposure Function
NF Network Function
NGAP Next Generation Application Protocol
NID Network identifier
NPN Non-Public Network
NR New Radio
NRF Network Repository Function
NSI ID Network Slice Instance Identifier
NSSAA Network Slice-Specific Authentication and Authorization
NSSAAF Network Slice-Specific Authentication and Authorization Function
NSSAI Network Slice Selection Assistance Information
NSSF Network Slice Selection Function
NSSP Network Slice Selection Policy
NSSRG Network Slice Simultaneous Registration Group
NW-TT Network-side TSN translator
NWDAF Network Data Analytics Function
PCF Policy Control Function
PDB Packet Delay Budget
PDR Packet Detection Rule
PDU Protocol Data Unit
PEI Permanent Equipment Identifier
PER Packet Error Rate
PFD Packet Flow Description
PLMN Public Land Mobile Network
PNI-NPN Public Network Integrated Non-Public Network
PPD Paging Policy Differentiation
PPF Paging Proceed Flag
PPI Paging Policy Indicator
PSA PDU Session Anchor
PTP Precision Time Protocol
QFI QoS Flow Identifier
QoE Quality of Experience
RACS Radio Capabilities Signalling optimisation
(R)AN (Radio) Access Network
RG Residential Gateway
RIM Remote Interference Management
RQA Reflective QoS Attribute
RQI Reflective QoS Indication
RSN Redundancy Sequence Number
SA NR Standalone New Radio
SBA Service Based Architecture
SBI Service Based Interface
SCP Service Communication Proxy
SD Slice Differentiator
SEAF Security Anchor Functionality
SEPP Security Edge Protection Proxy
SMF Session Management Function
SMSF Short Message Service Function
SN Sequence Number
SN name Serving Network Name.
SNPN Stand-alone Non-Public Network
S-NSSAI Single Network Slice Selection Assistance Information
SSC Session and Service Continuity
SSCMSP Session and Service Continuity Mode Selection Policy
SST Slice/Service Type
SUCI Subscription Concealed Identifier
SUPI Subscription Permanent Identifier
SV Software Version
TMSI Temporary Mobile Subscriber Identity
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMFUE radio Capability Management Function
UDM Unified Data Management
UDR Unified Data Repository
UDSF Unstructured Data Storage Function
UL Uplink
UL CL Uplink Classifier
UPF User Plane Function
URLLC Ultra Reliable Low Latency Communication
URRP-AMF UE Reachability Request Parameter for AMF
URSP UE Route Selection Policy
VID VLAN Identifier
VLAN Virtual Local Area Network
VPLMN Visited PLMN
W-5GAN Wireline 5G Access Network
W-5GBAN Wireline BBF Access Network
W-5GCAN Wireline 5G Cable Access Network
W-AGF Wireline Access Gateway Function

### Definitions

For the purposes of the present document, the terms and definitions given in NPL 1 and the following apply. A term defined in the present document takes precedence over the definition of the same term, if any, in NPL 1.

### General

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

A term “UE context” in aspects below may mean the 5GMM context and optionally 5GSM context stored in an AMF. A 5G NAS security context may be part of the 5GMM context. A term “NAS security context” used below may mean a 5G NAS security context as defined in NPL 5.

The AMF and the UE establish a common 5G NAS security context including a single set of NAS keys and algorithm at the time of first registration over any access. The AMF and the UE also store parameters specific to each NAS connection in the common NAS security context including two pairs of NAS COUNTs for each access (i.e. 3GPP access and non-3GPP access).

Each of Aspects and elements included in the each Aspects described below may be implemented independently or in combination with any other. These Aspects include novel characteristics different from one another. Accordingly, these Aspects contribute to achieving objects or solving problems different from one another and contribute to obtaining advantages different from one another.

Registration procedure in every Aspect can be initial Registration procedure, mobility registration procedure or periodic registration procedure, but not limited to these procedures.

### <First Aspect>

When a UE initiates registration procedure over 3GPP access while the UE has already registered with a non-geographically selected AMF over non-3GPP access, the UE performs integrity protection for a registration request message including an assigned 5G-GUTI using a NAS security context, and sends an RRC setup complete message including the integrity protected registration request message over the 3GPP access. When an NG-RAN receives the RRC setup complete message including the integrity protected registration request message during RRC connection establishment procedure, the NG-RAN routes (or sends) the integrity protected registration request message to a geographically selected AMF. Then the geographically selected AMF (e.g. a new AMF) initiates UE context transfer procedure with the non-geographically selected AMF (e.g. an old AMF) over N14 interface by sending an Namf_Communication_UEContextTransfer request message including the integrity protected registration request message that is received from the UE. In this case, the old AMF doesn't know whether the registration request message is integrity protected with a NAS security context of 3GPP access or a NAS security context of non-3GPP access. This may lead to a failure in an integrity check for the registration request message. For example, this may lead to a failure in an integrity check for the registration request message as security parameters in the NAS security context used by the old AMF for the integrity check may be different from security parameters in the NAS security context used by the UE. The NAS security context mismatch between the UE and the non-geographically selected AMF will eventually lead to a failure of the UE context transfer from the non-geographically selected AMF to the geographically selected AMF. As a result, the registration procedure over 3GPP access will fail. For example, when the mobility from a non-geographically selected AMF to a geographically selected AMF is performed, there is a case where integrity check for transferring the UE context by an AMF may fail.

The first aspect discloses a solution where an AMF performs an integrity check even if the AMF does not have an MM context that corresponds to an indicated access type in an Namf_Communication_UEContextTransfer request message. The first aspect can solve the above problem statement. For example, the MM context may be a 5GMM context or a 5GSM context.

When a UE has registered successfully with an AMF of a PLMN, the UE has current NAS security context stored in an ME memory or in a USIM card. When the UE performs registration procedure to the PLMN over 3GPP access while the UE has been registered over non-3GPP access (e.g. when the UE performs registration procedure to the PLMN over 3GPP access while the UE has been registered to a non-geographically selected AMF over non-3GPP access), the UE integrity protects a registration request message using integrity protection mechanism defined in NPL 5 and sends the integrity protected registration request message over the 3GPP access. The integrity protected registration request message includes 5G-GUTI and an information element called as NAS connection identifier which is set to 3GPP access.

When a geographically selected AMF receives the integrity protected registration request message from the UE, the geographically selected AMF sends, to the non-geographically selected AMF, an Namf_Communication_UEContext Transfer request message including 5G-GUTI and an access type parameter set to 3GPP access (or any other notation to identify 3GPP access) along with other information elements. The Namf_Communication_UEContextTransfer request message may include the integrity protected registration request message. The geographically selected AMF may be called as a geographical AMF or an AMF-G in this disclosure. The non-geographically selected AMF may be called as a non-geographical AMF or an AMF-NG in this disclosure. The Namf_Communication_UEContextTransfer request message may be called as an Namf_Communication_UEContextTransfer message in this disclosure. When the non-geographically selected AMF receives the Namf_Communication_UEContext Transfer request message, the non-geographically selected AMF finds a UE context related to the UE's 5G-GUTI received in the Namf_Communication_UEContextTransfer request message. Although the non-geographically selected AMF finds out that there is no MM contexts for 3GPP access, the non-geographically selected AMF performs an integrity check of the received NAS message (e.g. the integrity protected registration request message) by using the 0 (zero) value for UL NAS COUNT integrity protection parameter for the integrity check. Upon successful integrity check, the AMF-NG sends an Namf_Communication_UEContextTransfer response message to the AMF-G. The AMF-G completes the registration procedure for both 3GPP access and non-3GPP access and allocates a new 5G-GUTI and sends the new 5G-GUTI to the UE.

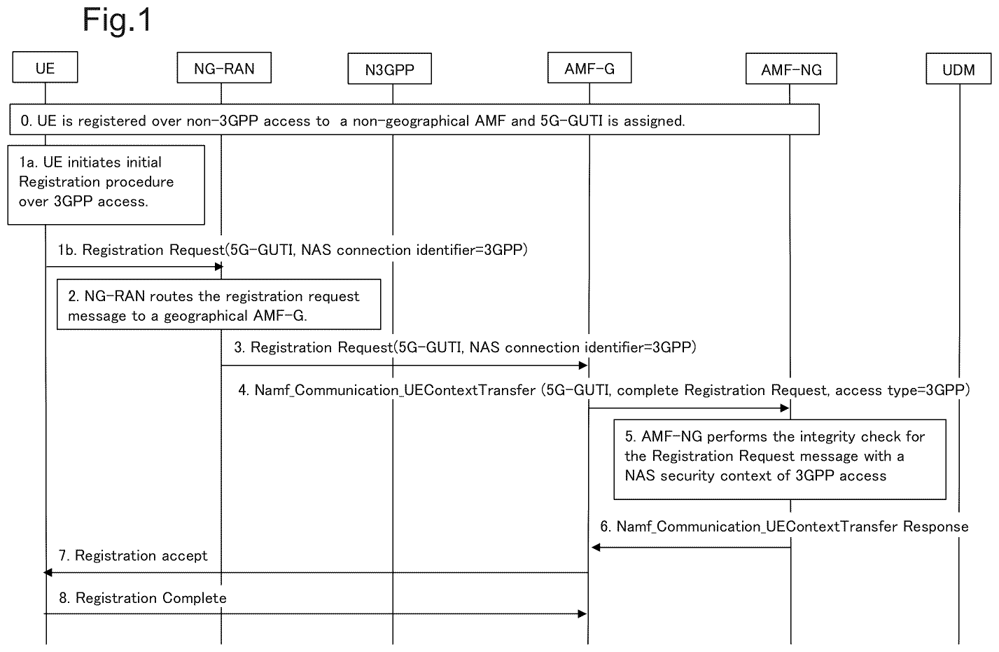

FIG. 1 shows mobility procedure with AMF change, from non-geographically selected AMF to geographically selected AMF.

The detailed procedure of the first aspect is described below.

0. A UE is registered to a non-geographically selected AMF over a non-3GPP access and a 5G-GUTI is assigned to the UE. A NAS security context is created for the non-3GPP access. For example, the UE and the non-geographically selected AMF have the NAS security context of the non-3GPP access. In addition, the UE has not been registered to a 3GPP access yet.

1a-1b. The UE initiates registration procedure over 3GPP access. The UE performs integrity protection for a registration request message using the NAS security context of the non-3GPP access. The registration request message includes 5G-GUTI and a NAS connection identifier set to non-3GPP access. The UE sends the integrity protected registration request message. For example, the UE sends an RRC message including the integrity protected registration request message. The integrity protected registration request message may be called as a registration request message in this disclosure. The value of the unique NAS connection identifier (or the value of the NAS connection identifier) is set to “0x01” for 3GPP access and set to “0x02” for non-3GPP access. For example, the UE sets the NAS connection identifier to 3GPP access or “0x01” and includes the NAS connection identifier in the registration request message.

In another example, the registration request message is integrity protected using the common 5G NAS security context created in step 0 and UL NAS COUNT set to zero for 3GPP access if there is no stored UL NAS COUNT for 3GPP access otherwise using the stored UL NAS COUNT.

2-3. When an NG-RAN receives, from the UE, the RRC message including the registration request message, then the NG-RAN routes (or sends) the registration request message to the geographically selected AMF (AMF-G). The registration request message includes the 5G-GUTI. The 5G-GUTI may indicate a non-geographically selected AMF (i.e., AMF-NG).

4. When the AMF-G receives the registration request message including the 5G-GUTI, the AMF-G identifies a Target AMF using the received 5G-GUTI in the registration request message. The Target AMF may be an AMF with which the AMF-G performs Namf_Communication_UEContextTransfer. The AMF-G sends an Namf_Communication_UEContextTransfer request message including an access type set to 3GPP access (or any other notation to identify 3GPP access), an integrity protected NAS message, and 5G-GUTI. The Namf_Communication_UEContextTransfer request message may include the NAS connection identifier received in the registration request message. The integrity protected NAS message may be the integrity protected registration request message received from the NG-RAN in step 4. The integrity protected NAS message may be the integrity protected registration request message received from the NG-RAN. The integrity protected NAS message may be called as a complete Registration Request or an integrity protected complete Registration request NAS message in this disclosure. For example, in a case where the AMF-G identifies the AMF-NG as the Target AMF using the received 5G-GUTI in the registration request message, the AMF-G sends, to the AMF-NG, the Namf_Communication_UEContextTransfer request message including the access type set to 3GPP access (or any other notation to identify 3GPP access) and the integrity protected NAS message.

5. When the AMF-NG receives the Namf_Communication_UEContextTransfer request message, the AMF-NG determines performing an integrity check of the integrity protected NAS message using one of the following procedure:
i) the AMF-NG uses the NAS security context in the AMF-NG for the UE corresponding to the value received in the access type information element which is 3GPP access in the current case. The AMF-NG uses the common 5G NAS security context created in step 0 and UL NAS COUNT set to zero if there is no UL NAS COUNT stored for the 3GPP Access or using the stored NAS count for 3GPP access.
ii) the AMF-NG uses the NAS security context corresponding to the value received in the NAS connection identifier which is non-3GPP access. The AMF-NG uses the 5G NAS security context based of non-3GPP access to integrity check the NAS message.

For example, the AMF-NG performs the integrity check of the received integrity protected NAS message using the NAS security context of non-3GPP access even if the access type in the Namf_Communication_UEContextTransfer request message is set to 3GPP access.

For example, the AMF-NG may determine that the access type in the Namf_Communication_UEContextTransfer request message is set to 3GPP access, and may perform the integrity check of the received integrity protected NAS message using the NAS security context of non-3GPP access even if the access type in the Namf_Communication_UEContextTransfer request message is set to 3GPP access.

For example, the AMF-NG may perform the integrity check of the received integrity protected NAS message using the NAS security context of non-3GPP access in a case where the AMF-NG receives the NAS connection identifier set to non-3GPP access.

For example, the AMF-NG may determine that the integrity protected NAS message is protected by the NAS security context of non-3GPP access in a case where the AMF-NG determines that the NAS connection identifier is set to non-3GPP access. Then the AMF-NG may perform the integrity check of the received integrity protected NAS message using the NAS security context of non-3GPP access.

In one example, the NAS connection identifier is sent as cleartext element in the registration request message in step 1. When the AMF-NG receives the registration request message, it reads the NAS connection identifier and determines whether to use NAS security context of 3GPP access or non-3GPP access based on the value of the NAS connection identifier.

In one example the NAS connection identifier is optional information element. In absence of NAS connection identifier the 5G NAS security context related to the access type is used to perform integrity check.

In one example, if both NAS connection identifier and access type are present then the AMF-NG can use 5G NAS security context related to either access type or the NAS connection identifier.

6. Upon successful integrity check, the AMF-NG sends, to the AMF-G, an Namf_Communication_UEContextTransfer response message including a 5GMM context for non-3GPP access of the UE.

7. Upon reception of the Namf_Communication_UEContextTransfer response message, the AMF-G takes steps 6 to 19 in section 4.2.2.2.2 of NPL 4 and the AMF-G sends, to the UE, a registration accept message including newly assigned 5G-GUTI.

8. Upon reception of the registration accept message, the UE concludes that the UE is registered for both 3GPP access and non-3GPP access with the AMF-G. The UE sends the Registration complete message to the AMF-G.

### <Variant 1 of the First Aspect>

In step 4, the AMF-G includes new UL NAS COUNT for integrity protection parameter set to 0 in the Namf_Communication_UEContextTransfer request message. With this explicit indication from the AMF-G, the AMF-NG uses the value of UL NAS COUNT for integrity protection (i.e., the value “0”) for integrity check for the received NAS message.

### <Variant 2 of the First Aspect>

Principles of the first aspect can also apply for a case when the UE was registered to a first PLMN over the first access only and the UE has 5G-GUTI, the 5G NAS security context associated with the first PLMN. The UE was never registered over second access i.e. the UE doesn't have any security context (e.g. any security context related to the second access) and the UE is in deregistered state. The UE initiates registration over the second access to a second PLMN. In this case the AMF-NG acts like old AMF, i.e. the AMF of the first PLMN and AMF-G acts like a new AMF i.e. the AMF of the second PLMN. The UE, the old AMF and the new AMF follow the procedure as described in the first aspect to perform registration procedure to the second PLMN over second access.

In one example when the UE is registering over the second access to the second PLMN then the UE includes 5G-GUTI assigned by the first PLMN in the registration request message. In one example when the UE initiates registration procedure over second access to the second PLMN, the UE sends SUCI instead of 5G-GUTI in the registration request message. In this case the UE and the network perform one of the following way to integrity protect the registration request message and integrity check the received registration request message.

The UE integrity protects the registration request message using the common 5G NAS security context and UL NAS COUNT set to zero. When the new AMF sends the registration request message to the old AMF then the old AMF uses the security context associated with the access type parameter received in the Namf_Communication_UEContextTransfer request message i.e. the old AMF uses the security context related to the NAS connection identifier corresponding the access type to integrity check the registration request message. In this case the old AMF uses the common 5G NAS security context and UL NAS COUNT set to zero to integrity check the registration request message as the UE is never registered over the second access to the first PLMN. After the successful integrity check the old AMF sends the UE context to the new AMF.

1 The UE integrity protects the registration request message using the 5G NAS security context of the first access. The UE includes an information element NAS connection identifier with the value set as the NAS connection identifier of the 5G NAS security context used to integrity protect the registration request message. In the current case the NAS connection identifier value is set to the value of NAS connection identifier corresponding to the first access. This information element is sent as clear text. When the old AMF receives the registration request message the old AMF uses the 5G NAS security context corresponding to the value of the NAS connection identifier to integrity check the received registration request message. Upon successful integrity check the old AMF sends the UE context to the new AMF.

### <Variant 3 of the First Aspect>

In step 1b, the UE includes a NAS connection identifier set to non-3GPP access to the registration request message although the UE is accessing over the 3GPP access. This is an explicit indication to the AMF-G that the UE performed an integrity protection for a registration request message using the NAS security context of the non-3GPP access. With this indication, the AMF-G includes the access type set to non-3GPP access in the Namf_Communication_UEContextTransfer request message and sends this message to the AMF-NG in step 4. Then the AMF-NG performs the integrity check of the received integrity protected NAS message using the NAS security context of non-3GPP access based on the received access type set to non-3GPP access in step 5.

### <Variant 4 of the First Aspect>

In step 4, the AMF-G includes the access type set to non-3GPP access in the Namf_Communication_UEContextTransfer request message and sends this message to the AMF-NG if the AMF-G finds that the AMF-NG is a non-geographically selected AMF based on assigned 5G-GUTI or local configuration in the AMF-G. Then the AMF-NG performs the integrity check of the received integrity protected NAS message using the NAS security context of non-3GPP access based on the received access type set to non-3GPP access in step 5.

### <Variant 5 of the First Aspect>

The old AMF (e.g. the AMF-NG) upon receiving the Namf_Communication_UEContextTransfer request message uses the 5G NAS security context related to non-3GPP access (e.g. the NAS security context of non-3GPP access) if the 5G-GUTI is assigned to the UE over non-3GPP access based on GUAMI of the 5G-GUTI indicating non-geographical AMF and otherwise uses 5G NAS security context related to 3GPP access if the 5G-GUTI indicates that the 5G-GUTI is assigned over 3GPP access based on GUAMI of the 5G-GUTI e.g. GUAMI indicating geographical AMF.

### <Second Aspect>

A UE is registered to a PLMN (e.g. an old PLMN) over 3GPP access and non-3GPP access and a single 5G-GUTI is assigned to the UE. For example, the UE is registered to a geographically selected AMF in the old PLMN over 3GPP access and non-3GPP access. The geographically selected AMF in the old PLMN may be called as an old AMF in this disclosure. Then, the UE registers to a new PLMN via non-3GPP access only. This can happen when, for example, after the UE is registered to the geographically selected AMF in the old PLMN, a UE is set to an airplane mode and moves to a different country and only Wi-Fi access is activated. In this case, a N3IWF in the new PLMN may choose a non-geographically selected AMF in the new PLMN and a 5GMM context of non-3GPP access (e.g. 5GMM context of non-3GPP access related to the old PLMN) is only transferred from the geographically selected AMF in the old PLMN to the non-geographically selected AMF in the new PLMN. The non-geographically selected AMF in the new PLMN may be called as a new AMF in this disclosure. Then, the new AMF assigns, to the UE, a 5G-GUTI for non-3GPP access.

Thereafter when the UE registers to the new PLMN over 3GPP access (e.g. when the UE registers to a geographically selected AMF in the new PLMN over 3GPP access), the UE sends a registration request message including the 5G-GUTI assigned by the non-geographically selected AMF in the new PLMN according to NPL 4. In this case, the new geographically selected AMF in the new PLMN does not fetch a 5GMM context of 3GPP access and a 5GSM context of 3GPP access from the old AMF (e.g. the geographically selected AMF in the old PLMN) according to NPL 4. This leads to loss of the services over the 3GPP access as all PDU sessions over the 3GPP access cannot be transferred from the old AMF to the new AMF.

The second aspect discloses a method to retrieve a UE context of 3GPP access and a UE context of non-3GPP access from two different AMFs by new AMF during registration procedure. The second aspect can solve the above problem statement.

The second aspect discloses a registering procedure in PLMN 2 (e.g. the new PLMN) in the following situations.
A UE has a valid 5G-GUTI 1 and a corresponding security context for 3GPP access (for example, NAS security context 1) that are associated with AMF 1 in PLMN 1 (e.g. the old PLMN).
The UE has a valid 5G-GUTI 2 and a corresponding security context for non-3GPP access (for example, NAS security context 2) that are associated with an AMF-NG in the PLMN 2.

In this case, the UE sends a registration request message including two NAS containers, 5G-GUTI 1 and 5G-GUTI 2. The UE performs integrity protection for the registration request message to be sent to the AMF-G using the NAS security context 1 related to 5G-GUTI 1, and includes the integrity protected registration request message based on the NAS security context 1 in a first container of the two NAS containers. The UE performs integrity protection for the registration request message to be sent to the AMF-G using the security context 2 related to 5G-GUTI 2 and includes the integrity protected registration request message based on the NAS security context 2 in a second NAS container of the two NAS containers. When the AMF-G receives the registration request messages, the AMF-G performs two UE Context transfer procedures, one for 3GPP access with PLMN 1 and the other one for non-3GPP access with PLMN 2. Upon the AMF-G receiving both, the UE context for 3GPP access from the AMF 1 and the UE context for non-3GPP access from the AMF-NG, the AMF-G completes the registration procedure for both 3GPP access and non-3GPP access.

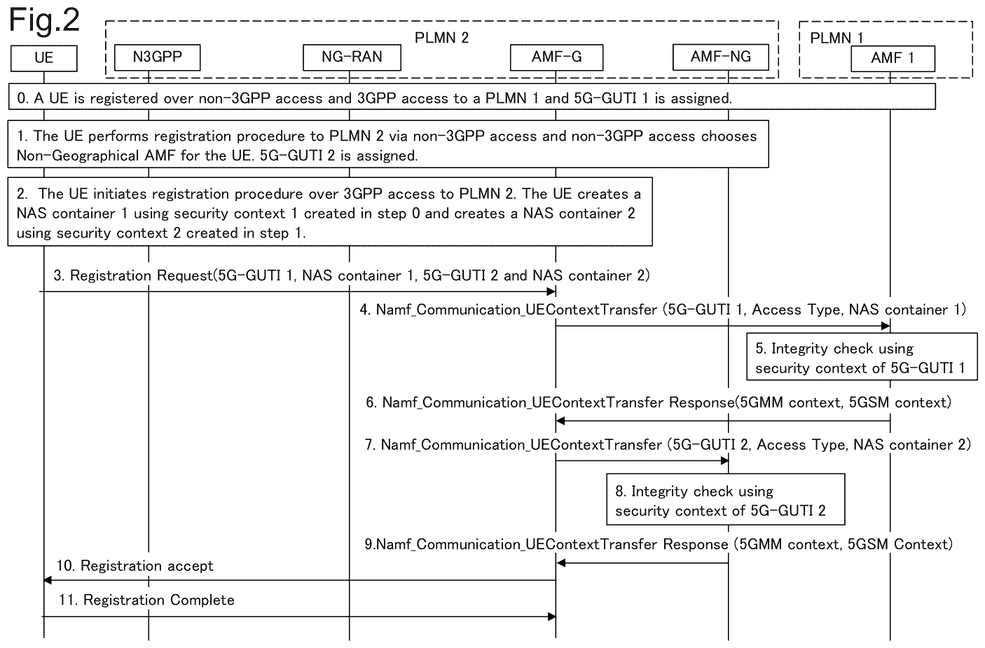

FIG. 2 shows procedure to fetch the UE context related to 3GPP access and non-3GPP access from two different AMFs belonging to two different PLMNs. In FIG. 2, PLMN 2 (or a second PLMN) includes non-3GPP access (or a non-3GPP access network), a NG-RAN, an AMF-G and an AMF-NG. In addition, in FIG. 2, PLMN 1 (or a first PLMN) includes AMF 1 (or a first AMF). For example, PLMN 1 is different from PLMN 2. The non-3GPP access (or non-3GPP access network) may be called as N3GPP in this disclosure.

The detailed procedure of the second aspect is described below.

0. A UE is successfully registered to both 3GPP access and non-3GPP access with an AMF 1 in a first PLMN. In this case, a 5G-GUTI 1 is assigned to the UE. The first PLMN may be called as PLMN 1 in this disclosure. For example, the 5G-GUTI 1 is assigned by the AMF 1. In addition, for example, the UE and the AMF 1 have a NAS security context related to 5G-GUTI 1. The NAS security context related to 5G-GUTI 1 may be created during registration procedure to both 3GPP access and non-3GPP access in step 0. The NAS security context related to 5G-GUTI 1 may be called as a NAS security context of 3GPP access related to 5G-GUTI 1 or security context 1 in this disclosure.

1. The UE registers to a second PLMN over non-3GPP access. A non-geographically selected AMF (i.e., an AMF-NG) is chosen for the UE. In this case, 5G-GUTI 2 for non-3GPP access is assigned to the UE. At this point, the UE and the AMF 1 still hold a UE context for 3GPP access with 5G-GUTI 1. The second PLMN may be called as PLMN 2 in this disclosure. For example, the 5G-GUTI 2 is assigned by the AMF-NG. For example, at this point, the UE and the AMF 1 still hold the UE context for 3GPP access corresponding to 5G-GUTI 1. In addition, for example, the UE and the AMF-NG have a NAS security context related to 5G-GUTI 2. The NAS security context related to 5G-GUTI 2 may be created during registration procedure to a second PLMN over non-3GPP access in step 1. The NAS security context related to 5G-GUTI 2 may be called as a NAS security context of non-3GPP access related to 5G-GUTI 2 or security context 2 in this disclosure.

2. The UE initiates registration procedure over 3GPP access to the second PLMN. The UE performs integrity protection for a registration request message using the NAS security context related to 5G-GUTI 1, and the UE sets this integrity protected registration request message based on the NAS security context related to 5G-GUTI 1 to a NAS container 1. The UE also performs integrity protection for the registration request message using the NAS security context related to 5G-GUTI 2, and the UE sets this integrity protected registration request message based on the NAS security context related to 5G-GUTI 2 to the NAS container 2.

3. The UE sends a registration request message which includes 5G-GUTI 1, the NAS container 1, 5G-GUTI 2, and the NAS container 2. The 5G-GUTI 1 may be set with the additional 5G-GUTI. The 5G-GUTI 2 may be set with the additional 5G-GUTI. For example, the UE sends 5G-GUTI 1, the NAS container 1 associated with 5G-GUTI 1, 5G-GUTI 2, and the NAS container 2 associated to 5G-GUTI 2. The UE may include, in the registration request message, information so that the AMF-G can determine that 5G-GUTI 1 is associated with the NAS container 1, and information so that the AMF-G can determine that 5G-GUTI 2 is associated with the NAS container 2.

4. When the AMF-G receives the registration request message from the UE, the AMF-G sends, to the AMF 1, an Namf_Communication_UEContextTransfer request message which includes 5G-GUTI 1, the integrity protected NAS message in the received NAS container 1 and an access type set to 3GPP access. For example, the AMF-G sends, to the AMF 1, an Namf_Communication_UEContextTransfer request message including 5G-GUTI 1, the received NAS container 1 which includes the integrity protected registration request message based on the NAS security context related to 5G-GUTI 1, and the access type set to 3GPP access. For example, the AMF-G sends, to the AMF 1, an Namf_Communication_UEContextTransfer request message including 5G-GUTI 1, the NAS container 1 associated with 5G-GUTI 1, and the access type set to 3GPP access. For example, the AMF-G determines that the NAS container 1 is associated with 5G-GUTI 1 based on 5G-GUTI 1 or the information received from the UE in step 3, and sends, to the AMF 1, an Namf_Communication_UEContextTransfer request message including 5G-GUTI 1, the received NAS container 1 and the access type set to 3GPP access.

5. When the AMF 1 receives the Namf_Communication_UEContextTransfer request message, the AMF 1 performs an integrity check of the integrity protected NAS message in the NAS container 1 using the NAS security context of 3GPP access related to 5G-GUTI 1. For example, the AMF 1 determines that the access type in the Namf_Communication_UEContextTransfer request message is set to 3GPP access, and performs the integrity check of the received integrity protected NAS message (i.e., the received integrity protected registration request message in the NAS container 1) using the NAS security context of 3GPP access related to 5G-GUTI 1.

6. Upon successful integrity check, the AMF 1 sends, to the AMF-G, an Namf_Communication_UEContextTransfer response message including a 5GMM context for 3GPP access of the UE. The Namf_Communication_UEContextTransfer response message may include a 5GSM context for 3GPP access of the UE. The 5GMM context for 3GPP access of the UE and the 5GSM context for 3GPP access of the UE may be related to 5G-GUTI 1.

7. Then the AMF-G sends, to the AMF-NG, an Namf_Communication_UEContextTransfer request message includes 5G-GUTI 2, the integrity protected NAS message in the received NAS container 2 and an access type set to 3GPP access. For example, the AMF-G sends, to the AMF-NG, an Namf_Communication_UEContextTransfer request message including 5G-GUTI 2, the received NAS container 2 which includes the integrity protected registration request message based on the NAS security context related to 5G-GUTI 2, and the access type set to 3GPP access. For example, the AMF-G sends, to the AMF-NG, an Namf_Communication_UEContextTransfer request message including 5G-GUTI 2, the NAS container 2 associated with 5G-GUTI 2, and the access type set to 3GPP access. For example, the AMF-G determines that the NAS container 2 is associated with 5G-GUTI 2 based on 5G-GUTI 2 or the information received from the UE in step 3, and sends, to the AMF-NG, an Namf_Communication_UEContextTransfer request message including 5G-GUTI 2, the received NAS container 2 and the access type set to 3GPP access.

8. When the AMF-NG receives the Namf_Communication_UEContextTransfer request message, the AMF-NG performs an integrity check of the integrity protected NAS message in the NAS container 2 using the NAS security context related to 5G-GUTI 2 even if the AMF-NG does not have an MM context for 3GPP access. In this case, the AMF-NG uses value of UL NAS COUNT for integrity protection which is set to 0 for integrity check for the received NAS message (i.e., the integrity protected NAS message in the NAS container 2). For example, the AMF-NG determines that the access type in the Namf_Communication_UEContextTransfer request message is set to 3GPP access, and performs the integrity check of the received integrity protected NAS message (i.e., the received integrity protected registration request message) using the NAS security context related to 5G-GUTI 2.

9. Upon successful integrity check, the AMF-NG sends, to the AMF-G, an Namf_Communication_UEContextTransfer response message including the 5GMM context for non-3GPP access of the UE. The Namf_Communication_UEContextTransfer response message may include a 5GSM context for non-3GPP access of the UE. The 5GMM context for non-3GPP access of the UE and the 5GSM context for non-3GPP access of the UE may be related to 5G-GUTI 2.

10. Upon reception of the Namf_Communication_UEContextTransfer response messages in step 6 and step 9, the AMF-G takes steps 6 to 19 in section 4.2.2.2.2 of NPL 4 and the AMF-G sends, to the UE, a registration accept message including newly assigned 5G-GUTI.

11. Upon reception of the registration accept message, the UE concludes that the UE is registered for both, 3GPP access and non-3GPP access at the AMF-G. The UE sends the Registration complete message to the AMF-G.

In one example, step 7 may be performed before step 4. For example, the AMF-G sends, to the AMF-NG, the Namf_Communication_UEContextTransfer request message and receives the Namf_Communication_UEContextTransfer response messages from the AMF-NG, then the AMF-G sends, to the AMF 1, the Namf_Communication_UEContextTransfer request message.

In one example, steps 4 and 7 may be performed simultaneously.

<First Variant of the second Aspect>

In one example the UE includes only NAS container 2 and 5G-GUTI 2 and doesn't include NAS container 1 and 5G-GUTI 1. The AMF-G performs steps 7-9 first then steps 4-7. After successfully performing step 7-9, and the UE context transfer successfully from the AMF-NG to AMF-G, the AMF-G performs step 4 and in the Namf_Communication_UEContextTransfer request message the AMF includes an information element indicating that UE is validated and SUPI (e.g. SUPI related to the UE). The AMF-G sets this value as the UE is successfully validated at the AMF-NG. When the AMF 1 receives the Namf_Communication_UEContextTransfer request message containing the information element indicating that the UE is validated and the SUPI, the AMF 1 sends the UE context to the AMF-G in the Namf_Communication_UEContextTransfer response message. The AMF-G completes the registration procedure as described in aspect 2.

### <Third Aspect>

There can be a case where a N3IWF is only connected to a non-geographically selected AMF. I.e., the N3IWF is not connected with any geographically selected AMFs. In such a network topology, if the UE performs registration procedure to a PLMN over 3GPP access while the UE has already registered over a non-3GPP access with a non-geographically selected AMF of the PLMN, a new geographically selected AMF is chosen and the chosen AMF is used for both 3GPP access and non-3GPP access as both accesses are connected to the same PLMN. In this case, the UE loses any services over non-3GPP access as the N3IWF cannot communicate with the chosen AMF due to a limitation of the network topology. For example, when the mobility from a non-geographically selected AMF to a geographically selected AMF is performed, there is a case where procedure of the mobility is unclear depending on a network topology.

The third aspect discloses a method to handle a scenario when the registration of a UE is not possible for both 3GPP access and non-3GPP access with the same AMF. The third aspect discloses a solution of the above problem statement.

The third aspect discloses the solution for a case where the UE cannot be registered with a geographically selected AMF for both, 3GPP access and non-3GPP access, because a N3IWF is only connected with a non-geographically selected AMF. In this case, the geographically selected AMF proceeds with registration procedure for one access only according to user subscription or operator policy. When the UE receives indication that the UE cannot be connected over both 3GPP access and non-3GPP access simultaneously, then the UE does not initiate registration procedure to the PLMN over another access while the UE is registered over the one access to the same PLMN.

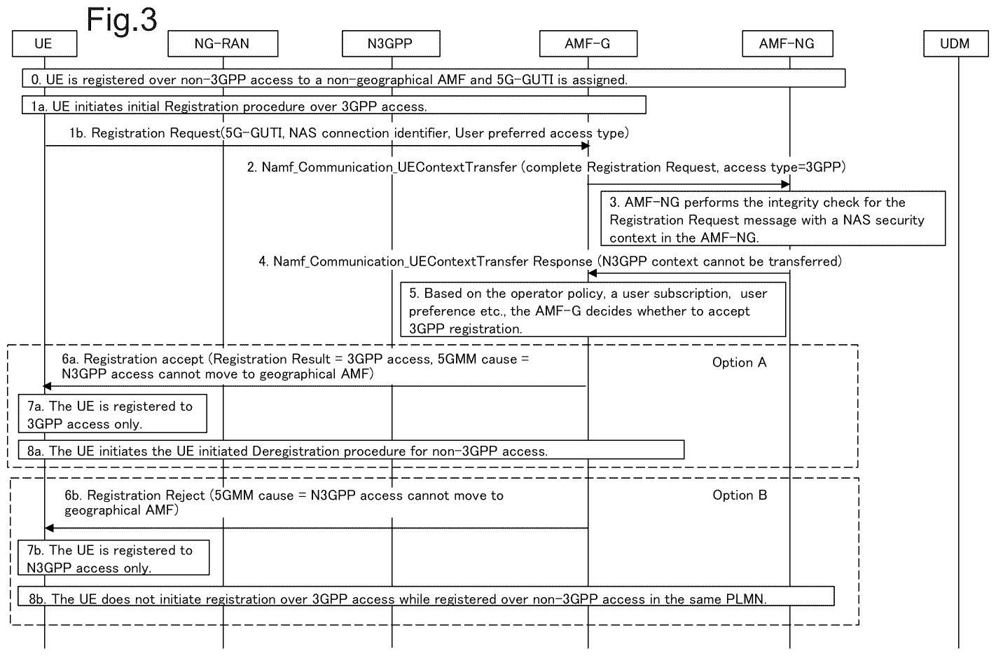

FIG. 3 shows registration procedure when a UE cannot be registered to a same AMF for 3GPP access and non-3GPP access at the same time within a PLMN.

The detailed procedure of the third aspect is described below.

0. A UE is registered to a non-geographically selected AMF (i.e., an AMF-NG) over a non-3GPP access and 5G-GUTI is assigned to the UE. A NAS security context is created for the non-3GPP access. For example, the UE and the non-geographically selected AMF have the NAS security context of the non-3GPP access.

1a-1b. The UE initiates registration procedure over 3GPP access. The UE performs integrity protection for a registration request message using the NAS security context of the non-3GPP access. The UE sends the registration request message (e.g. the integrity protected registration request message). The registration request message includes 5G-GUTI, user preferred access type and NAS connection identifier set to 3GPP access. The user preferred access type indicates a registration over which access type is preferred (e.g. with higher priority) in a case where a registration over both access types is not possible. The user preferred access type can be set to either 3GPP access or non-3GPP access. For example, the user preferred access type set to 3GPP access indicates that a registration over 3GPP access is preferred by the UE in a case where a registration over both access types is not possible. For example, the user preferred access type set to non-3GPP access indicates that a registration over non-3GPP access is preferred by the UE in a case where a registration over both access types is not possible. The value of the unique NAS connection identifier (or the value of the NAS connection identifier) is set to “0x01” for 3GPP access and set to “0x02” for non-3GPP access.

2. When the AMF-G receives, from the UE, the registration request message including the 5G-GUTI, the AMF-G identifies a Target AMF using the received 5G-GUTI in the registration request message. The Target AMF may be an AMF with which the AMF-G performs Namf_Communication_UEContextTransfer. The AMF-G sends an Namf_Communication_UEContextTransfer request message which includes the access type set to 3GPP access and an integrity protected NAS message. The Namf_Communication_UEContextTransfer request message may include the NAS connection identifier received in the registration request message. The integrity protected NAS message may be the integrity protected registration request message received in step 2. The integrity protected NAS message may be called as a complete Registration Request or an integrity protected complete Registration request NAS message in this disclosure. For example, in a case where the AMF-G identifies the AMF-NG as the Target AMF using the received 5G-GUTI in the registration request message, the AMF-G sends, to the AMF-NG, the Namf_Communication_UEContextTransfer request message including the access type set to 3GPP access (or any other notation to identify 3GPP access) and the integrity protected NAS message.

3. When the AMF-NG receives, from the AMF-G, the Namf_Communication_UEContextTransfer request message, the AMF-NG performs an integrity check of the integrity protected NAS message using a NAS security context in the AMF-NG for the UE even if the AMF-NG does not have an MM context for 3GPP access. In this case, the AMF-NG uses the 0 (zero) value of the UL NAS COUNT integrity protection parameter for the integrity check of the received integrity protected NAS message.

Upon successful integrity check, the AMF-NG determines whether a non-3GPP context (e.g. a UE context related to non-3GPP access, a 5GMM context for non-3GPP access of the UE and a 5GSM context for non-3GPP access of the UE) can be transferred to the AMF-G. For example, if a N3IWF can only establish a connection with the AMF-NG, then the AMF-NG determines that the non-3GPP context cannot be transferred to the AMF-G. For example, the AMF-NG determines, based on network configuration of N2 reference point between the N3IWF and the AMF-NG taking a reachability between the N3IWF and AMF-G into account, that the N3IWF can only establish a connection with the AMF-NG, and the AMF-NG determines that the non-3GPP context cannot be transferred to the AMF-G.

For example, the AMF-NG determines that the access type in the Namf_Communication_UEContextTransfer request message is set to 3GPP access, and performs the integrity check of the received integrity protected NAS message using the NAS security context of non-3GPP access even if the access type in the Namf_Communication_UEContextTransfer request message is set to 3GPP access.

For example, the AMF-NG performs the integrity check of the received integrity protected NAS message using the NAS security context of non-3GPP access even if the access type in the Namf_Communication_UEContextTransfer request message is set to 3GPP access.

For example, the AMF-NG may perform the integrity check of the received integrity protected NAS message using the NAS security context of non-3GPP access in a case where the AMF-NG receives the NAS connection identifier set to non-3GPP access.

For example, the AMF-NG may determine that the integrity protected NAS message is protected by the NAS security context of non-3GPP access in a case where the AMF-NG determines that the NAS connection identifier is set to non-3GPP access. Then the AMF-NG may perform the integrity check of the received integrity protected NAS message using the NAS security context of non-3GPP access.

4. The AMF-NG sends, to the AMF-G, an Namf_Communication_UEContextTransfer response message including a cause (or information) indicating that the non-3GPP context cannot be transferred to the AMF-G.

For example, the AMF-NG sends, to the AMF-G, the Namf_Communication_UEContextTransfer response message in a case where the AMF-NG determines, based on network configuration of N2 reference point between the N3IWF and the AMF-NG taking a reachability between the N3IWF and AMF-G into account, that the N3IWF can only establish a connection with the AMF-NG and the AMF-NG determines that the non-3GPP context cannot be transferred to the AMF-G.

For example the AMF-NG may send, to the AMF-G, an Namf_Communication_UEContextTransfer response message including a cause (or information) indicating that the N3IWF can only establish a connection with the AMF-NG in a case where the AMF-NG determines, based on network configuration of N2 reference point between the N3IWF and the AMF-NG taking a reachability between the N3IWF and AMF-G into account, that the N3IWF can only establish a connection with the AMF-NG and the AMF-NG determines that the non-3GPP context cannot be transferred to the AMF-G.

5. Upon reception of the Namf_Communication_UEContextTransfer response message with the cause indicating that the non-3GPP context cannot be transferred (or the cause indicating that the N3IWF can only establish a connection with the AMF-NG), depending on at least one of operator's policy, a user subscription (e.g. 3GPP access subscription has higher priority than non-3GPP access or non-3GPP access subscription has higher priority than 3GPP access) from the UDM and the user preferred access type indicated in the registration request message in step 1b, the AMF-G can either accept the registration procedure over 3GPP access and deregister the UE over non-3GPP access, or reject the registration procedure over 3GPP access (e.g. when the non-3GPP access subscription has higher priority). For example, the AMF-G performs either option A (steps 6a-7a) or Option B (steps 6b-7b). The operator's policy may indicate whether 3GPP access subscription has higher priority than non-3GPP access or non-3GPP access subscription has higher priority than 3GPP access. The operator's policy may be configured to the AMF-G or the AMF-G may receive the operator's policy from another network node.

### Option A:

6a. When the AMF-G accepts the registration procedure based on the decision in step 5, then the AMF-G sends, to the UE, a registration accept message including registration result type (or registration result) set to 3GPP access. The registration result type set to 3GPP access may indicate completion of the registration for the 3GPP access. The AMF-G in addition includes, in the registration accept message, an existing information element (e.g. 5GMM cause) or a new information element to indicate that the AMF-G is unable to simultaneously register the UE for 3GPP access and non-3GPP access. The existing information element (e.g. 5GMM cause) or the new information element may also indicate that non-3GPP access cannot move to the geographically selected AMF (e.g. the AMF-G) or that the UE cannot be connected over both 3GPP access and non-3GPP access simultaneously.

For example, in a case where the AMF-G receives the user preferred access type set to 3GPP access, the AMF-G accepts the registration procedure over 3GPP access, and the AMF-G sends the registration accept message.

For example, in a case where the AMF-G receives, from the UDM, the user subscription indicating that 3GPP access subscription has higher priority than non-3GPP access (or information indicating that 3GPP access has higher priority than non-3GPP access), the AMF-G accepts the registration procedure over 3GPP access, and the AMF-G sends the registration accept message.

For example, in a case where the AMF-G determines that the operator's policy indicates that 3GPP access subscription has higher priority than non-3GPP access (or indicates that 3GPP access has higher priority than non-3GPP access), the AMF-G accepts the registration procedure over 3GPP access, and the AMF-G sends the registration accept message.

7a. When the UE receives the registration accept message including the existing information element or the new information element as described in step 6a, the UE considers itself that the UE is registered to the 3GPP access only.

8a. When the UE receives the registration accept message including the existing information element or the new information element as described in step 6a, the UE initiates the UE initiated Deregistration procedure for non-3GPP access according to NPL 4.

### Option B:

6b. When the AMF-G rejects the registration procedure based on the decision in step 5 as the non-3GPP access subscription has higher priority than the 3GPP access, then the AMF-G rejects the registration procedure for the 3GPP access and sends, to the UE, a registration reject message including a new information element to indicate that the AMF-G is unable to simultaneously register the UE for 3GPP access and non-3GPP access. The new information element may also indicate that non-3GPP access cannot move to a geographically selected AMF or that the UE cannot be connected over both 3GPP access and non-3GPP access simultaneously.

For example, in a case where the AMF-G receives the user preferred access type set to non-3GPP access, the AMF-G rejects the registration procedure over 3GPP access, and the AMF-G sends the registration reject message.

For example, in a case where the AMF-G receives, from the UDM, the user subscription indicating that non-3GPP access subscription has higher priority than 3GPP access (or information indicating that non-3GPP access has higher priority than 3GPP access), the AMF-G rejects the registration procedure over 3GPP access, and the AMF-G sends the registration reject message.

For example, in a case where the AMF-G determines that the operator's policy indicates that non-3GPP access subscription has higher priority than 3GPP access (or indicates that non-3GPP access has higher priority than 3GPP access), the AMF-G rejects the registration procedure over 3GPP access, and the AMF-G sends the registration reject message.

7b. When the UE receives the registration reject message including the new information element as described in step 6b, the UE considers itself that the UE is registered to the non-3GPP access only. For example, at step 7b, the UE is registered to the AMF-NG over the non-3GPP access.

8b. The UE does not initiate the registration procedure over 3GPP access while the UE is registered over non-3GPP access in the same PLMN.

### <Variant 1 of the Third Aspect>

In step 7a, the UE may be registered to the AMF-G over the 3GPP access and the UE may be registered to the AMF-NG over the non-3GPP access. In this case, the UE maintains 5G-GUTI for non-3GPP access and associated the MM contexts for non-3GPP access. In this variant 1, the UE holds two 5G-GUTIs, one for 3GPP access and another one for non-3GPP access even both 3GPP access and non-3GPP access are provided by the same PLMN. In this case, the step 8a is not taken place by the UE in order to maintain non-3GPP access registered with the AMF-NG.

### <Variant 2 of the Third Aspect>

After step 8a, the UE may initiate the registration procedure over non-3GPP access using the 5G-GUTI assigned by the AMF-G.

### <Variant 3 of the Third Aspect>

In step 1b, the UE includes a NAS connection identifier set to non-3GPP access to the registration request message although the UE is accessing over the 3GPP access. This is an explicit indication to the AMF-G that the UE performed an integrity protection for a registration request message using the NAS security context of the non-3GPP access. With this indication, the AMF-G includes the access type set to non-3GPP access in the Namf_Communication_UEContextTransfer request message and sends this message to the AMF-NG in step 2. Then the AMF-NG performs the integrity check of the received integrity protected NAS message using the NAS security context of non-3GPP access based on the received access type set to non-3GPP access in step 3.

### <Variant 4 of the Third Aspect>

In step 1b, the UE includes a NAS connection identifier set to non-3GPP access to the registration request message although the UE is accessing over the 3GPP access. This is an explicit indication to the AMF-G that the UE performed an integrity protection for a registration request message using the NAS security context of the non-3GPP access. With this indication, the AMF-G includes the access type set to non-3GPP access in the Namf_Communication_UEContextTransfer request message and sends this message to the AMF-NG in step 2. Then the AMF-NG performs the integrity check of the received integrity protected NAS message using the NAS security context of non-3GPP access based on the received access type set to non-3GPP access in step 3.

<Variant 5 of the third Aspect>

In step 2, the AMF-G includes the access type set to non-3GPP access in the Namf_Communication_UEContextTransfer request message and sends this message to the AMF-NG if the AMF-G finds that the AMF-NG is a non-geographically selected AMF based on assigned 5G-GUTI or local configuration in the AMF-G. Then the AMF-NG performs the integrity check of the received integrity protected NAS message using the NAS security context of non-3GPP access based on the received access type set to non-3GPP access in step 3.

### <Fourth Aspect>

When the AMF relocation takes place during the registration procedure as defined in NPL 4, an Initial AMF sends Namf_Communication_UEContextTransfer request message to Old AMF (AMF3) to get the UE context. The Initial AMF (AMF1) may be an AMF to send Namf_Communication_UEContextTransfer request message. Upon successful integrity check an Old AMF sends to the Initial AMF the UE context. When the Initial AMF determines that the Initial AMF cannot handle the requested NSSAI but the requested NSSAI can be handled by a Target AMF then the Initial AMF forwards the Registration Request message to the Target AMF (AMF2) via NG-RAN. There can be a case where the Initial AMF deciphers the NAS message container of the registration request message and sends the registration request message contained in the NAS message (or the NAS container). However, it is not clear how the Target AMF fetches the UE context from the Old AMF as the integrity protected registration request message received by the Initial AMF from the UE is not sent to the Target AMF from the Initial AMF. For example, it is also not clear how the UE validity check is performed by the Old AMF in case that Initial AMF forwards the registration request message to a Target AMF. In this case, the registration request message received by the Target AMF may not be the same as the one sent from the UE to the Initial AMF and the UE validity check in the Old AMF may fail.

The fourth aspect discloses a method to solve the above problem and to fetch the UE context from the Old AMF by a Target AMF during the AMF relocation procedure when the Target AMF doesn't have integrity protected registration request message. In the scenario when the Initial AMF receives the UE context from the Old AMF after the successful integrity check of the registration request message at the Old AMF, the Initial AMF marked the UE as validated i.e. the UE is a genuine UE as the UE integrity protected registration request message has passed the integrity check at the Old AMF. When the Initial AMF sends a reroute NAS message to the NG-RAN, the Initial AMF includes an information element indicating that the UE is validated and SUPI (e.g. SUPI related to the UE). Upon receiving the reroute NAS message, the NG-RAN sends Initial NAS message which includes the information element and the SUPI to the Target AMF. When the Target AMF receives the re-route NAS message (or the Initial NAS message) with the information element and the SUPI, the Target AMF sends, to the Old AMF, an Namf_Communication_UEContextTransfer request message containing SUPI and the information element indicating that the UE is validated. Upon receiving the Namf_Communication_UEContextTransfer request message including the information element indicating that the UE is validated and the SUPI, the Target AMF sends an Namf_Communication_UEContextTransfer response message including the UE context corresponding to the SUPI. The Target AMF upon receiving the message further processes the registration procedure.

The detailed steps of the fourth aspect are described below.

The Initial AMF and the Target AMF register their capability at the NRF.

1. The UE initiates registration procedure in idle mode by sending the registration request message to the (R)AN during the RRCsetupcomplete message during the RRC connection setup procedure, and the (R)AN sends the Registration request message within an Initial UE message to the Initial AMF.

2. If the AMF needs the SUPI and/or UE's subscription information to decide whether to reroute the Registration Request or if the Registration Request was not sent integrity protected or integrity protection is indicated as failed, then AMF performs identity request response procedure, authentication procedure and Security mode command procedure. The Registration Request may be called as a Registration Request message in this disclosure.

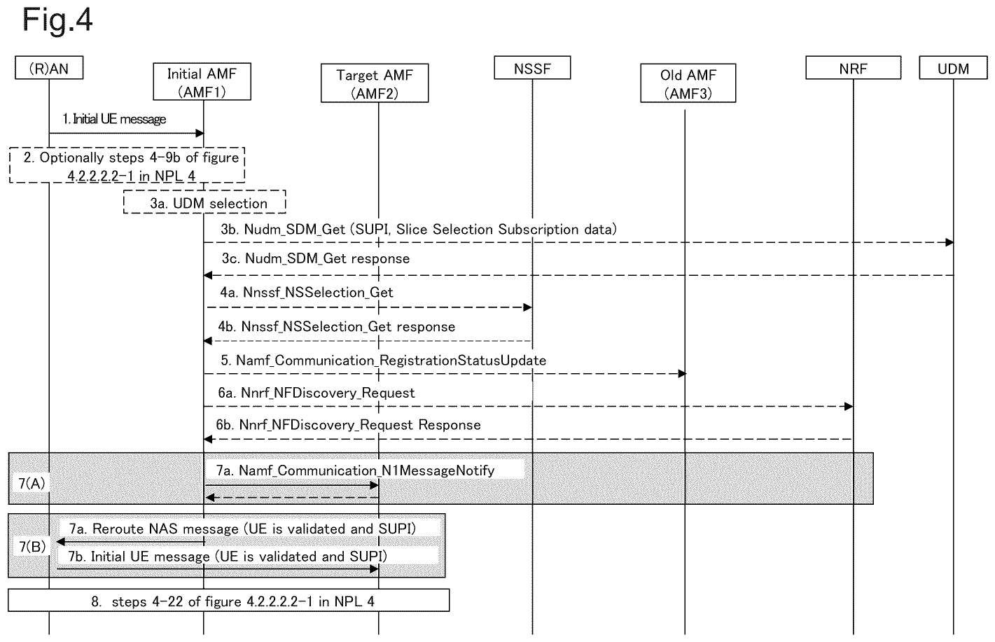

For example, during step 2, the Initial AMF receives a UE context for the UE from the Old AMF after the successful integrity check of the registration request message at the Old AMF, and the Initial AMF marks the UE as validated i.e. the UE is a genuine UE as the UE integrity protected registration request message has passed the integrity check at the Old AMF. For example, the Initial AMF sends, to the Old AMF, an Namf_Communication_UEContextTransfer message to retrieve the UE context, and receives, from the Old AMF, an Namf_Communication_UEContextTransfer response including the UE context. Steps 4 to 9b in FIG. 4.2.2.2.2-1 of NPL 4 may be performed.

3a. If the Initial AMF needs UE's subscription information to decide whether to reroute the Registration Request and UE's slice selection subscription information was not provided by Old AMF, the AMF selects a UDM.

3b. Initial AMF to UDM: Nudm_SDM_Get (SUPI, Slice Selection Subscription data). For example, the Initial AMF sends, to the UDM, Nudm_SDM_Get including SUPI and Slice Selection Subscription data. The Initial AMF requests UE's Slice Selection Subscription data from the UDM by invoking the Nudm_SDM_Get service operation. The UDM may get this information from UDR by Nudr_DM_Query (SUPI, Slice Selection Subscription data). For example, the UDM may get this information from the UDR by Nudr_DM_Query including SUPI and Slice Selection Subscription data.

3c. UDM to Initial AMF: Response to Nudm_SDM_Get. For example, the UDM sends, to the Initial AMF, Response to Nudm_SDM_Get. The AMF gets the Slice Selection Subscription data including Subscribed S-NSSAIs. The UDM responds with slice selection data to Initial AMF.

4a. Initial AMF to NSSF: Nnssf_NSSelection_Get (Requested NSSAI, [Mapping Of Requested NSSAI], Subscribed S-NSSAI(s) with the default S-NSSAI indication, [NSSRG Information], TAI, Allowed NSSAI for the other access type (if any), [Mapping of Allowed NSSAI], PLMN ID of the SUPI). For example, the Initial AMF may send, to the NSSF, Nnssf_NSSelection_Get including Requested NSSAI, Mapping Of Requested NSSAI, Subscribed S-NSSAI(s) with the default S-NSSAI indication, NSSRG Information, TAI, Allowed NSSAI for the other access type (if any), Mapping of Allowed NSSAI, PLMN ID of the SUPI.

If there is a need for slice selection, e.g. the Initial AMF cannot serve all the S-NSSAI(s) from the Requested NSSAI permitted by the subscription information, the Initial AMF invokes the Nnssf_NSSelection_Get service operation from the NSSF by including Requested NSSAI, optionally Mapping Of Requested NSSAI, Subscribed S-NSSAIs with the default S-NSSAI indication, [NSSRG Information], Allowed NSSAI for the other access type (if any), Mapping of Allowed NSSAI, PLMN ID of the SUPI and the TAI of the UE.

The AMF includes, if available, the NSSRG Information for the S-NSSAIs of the HPLMN, defined in clause 5.15.12 of NPL 3, including information whether the UE has indicated support of the subscription-based restrictions to simultaneous registration of network slices, and whether the UDM has indicated to provide all subscribed S-NSSAIs for non-supporting UEs.

4b. NSSF to Initial AMF: Response to Nnssf_NSSelection_Get (AMF Set or list of AMF addresses, Allowed NSSAI for the first access type, [Mapping Of Allowed NSSAI], [Allowed NSSAI for the second access type], [Mapping of Allowed NSSAI], [NSI ID(s)], [NRF(s)], [List of rejected (S-NSSAI(s), cause value(s))], [Configured NSSAI for the Serving PLMN], [Mapping Of Configured NSSAI]). For example, the NSSF may send, to the Initial AMF, Response to Nnssf_NSSelection_Get including AMF Set or list of AMF addresses, Allowed NSSAI for the first access type, Mapping Of Allowed NSSAI, Allowed NSSAI for the second access type, Mapping of Allowed NSSAI, NSI ID(s), NRF(s), List of rejected (S-NSSAI(s), cause value(s)), Configured NSSAI for the Serving PLMN, Mapping Of Configured NSSAI.

The NSSF returns to Initial AMF the Allowed NSSAI for the first access type, optionally the Mapping Of Allowed NSSAI, the Allowed NSSAI for the second access type (if any), optionally the Mapping of Allowed NSSAI and the Target AMF Set or, based on configuration, the list of candidate AMF(s). The NSSF may return NSI ID(s) associated to the Network Slice instance(s) corresponding to certain S-NSSAI(s). The NSSF may return the NRF(s) to be used to select NFs/services within the selected Network Slice instance(s). It may return also information regarding rejection causes for S-NSSAI(s) not included in the Allowed NSSAI. The NSSF may return Configured NSSAI for the Serving PLMN, and possibly the associated mapping of the Configured NSSAI. If the NSSRG information was included in the request, the NSSF provides the Configured NSSAI.

5. Initial AMF to Old AMF: Namf_Communication_RegistrationStatus Update (failure cause). For example, the Initial AMF may send, to the Old AMF, Namf_Communication_RegistrationStatusUpdate including failure cause.

If another AMF is selected, the Initial AMF sends a reject indication to the Old AMF telling that the UE Registration procedure did not fully complete at the Initial AMF. The Old AMF continues as if the Namf_Communication_UEContextTransfer had never been received.

6a. Initial AMF to NRF: Nnrf_NFDiscovery_Request (NF type, AMF Set). For example, the Initial AMF may send, to the NRF, Nnrf_NFDiscovery_Request including NF type, AMF Set.

If the Initial AMF does not locally store the Target AMF address, and if the Initial AMF intends to use direct reroute to Target AMF or the reroute via (NG-R) AN message needs to include AMF address, then the Initial AMF invokes the Nnrf_NFDiscovery_Request service operation from the NRF to find a proper Target AMF which has required NF capabilities to serve the UE. The NF type is set to AMF. The AMF Set is included in the Nnrf_NFDiscovery_Request.

6b. NRF to AMF: Response to Nnrf_NFDiscovery_Request (list of (AMF pointer, AMF address, plus additional selection rules and NF capabilities)). For example, the NRF may send, to the Initial AMF, Response to Nnrf_NFDiscovery_Request including list of (AMF pointer, AMF address, plus additional selection rules and NF capabilities).

The NRF replies with the list of potential Target AMF(s). The NRF may also provide the details of the services offered by the candidate AMF(s) along with the notification end-point for each type of notification service that the selected AMF had registered with the NRF, if available. As an alternative, it provides a list of potential Target AMFs and their capabilities, and optionally, additional selection rules. Based on the information about registered NFs and required capabilities, a Target AMF is selected by the Initial AMF.

If the security association has been established between the UE and Initial AMF, to avoid a registration failure, the Initial AMF shall forward the NAS message to the Target AMF by executing step 7 (A).

If the Initial AMF is not part of the Target AMF Set, and is not able to get a list of candidate AMF(s) by querying the NRF with the Target AMF Set (e.g. the NRF locally pre-configured on AMF does not provide the requested information, the query to the appropriate NRF provided by the NSSF is not successful, or the Initial AMF has knowledge that the Initial AMF is not authorized as serving AMF etc.) then the Initial AMF shall forward the NAS message to the Target AMF via (R)AN executing step 7 (B) unless the security association has been established between the UE and Initial AMF: the Allowed NSSAI and the AMF Set are included to enable the (R)AN to select the Target AMF.

7 (A). If the Initial AMF, based on local policy and subscription information, decides to forward the NAS message to the Target AMF directly, the Initial AMF invokes the Namf_Communication_NIMessageNotify to the Target AMF, carrying the rerouted NAS message. The Namf_Communication_NIMessageNotify service operation includes AN access information (e.g. the information enabling (R)AN to identify the N2 terminating point, CAG Identifier(s) of the CAG cell) and the full Registration Request message, and the UE's SUPI, information element indicating that the UE is validated and MM Context if available. If the Initial AMF has obtained the information from the NSSF as described at step 4b, that information except the AMF Set or list of AMF addresses is included. The Target AMF then updates the (R)AN with a new updated N2 termination point for the UE in the first message from Target AMF to RAN in step 8. For example, in a case where the Initial AMF receives a UE context for the UE from the Old AMF after the successful integrity check of the registration request message at the old AMF and the Initial AMF marks the UE as validated i.e. the UE is a genuine UE as the UE integrity protected registration request message has passed the integrity check at the old AMF, then the Initial AMF includes the information element indicating that the UE is validated in the Namf_Communication_NIMessageNotify. For example, in a case where the Initial AMF receives a UE context for the UE from the Old AMF after the successful integrity check of the registration request message at the Old AMF and the Initial AMF marks the UE as validated i.e. the UE is a genuine UE as the UE integrity protected registration request message has passed the integrity check at the Old AMF, then the Initial AMF includes the UE context (e.g. MM context for the UE) and the information element indicating that the UE is validated in the Namf_Communication_NIMessageNotify. The information element may indicate that the Initial AMF receives a UE context for the UE from the Old AMF after the successful integrity check of the registration request message at the old AMF. The information element may indicate that the Initial AMF marks the UE as validated i.e. the UE is a genuine UE as the UE integrity protected registration request message has passed the integrity check at the old AMF. The information element may indicate that there is no need to perform the integrity check of the registration request message.

If the target AMF receives the Namf_Communication_NIMessageNotify message including SUPI, the information element indicating that the UE is validated and MM context, the Target AMF does not invoke the Namf_Communication_UEContextTransfer service and the Target AMF continues with the Registration procedure as defined in NPL 4 (with the Target AMF corresponding to the new AMF).

7 (B). If the Initial AMF, based on local policy and subscription information, decides to forward the NAS message to the Target AMF via (R)AN unless the Target AMF(s) are returned from the NSSF and identified by a list of candidate AMF(s), the Initial AMF sends a Reroute NAS message to the (R)AN (step 7 (B) step 7a). The Reroute NAS message includes the information about the Target AMF, and the full Registration Request message. If the Initial AMF has received the MM context from the Old AMF in step 2 as the Old AMF successfully checked the integrity of the registration request message or the authentication procedure is successfully performed in step 2, the Initial AMF includes SUPI and an information element indicating that the UE is validated. The (R)AN sends the Initial UE message to the Target AMF (step 7 (B) step 7b) indicating reroute due to slicing including the information from step 4b that the NSSF provided. The NG-RAN also includes SUPI and the information element indicating that the UE is validated and other received information elements in the reroute NAS message to the initial NAS message.

For example, in a case where the Initial AMF receives a UE context for the UE from the Old AMF after the successful integrity check of the registration request message at the Old AMF and the Initial AMF marks the UE as validated i.e. the UE is a genuine UE as the UE integrity protected registration request message has passed the integrity check at the Old AMF, then the Initial AMF includes the information element indicating that the UE is validated in the Reroute NAS message. For example, in a case where the Initial AMF receives a UE context for the UE from the Old AMF after the successful integrity check of the registration request message at the Old AMF and the Initial AMF marks the UE as validated i.e. the UE is a genuine UE as the UE integrity protected registration request message has passed the integrity check at the Old AMF, then the Initial AMF includes the UE context (e.g. MM context for the UE) and the information element indicating that the UE is validated in the Reroute NAS message.

8. If the Target AMF receives the SUPI and the information element indicating that the UE is validated, the Target AMF sends the SUPI and the information element indicating that the UE is validated to the Old AMF in the Namf_Communication_UEContextTransfer message. Upon receiving the Namf_Communication_UEContextTransfer message with the SUPI and the information element indicating that the UE is validated, the Old AMF sends the UE context to the Target AMF in the Namf_Communication_UEContextTransfer.response message without performing the integrity check.

If the Target AMF does not receive the SUPI and the information element indicating that the UE is validated, then on receiving the Registration Request message transmitted at step 7 (A) step 7a or step 7 (B) step 7b, the Target AMF continues with the Registration procedure as defined in NPL 4 (with the Target AMF corresponding to the new AMF), which includes the UE context retrieved from Old AMF. If the 5G security context is received from the Initial AMF, the Target AMF continues using that one instead of the 5G security context retrieved from Old AMF. If the Initial AMF decides to forward the NAS message to the Target AMF (step 7 (A), the first message from the Target AMF to (R)AN (either Initial Context Setup Request, or Downlink NAS Transport) contains the AMF name of the Initial AMF and Target AMF UE NGAP ID.

### <Variant 1 of the Fourth Aspect>

In step 7a in 7 (B), if the Initial AMF has received the UE context from the Old AMF in step 2 as the Old AMF successfully checked the integrity of the registration request message or the authentication procedure is successfully performed in step 2, the Initial AMF includes SUPI, an information element indicating that the UE is validated and MM context that is received from the Old AMF. The (R)AN sends the Initial UE message to the Target AMF (step 7b) indicating reroute due to slicing including the information from step 4b that the NSSF provided. The NG-RAN also includes SUPI, the information element indicating the UE is validated, MM context and other received information elements in the reroute NAS message to the initial NAS message.

When the target AMF receives the initial NAS message including the SUPI, the information element indicating that the UE is validated and MM context, the Target AMF does not invoke the Namf_Communication_UEContextTransfer service and the Target AMF continues with the Registration procedure as defined in NPL 4 (with the Target AMF corresponding to the new AMF).

### <Variant 2 of the Fourth Aspect>

If the authentication procedure and security mode command procedure taken place in step 2 of the Fourth aspect, there is a case where the Initial AMF will have two registration request message one complete registration request message (Registration Request message 1) received in the step 1 from the UE and another one (Registration Request message 2) in security command complete message. In this case the Initial AMF performs one of the following two options:
i) the Initial AMF sends the complete registration request message (Registration Request message 1) as received in the step 1 in the reroute NAS message. When the Target AMF receives this registration request message in the Initial NAS message from the NG-RAN, the Target AMF sends this registration request message in Namf_Communication_UEContextTransfer request message to the Old AMF to retrieve the UE context from the Old AMF.
ii) the Initial AMF includes both Registration Request message 1 and Registration Request message 2 in the reroute NAS message to the (R)AN (e.g. the NG-RAN). On reception of the reroute NAS message the (R)AN includes these two registration request messages in Initial UE message to the Target AMF. When the Target AMF receives the Initial UE message, the Target AMF sends Registration Request message 1 to the Old AMF to retrieve the UE context and uses the Information elements of the Registration Request message 2 to perform the registration procedure e.g. requested NSSAI in Registration Request message 2 to calculate the allowed NSSSAI list.

In one example the Initial AMF puts the Registration Request message 1 in the first NAS PDU (existing information element NAS PDU in the initial UE message) and Registration Request message 2 in the second NAS PDU in INITIAL UE MESSAGE. When the Target AMF receives the initial registration request message from the (R)AN then the Target AMF sends the first NAS PDU to Old AMF to retrieve the UE context and uses Registration Request message 2 in second NAS PDU to process the registration procedure as defined above.

In one example, the Initial AMF includes explicit indication which of two registration requests message is used to send to the Old AMF to retrieve the UE context and which one is used to process the registration request message. Upon receiving these explicit indicator the Target AMF performs accordingly as described above.

<System overview>

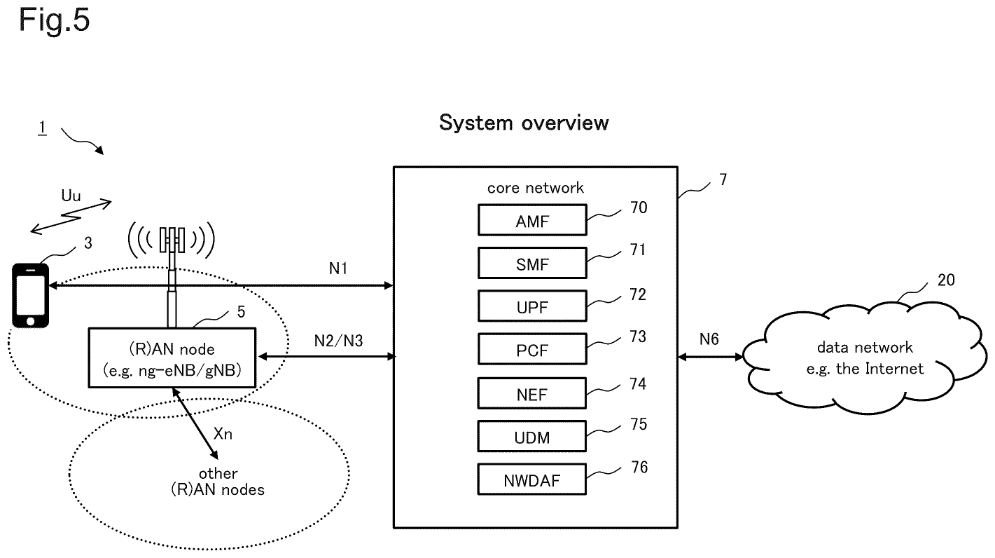

FIG. 5 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in a logical node can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network

### Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, a Network Exposure Function (NEF) 74, a Unified Data Management (UDM) 75, and a Network Data Analytics Function (NWDAF) 76. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2” /“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPV6, IPv4v6, Ethernet or unstructured data type.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by Aspects in this disclosure, following parameters may be included together in the RRC Setup Request message.
establishmentCause and ue-Identity. The ue-Identity may have a value of ng-5G-S-TMSI-Part1 or random Value.
RRC Setup message: This message is sent from the (R)AN node 5 to the UE 3. In addition to the parameters that are disclosed by Aspects in this disclosure, following parameters may be included together in the RRC Setup message.
masterCellGroup and radioBearerConfig
RRC setup complete message: This message is sent from the UE 3 to the (R)AN node 5. In addition to the parameters that are disclosed by Aspects in this disclosure, following parameters may be included together in the RRC setup complete message.
guami-Type, iab-NodeIndication, idleMeas Available, mobility State, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.

registration request message: This message is sent from the UE 3 to the AMF 70. In addition to the parameters that are disclosed by Aspects in this disclosure, following parameters may be included together in the registration request message. 5GS registration type, ngKSI, 5GS mobile identity, Non-current native NAS key set identifier, 5GMM capability, UE security capability, Requested NSSAI, Last visited registered TAI, SI UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.

registration accept message: This message is sent from the AMF 70 to the UE 3. In addition to the parameters that are disclosed by Aspects in this disclosure, following parameters may be included together in the registration accept message.
5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP deregistration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, following parameters may be included together in the Registration Complete message.
SOR transparent container.
Authentication Request message: This message is sent from the AMF 70 to the UE 3. In addition to the parameters that are disclosed by Aspects in this disclosure, following parameters may be included together in the Authentication Request message.
ngKSI,ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, following parameters may be populated together in the Authentication Response message.
Authentication response message identity, Authentication response parameter and EAP message.
Authentication Result message: This message is sent from the AMF 70 to the UE 3. In addition to the parameters that are disclosed by Aspects in this disclosure, following parameters may be populated together in the Authentication Result message.
ngKSI, EAP message and ABBA.
Authentication Failure message: This message is sent from the UE 3 to the AMF 70. In addition to the parameters that are disclosed by Aspects in this disclosure, following parameters may be populated together in the Authentication Failure message.
Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.
EAP message.
Service Request message: This message is sent from the UE 3 to the AMF 70. In addition to the parameters that are disclosed by Aspects in this disclosure, following parameters may be populated together in the Service Request message.
ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message.
PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, following parameters may be populated together in the Service Reject message.
5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, following parameters may be populated together in the Configuration Update Command message.
Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, following parameters may be populated together in the Configuration Update Complete message.
Configuration update complete message identity.

### <User Equipment (UE)>

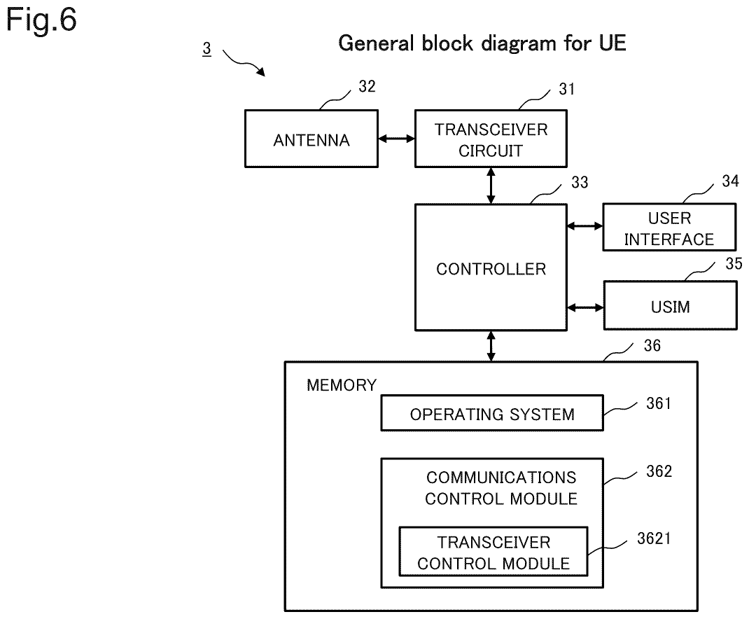

FIG. 6 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 10. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers: engines: turbines: solar panels: wind turbines: hydroelectric generators: thermal power generators: nuclear electricity generators: batteries: nuclear systems and/or associated equipment: heavy electrical machinery: pumps including vacuum pumps: compressors: fans: blowers: oil hydraulic equipment: pneumatic equipment: metal working machinery: manipulators: robots and/or their application systems: tools: molds or dies: rolls: conveying equipment: elevating equipment: materials handling equipment: textile machinery: sewing machines: printing and/or related machinery: paper converting machinery: chemical machinery: mining and/or construction machinery and/or related equipment: machinery and/or implements for agriculture, forestry and/or fisheries: safety and/or environment preservation equipment: tractors: precision bearings: chains: gears: power transmission equipment: lubricating equipment: valves: pipe fittings; and/or application systems for any of the previously mentioned equipment or machinery etc.).

The UE 3 may, for example, be an item of transport equipment (for example transport equipment such as: rolling stocks: motor vehicles: motor cycles: bicycles: trains: buses: carts: rickshaws: ships and other watercraft: aircraft: rockets: satellites: drones: balloons etc.).

The UE 3 may, for example, be an item of information and communication equipment (for example information and communication equipment such as: electronic computer and related equipment: communication and related equipment: electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment: video equipment: a loud speaker: a radio: a television: a microwave oven; a rice cooker: a coffee machine: a dishwasher: a washing machine: a dryer: an electronic fan or related appliance: a cleaner etc.).

The UE 3 may, for example, be an electrical application system or equipment (for example an electrical application system or equipment such as: an x-ray system: a particle accelerator: radio isotope equipment: sonic equipment: electromagnetic application equipment: electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm: a human alarm sensor: a motion sensor: a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

< (R)AN node>

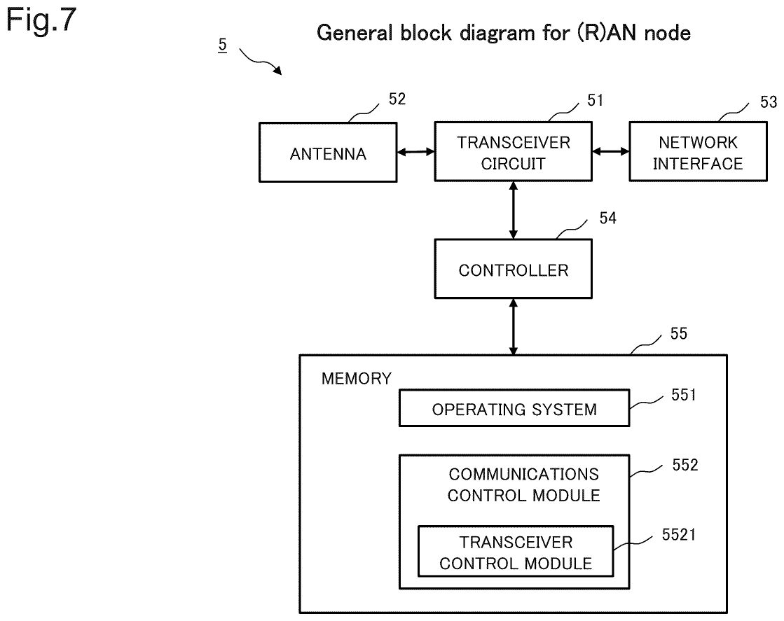

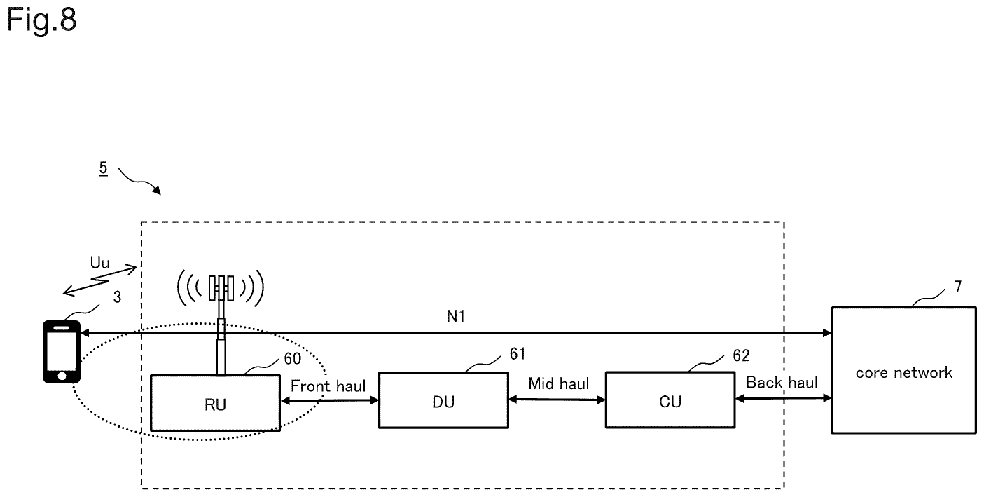

FIG. 7 is a block diagram illustrating the main components of an exemplary (R)AN node 5, for example a base station (′eNB′ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimate and/or moving trajectory estimation.

The (R)AN node 5 may support the Non-Public Network (NPN), The NPN may be a Stand-alone Non-Public Network (SNPN) or a Public Network Integrated NPN (PNI-NPN).

<System overview of (R)AN node 5 based on O-RAN architecture>

FIG. 8 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide functionalities to communicate with a UE 3 over air interface, the DU 61 may provide functionalities to support MAC layer and RLC layer, the CU 62 may provide functionalities to support PDCP layer, SDAP layer and RRC layer.

### <Radio Unit (RU)>

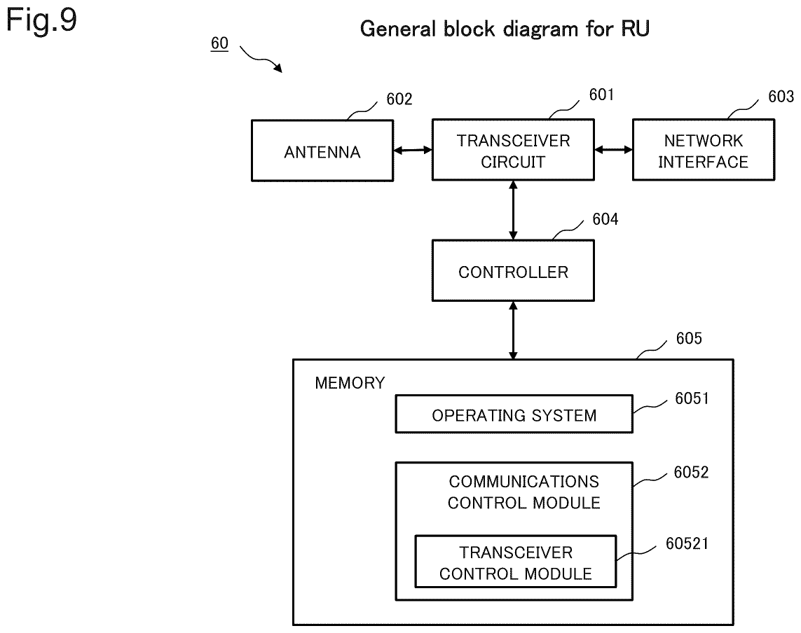

FIG. 9 is a block diagram illustrating the main components of an exemplary RU 60, for example a RU part of base station (′eNB′ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### <Distributed Unit (DU)>

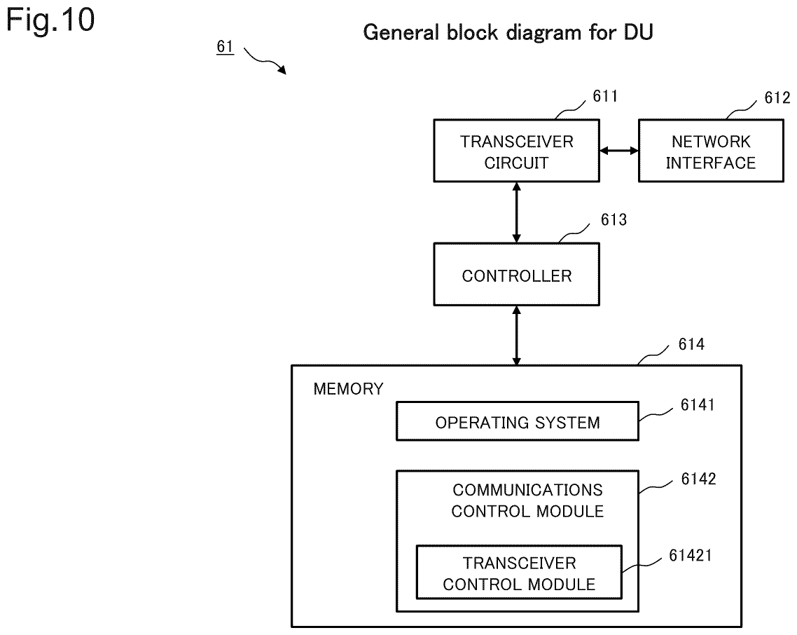

FIG. 10 is a block diagram illustrating the main components of an exemplary DU 61, for example a DU part of a base station (′eNB′ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### <Centralized Unit (CU)>

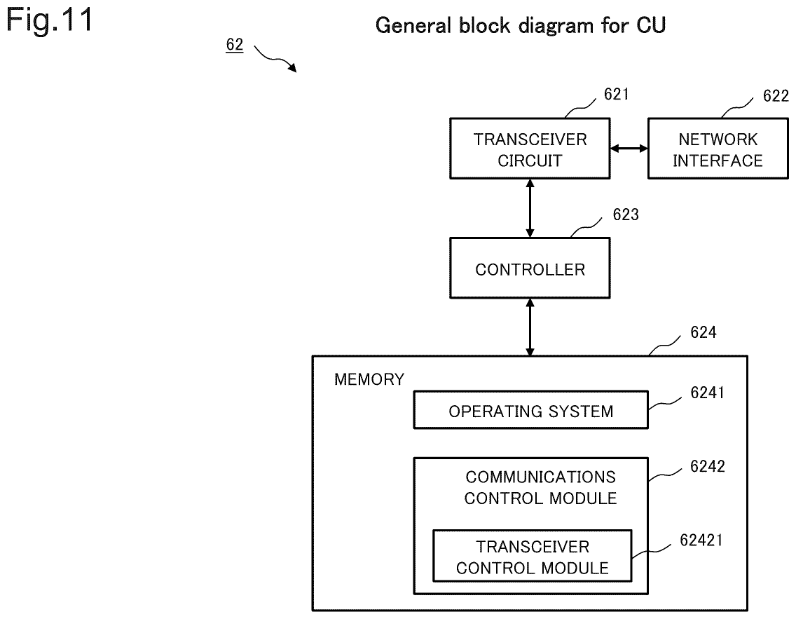

FIG. 11 is a block diagram illustrating the main components of an exemplary CU 62, for example a CU part of base station (′eNB′ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### <AMF>

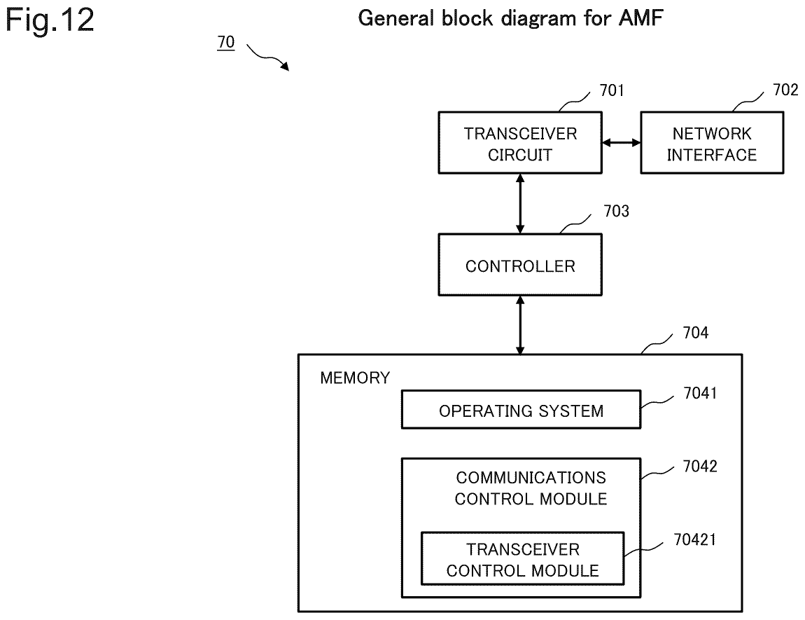

FIG. 12 is a block diagram illustrating the main components of the AMF 70. As shown, the apparatus includes a transceiver circuit 701 which is operable to transmit signals to and to receive signals from other nodes (including the UE 3) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN).

### <UDM>

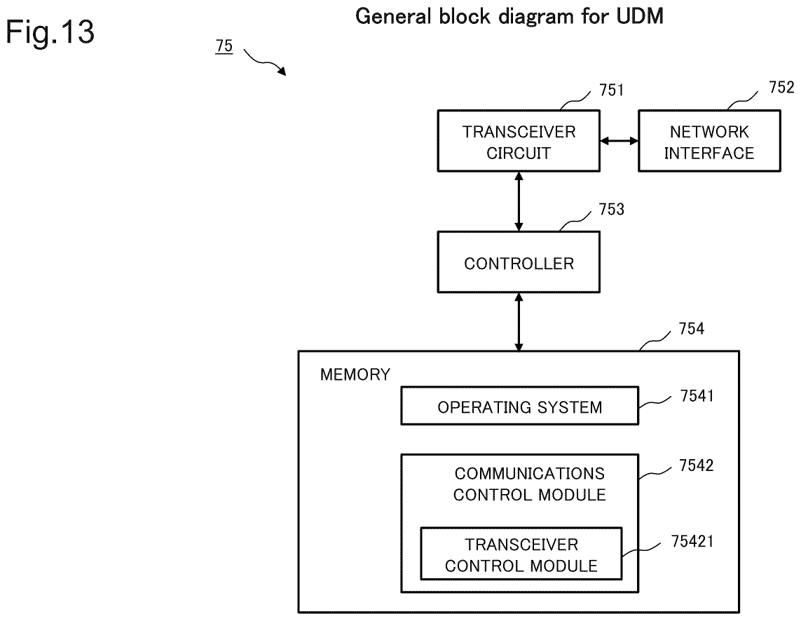

FIG. 13 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### <Modifications and Alternatives>

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors: microprocessors: central processing units (CPUs); arithmetic logic units (ALUs): input/output (IO) circuits; internal memories/caches (program and/or data): processing registers: communication buses (e.g. control, data and/or address buses): direct memory access (DMA) functions: hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

The whole or part of the example Aspects disclosed above can be described as, but not limited to, the following.

### <4.2.2.2.2 General Registration>

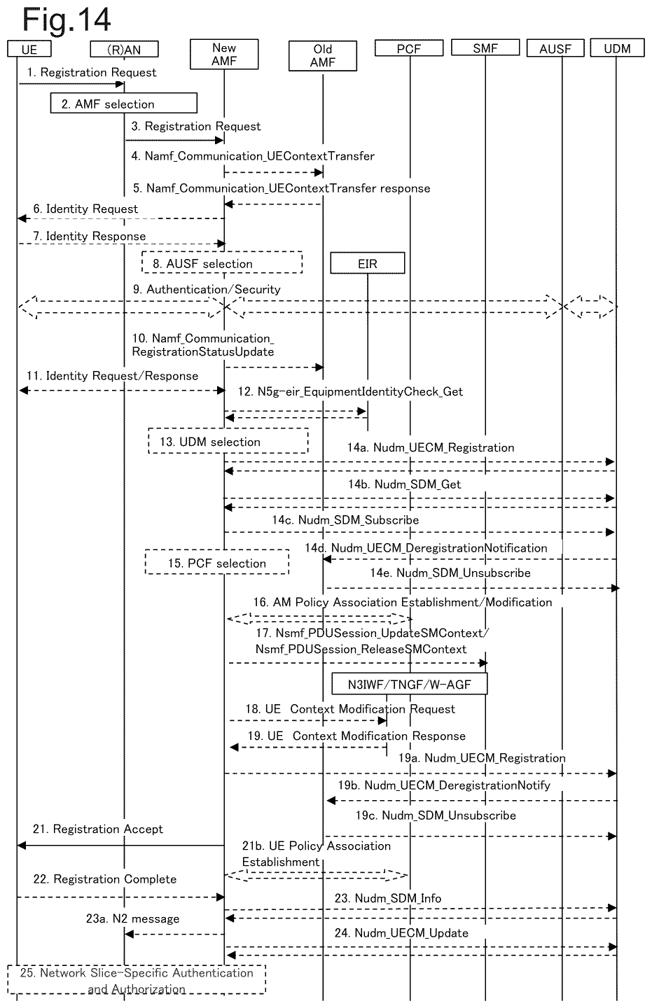

FIG. 4.2.2.2.2-1: Registration procedure (See FIG. 14)

1. UE to (R)AN: AN message (AN parameters, Registration Request (Registration type, SUCI or 5G-GUTI or PEI, [last visited TAI (if available)], Security parameters, [Requested NSSAI], [Mapping Of Requested NSSAI], [Default Configured NSSAI Indication], [UE Radio Capability Update], [UE MM Core Network Capability], [PDU Session status], [List Of PDU Sessions To Be Activated], [Follow-on request], [MICO mode preference], [Requested Active Time], [Requested DRX parameters for E-UTRA and NR], [Requested DRX parameters for NB-IoT], [extended idle mode DRX parameters], [LADN DNN(s) or Indicator Of Requesting LADN Information], [NAS message container], [Support for restriction of use of Enhanced Coverage], [Preferred Network Behaviour], [UE paging probability information], [UE Policy Container (the list of PSIs, indication of UE support for ANDSP and the operating system identifier)] and [UE Radio Capability ID], [Release Request indication], [Paging Restriction Information], PEI, [NSSRG handling support indication], [PLMN with Disaster Condition])).

NOTE 1: The UE Policy Container and its usage is defined in TS 23.503 [20].

In the case of NG-RAN, the AN parameters include e.g. 5G-S-TMSI or GUAMI, the Selected PLMN ID (or PLMN ID and NID, see clause 5.30 of TS 23.501 [2]) and NSSAI information, the AN parameters also include Establishment cause. The Establishment cause provides the reason for requesting the establishment of an RRC connection. Whether and how the UE includes the NSSAI information as part of the AN parameters is dependent on the value of the Access Stratum Connection Establishment NSSAI Inclusion Mode parameter, as specified in clause 5.15.9 of TS 23.501 [2].

The AN parameters shall also include an IAB-Indication if the UE is an IAB-node accessing 5GS.

The Registration type indicates if the UE wants to perform an Initial Registration (i.e. the UE is in RM-DEREGISTERED state), a Mobility Registration Update (i.e. the UE is in RM-REGISTERED state and initiates a Registration procedure due to mobility or due to the UE needs to update its capabilities or protocol parameters, or to request a change of the set of network slices it is allowed to use), a Periodic Registration Update (i.e. the UE is in RM-REGISTERED state and initiates a Registration procedure due to the Periodic Registration Update timer expiry, see clause 4.2.2.2.1), an Emergency Registration (i.e. the UE is in limited service state), or a Disaster Roaming Registration.

When the UE is using E-UTRA, the UE indicates its support of CIOT 5GS Optimisations, which is relevant for the AMF selection, in the RRC connection establishment signalling associated with the Registration Request.

When the UE is performing an Initial Registration or a Disaster Roaming Registration the UE shall indicate its UE identity in the Registration Request message as follows, listed in decreasing order of preference in the case of registration with a PLMN:
i) a 5G-GUTI mapped from an EPS GUTI, if the UE has a valid EPS GUTI.
ii) a native 5G-GUTI assigned by the PLMN to which the UE is attempting to register, if available;
iii) a native 5G-GUTI assigned by an equivalent PLMN to the PLMN to which the UE is attempting to register, if available;
iv) a native 5G-GUTI assigned by any other PLMN, if available.

NOTE 2: This can also be a 5G-GUTIs assigned via another access type.
v) Otherwise, the UE shall include its SUCI in the Registration Request as defined in TS 33.501[15].

If the UE is registering with an SNPN, when the UE is performing an Initial Registration the UE shall indicate its UE identity in the Registration Request message as follows, listed in decreasing order of preference:
i) a native 5G-GUTI assigned by the same SNPN to which the UE is attempting to register, if available;
ii) a native 5G-GUTI assigned by any other SNPN along with the NID of the SNPN that assigned the 5G-GUTI, if available;
iii) Otherwise, the UE shall include its SUCI in the Registration Request as defined in TS 33.501 [15].

When the UE performing an Initial Registration has both a valid EPS GUTI and a native 5G-GUTI, the UE shall also indicate the native 5G-GUTI as Additional GUTI. If more than one native 5G-GUTIs are available, the UE shall select the 5G-GUTI in decreasing order of preference among items (ii)-(iv) in the list above.

The NAS message container shall be included if the UE is sending a Registration Request message as an Initial NAS message and the UE has a valid 5G NAS security context and the UE needs to send non-cleartext IEs, see clause 4.4.6 in TS 24.501 [25]. If the UE does not need to send non-cleartext IEs, the UE shall send a Registration Request message without including the NAS message container.

If the UE does not have a valid 5G NAS security context, the UE shall send the Registration Request message without including the NAS message container. The UE shall include the entire Registration Request message (i.e. containing cleartext IEs and non-cleartext IEs) in the NAS message container that is sent as part of the Security Mode Complete message in step 9b.

When the UE is performing an Initial Registration (i.e., the UE is in RM-DEREGISTERED state) with a native 5G-GUTI then the UE shall indicate the related GUAMI information in the AN parameters. When the UE is performing an Initial Registration with its SUCI, the UE shall not indicate any GUAMI information in the AN parameters.

When the UE is performing an Initial Registration or a Mobility Registration and if CIOT 5GS Optimisations are supported the UE shall indicate its Preferred Network Behaviour (see clause 5.31.2 of TS 23.501 [2]). If SI mode is supported the UE's EPC Preferred Network Behaviour is included in the SI UE network capabilities in the Registration Request message, see clause 8.2.6.1 of TS 24.501 [25].

For an Emergency Registration, the SUCI shall be included if the UE does not have a valid 5G-GUTI available: the PEI shall be included when the UE has no SUPI and no valid 5G-GUTI. In other cases, the 5G-GUTI is included and it indicates the last serving AMF.

The UE may provide the UE's usage setting based on its configuration as defined in clause 5.16.3.7 of TS 23.501 [2]. The UE provides Requested NSSAI (as described in clause 5.15.5.2.1 of TS 23.501 [2] and, if the UE supports the subscription-based restrictions to simultaneous registration of network slices, also taking into account the NSSRG Information constraints as described in clause 5.15.12 of TS 23.501 [2] and, in the case of Initial Registration or Mobility Registration Update, the UE includes the Mapping Of Requested NSSAI (if available), which is the mapping of each S-NSSAI of the Requested NSSAI to the HPLMN S-NSSAIs, to ensure that the network is able to verify whether the S-NSSAI(s) in the Requested NSSAI are permitted based on the Subscribed S-NSSAIs. In the case of inter PLMN mobility, if the serving PLMN S-NSSAI(s) corresponding to the established PDU Session(s) are not present in the UE, the associated HPLMN S-NSSAI(s) associated with the established PDU Session(s) shall be provided in the Mapping Of Requested NSSAI as described in clause 5.15.5.2.1 TS 23.501 [2].

The UE includes the Default Configured NSSAI Indication if the UE is using a Default Configured NSSAI, as defined in TS 23.501 [2].

The UE may include UE paging probability information if it supports the assignment of WUS Assistance Information from the AMF (see TS 23.501 [2]).

In the case of Mobility Registration Update, the UE includes in the List Of PDU Sessions To Be Activated the PDU Sessions for which there are pending uplink data. When the UE includes the List Of PDU Sessions To Be Activated, the UE shall indicate PDU Sessions only associated with the access the Registration Request is related to. As defined in TS 24.501 the UE shall include always-on PDU Sessions which are accepted by the network in the List Of PDU Sessions To Be Activated even if there are no pending uplink data for those PDU Sessions.

NOTE 3: A PDU Session corresponding to a LADN is not included in the List Of PDU Sessions To Be Activated when the UE is outside the area of availability of the LADN.

The UE MM Core Network Capability is provided by the UE and handled by AMF as defined in clause 5.4.4a of TS 23.501 [2]. The UE includes in the UE MM Core Network Capability an indication if it supports Request Type flag “handover” for PDN connectivity request during the attach procedure as defined in clause 5.17.2.3.1 of TS 23.501 [2]. If the UE supports ‘Strictly Periodic Registration Timer Indication’, the UE indicates its capability of ‘Strictly Periodic Registration Timer Indication’ in the UE MM Core Network Capability. If the UE supports CAG, the UE indicates its capability of “CAG supported” in the UE MM Core Network Capability. If the UE operating two or more USIMs, supports and intends to use one or more Multi-USIM feature(s), the UE indicates one or more Multi-USIM specific features described in clause 5.38 of TS 23.501 [2] in the UE MM Core Network Capability.

The UE may provide either the LADN DNN(s) or an Indication Of Requesting LADN Information as described in clause 5.6.5 of TS 23.501 [2].

If available, the last visited TAI shall be included in order to help the AMF produce Registration Area for the UE.

The Security parameters are used for Authentication and integrity protection, see TS 33.501 [15]. Requested NSSAI indicates the Network Slice Selection Assistance Information (as defined in clause 5.15 of TS 23.501 [2]). The PDU Session status indicates the previously established PDU Sessions in the UE. When the UE is connected to the two AMFs belonging to different PLMN via 3GPP access and non-3GPP access then the PDU Session status indicates the established PDU Session of the current PLMN in the UE.

The Follow-on request is included when the UE has pending uplink signalling and the UE doesn't include List Of PDU Sessions To Be Activated, or the Registration type indicates the UE wants to perform an Emergency Registration. In Initial Registration and Mobility Registration Update, UE provides the UE Requested DRX parameters, as defined in clause 5.4.5 of TS 23.501 [2]. The UE may provide the extended idle mode DRX parameters as defined in clause 5.31.7.2 of TS 23.501 [2] to request extended idle mode DRX.

The UE provides UE Radio Capability Update indication as described in TS 23.501 [2].

The UE includes the MICO mode preference and optionally a Requested Active Time value if the UE wants to use MICO Mode with Active Time.

The UE may indicate its Service Gap Control Capability in the UE MM Core Network Capability, see clause 5.31.16 of TS 23.501 [2].

For a UE with a running Service Gap timer in the UE, the UE shall not set Follow-on Request indication or Uplink data status in the Registration Request message (see clause 5.31.16 of TS 23.501 [2]), except for network access for regulatory prioritized services like Emergency services or exception reporting.

If UE supports RACS and has been assigned UE Radio Capability ID(s), the UE shall indicate a UE Radio Capability ID as defined in clause 5.4.4.1a of TS 23.501 [2] as non-cleartext IE.

The PEI may be retrieved in initial registration from the UE as described in clause 4.2.2.2.1.

If a UE supports the subscription-based restrictions to simultaneous registration of network slices feature, it includes the NSSRG handling support indication according to clause 5.15.12 of TS 23.501 [2]. The AMF stores whether the UE supports this feature in the UE context.

When a UE in MUSIM mode wants to enter CM-IDLE state immediately e.g. after having performed mobility or periodic registration, it includes the Release Request indication and optionally provides Paging Restriction Information.

When the UE is performing a Disaster Roaming Registration, the UE may indicate the PLMN with Disaster Condition if UE does not have valid 5G-GUTI indicating the PLMN with Disaster Condition and the PLMN with Disaster Condition is not the HPLMN of the UE or the PLMN with Disaster Condition is the HPLMN of the UE but the UE does not provide its SUCI.

2. If a 5G-S-TMSI or GUAMI is not included or the 5G-S-TMSI or GUAMI does not indicate a valid AMF the (R)AN, based on (R) AT and Requested NSSAI, if available, selects an AMF

The (R)AN selects an AMF as described in clause 6.3.5 of TS 23.501 [2]. If UE is in CM-CONNECTED state, the (R)AN can forward the Registration Request message to the AMF based on the N2 connection of the UE.

If the (R)AN cannot select an appropriate AMF, it forwards the Registration Request to an AMF which has been configured, in (R)AN, to perform AMF selection.

3. (R)AN to new AMF: N2 message (N2 parameters, Registration Request (as described in step 1) and [LTE-M Indication].

When NG-RAN is used, the N2 parameters include the Selected PLMN ID (or PLMN ID and NID, see clause 5.30 of TS 23.501 [2]), Location Information and Cell Identity related to the cell in which the UE is camping, UE Context Request which indicates that a UE context including security information needs to be setup at the NG-RAN.

When NG-RAN is used, the N2 parameters shall also include the Establishment cause and IAB-Indication if the indication is received in AN parameters in step 1.

Mapping Of Requested NSSAI is provided only if available.

If the Registration type indicated by the UE is Periodic Registration Update, then steps 4 to 19 may be omitted.

When the Establishment cause is associated with priority services (e.g. MPS, MCS), the AMF includes a Message Priority header to indicate priority information. Other NFs relay the priority information by including the Message Priority header in service-based interfaces, as specified in TS 29.500 [17].

The RAT Type the UE is using is determined (see clause 4.2.2.2.1) and based on it the AMF determines whether the UE is performing Inter-RAT mobility to or from NB-IoT. If the AMF receives the LTE M indication, then it considers that the RAT Type is LTE-M and stores the LTE-M Indication in UE Context.

If a UE includes a Preferred Network Behaviour, this defines the Network Behaviour the UE supports and is expecting to be available in the network as defined in clause 5.31.2 of TS 23.501 [2].

If the UE has included the Preferred Network Behaviour, and what the UE indicated it supports in Preferred Network Behaviour is incompatible with the network support, the AMF shall reject the Registration Request with an appropriate cause value (e.g. one that avoids retries on this PLMN).

If there is a Service Gap timer running in the UE Context in AMF for the UE, and Follow-on Request indication or Uplink data status is included in the Registration Request message, the AMF shall ignore the Follow-on Request indication and Uplink data status and not perform any of the actions related to the status.

If the UE has included a UE Radio Capability ID in step 1 and the AMF supports RACS, the AMF stores the Radio Capability ID in UE context.

For NR satellite access, if the AMF can determine based on the Selected PLMN ID and ULI (including Cell ID) received from the gNB that the UE is attempting to register to a PLMN that is not allowed to operate at the present UE location, then the AMF should reject the Registration Request indicating a suitable Cause value and, if known in AMF, the country of the UE location. Otherwise, e.g. if the AMF is not aware of the UE location with sufficient accuracy to make a final decision, the AMF proceeds with the Registration procedure and may initiate UE location procedure as specified in clause 6.10.1 of TS 23.273 and be prepared to deregister the UE if the information received from LMF proves that the UE is registered to a PLMN that is not allowed to operate in the UE location.

NOTE 4: The location information cannot be guaranteed to be sufficiently accurate for the AMF to determine in all cases the country where UE is located.

NOTE 5: Some countries use multiple MCCs and some MCCs, such as 901, can be allowed in multiple countries and therefore the UE can register in a PLMN with MCC different from the one returned to the UE.

Upon receiving a Registration Reject with the country in which the UE is located, the UE shall attempt to register to a PLMN that is allowed to operate at the UE location as specified in TS 23.122 [22].

For a Disaster Roaming Registration, based on the ULI (including Cell ID) received from the NG-RAN, the PLMN with Disaster Condition derived from the UE's 5G-GUTI, derived from the UE's SUCI or indicated by the UE and the local configuration, the AMF determines if Disaster Roaming service can be provided. If the current location is not subject to Disaster Roaming service or the Disaster Roaming service is not provided to the PLMN with Disaster Condition derived from the UE's 5G-GUTI, derived from the UE's SUCI or indicated by UE, then the AMF should reject the Registration Request indicating a suitable Cause value.

4. [Conditional] new AMF to old AMF: Namf_Communication_UEContextTransfer (complete Registration Request) or new AMF to UDSF: Nudsf_Unstructured Data Management_Query ( )

The new AMF determines the old AMF using the UE's 5G-GUTI. If the new AMF received an NID in the Registration request, it determines that the 5G-GUTI was assigned by an SNPN and determines the old AMF using the 5G-GUTI and NID of the SNPN.

(With UDSF Deployment): If the UE's 5G-GUTI was included in the Registration Request and the serving AMF has changed since last Registration procedure, new AMF and old AMF are in the same AMF Set and UDSF is deployed, the new AMF retrieves the stored UE's SUPI and UE context directly from the UDSF using Nudsf_UnstructuredDataManagement_Query service operation or they can share stored UE context via implementation specific means if UDSF is not deployed. This includes also event subscription information by each NF consumer for the given UE. In this case, the new AMF uses integrity protected complete Registration request NAS message to perform and verify integrity protection.

(Without UDSF Deployment): If the UE's 5G-GUTI was included in the Registration Request and the serving AMF has changed since last Registration procedure, the new AMF may invoke the Namf_Communication_UEContextTransfer service operation on the old AMF including the complete Registration Request NAS message, which may be integrity protected, as well as the Access Type, to request the UE's SUPI and UE Context. See clause 5.2.2.2.2 for details of this service operation. In this case, the old AMF uses either 5G-GUTI and the integrity protected complete Registration request NAS message, or the SUPI and an indication that the UE is validated from the new AMF, to verify integrity protection if the context transfer service operation invocation corresponds to the UE requested. The old AMF uses the 5G NAS security context related to the access type to check integrity of the received complete registration request message. In this case the UE uses the common 5G NAS security context, ULNAS COUNT set to zero if UL NAS COUNT corresponding to the access type is not stored other uses the stored UL NAS count and the NAS connection identifier corresponding to the access type. The old AMF also transfers the event subscriptions information by each NF consumer, for the UE, to the new AMF. If the old AMF has not yet reported a non-zero MO Exception Data Counter to the (H-) SMF, the Context Response also includes the MO Exception Data Counter.

If the old AMF has PDU Sessions for another access type (different from the Access Type indicated in this step) and if the old AMF determines that there is no possibility for relocating the N2 interface to the new AMF, the old AMF returns UE's SUPI and indicates that the Registration Request has been validated for integrity protection, but does not include the rest of the UE context.

For inter PLMN mobility, UE Context information includes HPLMN S-NSSAIs corresponding to the Allowed NSSAI for each Access Type, without Allowed NSSAI of old PLMN.

NOTE 6: The new AMF Sets the indication that the UE is validated according to step 9a, if the new AMF has performed successful UE authentication after previous integrity check failure in the old AMF.

NOTE 7: The NF consumers do not need to subscribe for the events once again with the new AMF after the UE is successfully registered with the new AMF.

If the new AMF has already received UE contexts from the old AMF during handover procedure, then step 4,5 and 10 shall be skipped.

For an Emergency Registration, if the UE identifies itself with a 5G-GUTI that is not known to the AMF, steps 4 and 5 are skipped and the AMF immediately requests the SUPI from the UE. If the UE identifies itself with PEI, the SUPI request shall be skipped. Allowing Emergency Registration without a user identity is dependent on local regulations.

5. [Conditional] old AMF to new AMF: Response to Namf_Communication_UEContextTransfer (SUPI, UE Context in AMF (as per Table 5.2.2.2.2-1)) or UDSF to new AMF: Nudsf_Unstructured Data Management_Query ( ) The old AMF may start an implementation specific (guard) timer for the UE context.

If the UDSF was queried in step 4, the UDSF responds to the new AMF for the Nudsf_Unstructured Data Management_Query invocation with the related contexts including established PDU Sessions, the old AMF includes SMF information DNN, S-NSSAI(s) and PDU Session ID, active NGAP UE-TNLA bindings to N3IWF/TNGF/W-AGF, the old AMF includes information about the NGAP UE-TNLA bindings. If the Old AMF was queried in step 4, Old AMF responds to the new AMF for the Namf_Communication_UEContextTransfer invocation by including the UE's SUPI and UE Context.

If old AMF holds information about established PDU Session(s) and it is not an Initial Registration, the old AMF includes SMF information, DNN(s), S-NSSAI(s) and PDU Session ID(s).

If old AMF holds UE context established via N3IWF, W-AGF or TNGF, the old AMF includes the CM state via N3IWF, W-AGF or TNGF. If the UE is in CM-CONNECTED state via N3IWF, W-AGF or TNGF, the old AMF includes information about the NGAP UE-TNLA bindings.

If old AMF fails the integrity check of the Registration Request NAS message, the old AMF shall indicate the integrity check failure. If the new AMF is configured to allow emergency services for unauthenticated UE, the new AMF behaves as follows:
If the UE has only an emergency PDU Session, the AMF either skips the authentication and security procedure or accepts that the authentication may fail and continues the Mobility Registration Update procedure; or
If the UE has both emergency and non emergency PDU Sessions and authentication fails, the AMF continues the Mobility Registration Update procedure and deactivates all the non-emergency PDU Sessions as specified in clause 4.3.4.2.

NOTE 8: The new AMF can determine if a PDU Session is used for emergency service by checking whether the DNN matches the emergency DNN.

If old AMF holds information about AM Policy Association and the information about UE Policy Association (i.e. the Policy Control Request Trigger for updating UE Policy as defined in TS 23.503 [20]), the old AMF includes the information about the AM Policy Association, the UE Policy Association and PCF ID. In the roaming case, V-PCF ID and H-PCF ID are included.

If old AMF was a consumer of UE related NWDAF services, the old AMF includes information about active analytics subscriptions, i.e. the Subscription Correlation ID, NWDAF identifier (i.e. Instance ID or Set ID), Analytics ID(s) and associated Analytics specific data in the Namf_Communication_UEContextTransfer response. Usage of the analytics information by the new AMF is specified in TS 23.288 [50].

During inter PLMN mobility, the handling of the UE Radio Capability ID in the new AMF is as defined in TS 23.501 [2].

NOTE 9: When new AMF uses UDSF for context retrieval, interactions between old AMF, new AMF and UDSF due to UE signalling on old AMF at the same time is implementation issue.

6. [Conditional] new AMF to UE: Identity Request ( )

If the SUCI is not provided by the UE nor retrieved from the old AMF the Identity Request procedure is initiated by AMF sending an Identity Request message to the UE requesting the SUCI.

7. [Conditional] UE to new AMF: Identity Response ( )

The UE responds with an Identity Response message including the SUCI. The UE derives the SUCI by using the provisioned public key of the HPLMN, as specified in TS 33.501 [15].

8. The AMF may decide to initiate UE authentication by invoking an AUSF. In that case, the AMF selects an AUSF based on SUPI or SUCI, as described in clause 6.3.4 of TS 23.501 [2].

If the AMF is configured to support Emergency Registration for unauthenticated SUPIs and the UE indicated Registration type Emergency Registration, the AMF skips the authentication or the AMF accepts that the authentication may fail and continues the Registration procedure.

9a. If authentication is required, the AMF requests it from the AUSF; if Tracing Requirements about the UE are available at the AMF, the AMF provides Tracing Requirements in its request to AUSF. Upon request from the AMF, the AUSF shall execute authentication of the UE. The authentication is performed as described in TS 33.501 [15]. The AUSF selects a UDM as described in clause 6.3.8 of TS 23.501 [2] and gets the authentication data from UDM.

Editor's note: It is FFS how the AUSF executes authentication of the UE, in the case of Disaster Roaming Registration.

Once the UE has been authenticated the AUSF provides relevant security related information to the AMF. If the AMF provided a SUCI to AUSF, the AUSF shall return the SUPI to AMF only after the authentication is successful.

After successful authentication in new AMF, which is triggered by the integrity check failure in old AMF at step 5, the new AMF invokes step 4 above again and indicates that the UE is validated (i.e. through the reason parameter as specified in clause 5.2.2.2.2).

9b If NAS security context does not exist, the NAS security initiation is performed as described in TS 33.501 [15]. If the UE had no NAS security context in step 1, the UE includes the full Registration Request message as defined in TS 24.501 [25].

The AMF decides if the Registration Request needs to be rerouted as described in clause 4.2.2.2.3, where the initial AMF refers to the AMF.

9c. The AMF initiates NGAP procedure to provide the 5G-AN with security context as specified in TS 38.413 if the 5G-AN had requested for UE Context. Also, if the AMF decides that EPS fallback is supported (e.g. based on UE capability to support Request Type flag “handover” for PDN connectivity request during the attach procedure as defined in clause 5.17.2.3.1 of TS 23.501 [2], subscription data and local policy), the AMF shall send an indication “Redirection for EPS fallback for voice is possible” towards 5G-AN as specified in TS 38.413 [10]. Otherwise, the AMF indicates “Redirection for EPS fallback for voice is not possible”. In addition, if Tracing Requirements about the UE are available at the AMF, the AMF provides the 5G-AN with Tracing Requirements in the NGAP procedure.

9d. The 5G-AN stores the security context and acknowledges to the AMF. The 5G-AN uses the security context to protect the messages exchanged with the UE as described in TS 33.501 [15].

10. [Conditional] new AMF to old AMF: Namf_Communication_RegistrationStatusUpdate (PDU Session ID(s) to be released e.g. due to slice not supported).

If the AMF has changed the new AMF informs the old AMF that the registration of the UE in the new AMF is completed by invoking the Namf_Communication_RegistrationStatus Update service operation.

If the authentication/security procedure fails, then the Registration shall be rejected, and the new AMF invokes the Namf_Communication_RegistrationStatus Update service operation with a reject indication towards the old AMF. The old AMF continues as if the UE context transfer service operation was never received.

If one or more of the S-NSSAIs used in the old Registration Area cannot be served in the target Registration Area, the new AMF determines which PDU Session cannot be supported in the new Registration Area. The new AMF invokes the Namf_Communication_RegistrationStatus Update service operation including the rejected PDU Session ID towards the old AMF. Then the new AMF modifies the PDU Session Status correspondingly. The old AMF informs the corresponding SMF(s) to locally release the UE's SM context by invoking the Nsmf_PDUSession_ReleaseSMContext service operation.

If new AMF received in the UE context transfer in step 5 the information about the AM Policy Association and the UE Policy Association and decides, based on local policies, not to use the PCF(s) identified by the PCF ID(s) for the AM Policy Association and the UE Policy Association, then it will inform the old AMF that the AM Policy Association and the UE Policy Association in the UE context is not used any longer and then the PCF selection is performed in step 15.

If the new AMF received in the UE context transfer in step 5 the information about UE related analytics subscription(s), the new AMF may take over the analytics subscription(s) from the old AMF. Otherwise, if the new AMF instead determines to create new analytics subscription(s), it informs the old AMF about the analytics subscriptions (identified by their Subscription Correlation ID) that are not needed any longer and the old AMF may now unsubscribe those NWDAF analytics subscriptions for the UE according to TS 23.288 [50].

11. [Conditional] new AMF to UE: Identity Request/Response (PEI).

If the PEI was not provided by the UE nor retrieved from the old AMF the Identity Request procedure is initiated by AMF sending an Identity Request message to the UE to retrieve the PEI. The PEI shall be transferred encrypted unless the UE performs Emergency Registration and cannot be authenticated.

For an Emergency Registration, the UE may have included the PEI in the Registration Request. If so, the PEI retrieval is skipped.

If the UE supports RACS as indicated in UE MM Core Network Capability, the AMF shall use the PEI of the UE to obtain the IMEI/TAC for the purpose of RACS operation.

12. Optionally the new AMF initiates ME identity check by invoking the N5g-eir_EquipmentIdentity Check_Get service operation (see clause 5.2.4.2.2).

The PEI check is performed as described in clause 4.7.

For an Emergency Registration, if the PEI is blocked, operator policies determine whether the Emergency Registration procedure continues or is stopped.

13. If step 14 is to be performed, the new AMF, based on the SUPI, selects a UDM, then UDM may select a UDR instance. See clause 6.3.9 of TS 23.501 [2].

The AMF selects a UDM as described in clause 6.3.8 of TS 23.501 [2].

14a-c. If the AMF has changed since the last Registration procedure, or if the UE provides a SUPI which doesn't refer to a valid context in the AMF, or if the UE registers to the same AMF it has already registered to a non-3GPP access (i.e. the UE is registered over a non-3GPP access and initiates this Registration procedure to add a 3GPP access), the new AMF registers with the UDM using Nudm_UECM_Registration for the access to be registered (and subscribes to be notified when the UDM deregisters this AMF). In this case, if the AMF does not have event exposure subscription information for this UE, the AMF indicates it to UDM. Then, if the UDM has existing applicable event exposure subscriptions for events detected in AMF for this UE or for any of the groups this UE belongs to (possibly retrieved from UDR), UDM invokes the Namf_EventExposure_Subscribe service for recreating the event exposure subscriptions.

The AMF provides the “Homogenous Support of IMS Voice over PS Sessions” indication (see clause 5.16.3.3 of TS 23.501 [2]) to the UDM. The “Homogenous Support of IMS Voice over PS Sessions” indication shall not be included unless the AMF has completed its evaluation of the support of “IMS Voice over PS Session” as specified in clause 5.16.3.2 of TS 23.501 [2].

During initial Registration, if the AMF and UE supports SRVCC from NG-RAN to UTRAN the AMF provides UDM with the UE SRVCC capability.

If the AMF determines that only the UE SRVCC capability has changed, the AMF sends UE SRVCC capability to the UDM.

NOTE 10: At this step, it is possible that the AMF does not have all the information needed to determine the setting of the IMS Voice over PS Session Supported indication for this UE (see clause 5.16.3.2 of TS 23.501 [2]). Hence the AMF can send the “Homogenous Support of IMS Voice over PS Sessions” later on in this procedure.

If the AMF does not have subscription data for the UE, the AMF retrieves the Access and Mobility Subscription data, SMF Selection Subscription data, UE context in SMF data and LCS mobile origination using Nudm_SDM_Get. If the AMF already has subscription data for the UE but the SoR Update Indicator in the UE context requires the AMF to retrieve SoR information depending on the NAS Registration Type (“Initial Registration” or “Emergency Registration”) (see Annex C of TS 23.122 [22]), the AMF retrieves the Steering of Roaming information using Nudm_SDM_Get. This requires that UDM may retrieve this information from UDR by Nudr_DM_Query. After a successful response is received, the AMF subscribes to be notified using Nudm_SDM_Subscribe when the data requested is modified, UDM may subscribe to UDR by Nudr_DM_Subscribe. The GPSI is provided to the AMF in the Access and Mobility Subscription data from the UDM if the GPSI is available in the UE subscription data. The UDM may provide indication that the subscription data for network slicing is updated for the UE. If the UE is subscribed to MPS in the serving PLMN, “MPS priority” is included in the Access and Mobility Subscription data provided to the AMF. If the UE is subscribed to MCX in the serving PLMN, “MCX priority” is included in the Access and Mobility Subscription data provided to the AMF. The UDM also provides the IAB-Operation allowed indication to AMF as part of the Access and Mobility Subscription data. The AMF shall trigger the setup of the UE context in NG-RAN, or modification of the UE context in NG-RAN if the initial setup is at step 9c, including an indication that the IAB-node is authorized.

Editor's note: It is FFS how the UDM provides applicable subscription data for Disaster Roaming service to the AMF, in the case of Disaster Roaming Registration.

The new AMF provides the Access Type it serves for the UE to the UDM and the Access Type is set to “3GPP access”. The UDM stores the associated Access Type together with the serving AMF and does not remove the AMF identity associated to the other Access Type if any. The UDM may store in UDR information provided at the AMF registration by Nudr_DM_Update.

If the UE was registered in the old AMF for an access, and the old and the new AMFs are in the same PLMN, the new AMF sends a separate/independent Nudm_UECM_Registration to update UDM with Access Type set to access used in the old AMF, after the old AMF relocation is successfully completed.

The new AMF creates an UE context for the UE after getting the Access and Mobility Subscription data from the UDM. The Access and Mobility Subscription data includes whether the UE is allowed to include NSSAI in the 3GPP access RRC Connection Establishment in clear text. The Access and Mobility Subscription data may include Enhanced Coverage Restricted information. If received from the UDM and the UE included support for restriction of use of Enhanced Coverage in step 1, the AMF determines whether Enhanced Coverage is restricted or not for the UE as specified in clause 5.31.12 of TS 23.501 [2] and stores the updated Enhanced Coverage Restricted information in the UE context.

The Access and Mobility Subscription data may include the NB-IoT UE Priority.

The subscription data may contain Service Gap Time parameter. If received from the UDM, the AMF stores this Service Gap Time in the UE Context in AMF for the UE.

For an Emergency Registration in which the UE was not successfully authenticated, the AMF shall not register with the UDM.

The AMF enforces the Mobility Restrictions as specified in clause 5.3.4.1.1 of TS 23.501 [2]. For an Emergency Registration, the AMF shall not check for Mobility Restrictions, access restrictions, regional restrictions or subscription restrictions. For an Emergency Registration, the AMF shall ignore any unsuccessful registration response from UDM and continue with the Registration procedure.

NOTE 11: The AMF can, instead of the Nudm_SDM_Get service operation, use the Nudm_SDM_Subscribe service operation with an Immediate Report Indication that triggers the UDM to immediately return the subscribed data if the corresponding feature is supported by both the AMF and the UDM.

14d. When the UDM stores the associated Access Type (e.g. 3GPP) together with the serving AMF as indicated in step 14a, it will cause the UDM to initiate a Nudm_UECM_DeregistrationNotification (see clause 5.2.3.2.2) to the old AMF corresponding to the same (e.g. 3GPP) access, if one exists. If the timer started in step 5 is not running, the old AMF may remove the UE context for the same Access Type. Otherwise, the AMF may remove UE context for the same Access Type when the timer expires. If the serving NF removal reason indicated by the UDM is Initial Registration, then, as described in clause 4.2.2.3.2, the old AMF invokes the Nsmf_PDUSession_ReleaseSMContext (SM Context ID) service operation towards all the associated SMF(s) of the UE to notify that the UE is deregistered from old AMF for the same Access Type. The SMF(s) shall release the PDU Session on getting this notification.

If the old AMF has established an AM Policy Association and a UE Policy Association with the PCF(s), and the old AMF did not transfer the PCF ID(s) to the new AMF (e.g. new AMF is in different PLMN), the old AMF performs an AMF-initiated Policy Association Termination procedure, as defined in clause 4.16.3.2, and performs an AMF-initiated UE Policy Association Termination procedure, as defined in clause 4.16.13.1. In addition, if the old AMF transferred the PCF ID(s) in the UE context but the new AMF informed in step 10 that the AM Policy Association information and UE Policy Association information in the UE context will not be used then the old AMF performs an AMF-initiated Policy Association Termination procedure, as defined in clause 4.16.3.2, and performs an AMF-initiated UE Policy Association Termination procedure, as defined in clause 4.16.13.1.

If the old AMF has an N2 connection for that UE (e.g. because the UE was in RRC Inactive state but has now moved to E-UTRAN or moved to an area not served by the old AMF), the old AMF shall perform AN Release (see clause 4.2.6) with a cause value that indicates that the UE has already locally released the NG-RAN's RRC Connection.

If the UE context in the old AMF contains an Allowed NSSAI including one or more S-NSSAI(s) subject to NSAC, the old AMF upon receipt of the Nudm_UECM_Deregistration Notification from the UDM, sends an update request message for each S-NSSAI subject to NSAC to the corresponding NSACF(s) with update flag parameter set to decrease (see clause 4.2.11.2).

At the end of registration procedure, the AMF may initiate synchronization of event exposure subscriptions with the UDM if the AMF does not indicate unavailability of event exposure subscription in step 14a.

NOTE 12: The AMF can initiate synchronization with UDM even if events are available in the UE context (e.g. as received from old AMF) at any given time and based on local policy. This can be done during subscription change related event.

14e. [Conditional] If old AMF does not have UE context for another access type (i.e. non-3GPP access), the Old AMF unsubscribes with the UDM for subscription data using Nudm_SDM_unsubscribe.

15. If the AMF decides to initiate PCF communication, the AMF acts as follows.

If the new AMF decides to use the (V-) PCF identified by the (V-) PCF ID included in UE context from the old AMF in step 5, the AMF contacts the (V-) PCF identified by the (V-) PCF ID to obtain policy. If the AMF decides to perform PCF discovery and selection and the AMF selects a (V)-PCF and may select an H-PCF (for roaming scenario) as described in clause 6.3.7.1 of TS 23.501 [2] and according to the V-NRF to H-NRF interaction described in clause 4.3.2.2.3.3.

16. [Optional] new AMF performs an AM Policy Association Establishment/Modification. For an Emergency Registration, this step is skipped.

If the new AMF selects a new (V-) PCF in step 15, the new AMF performs AM Policy Association Establishment with the selected (V-) PCF as defined in clause 4.16.1.2.

If the (V-) PCF identified by the (V-) PCF ID included in UE context from the old AMF is used, the new AMF performs AM Policy Association Modification with the (V-) PCF as defined in clause 4.16.2.1.2.

If the AMF notifies the Mobility Restrictions (e.g. UE location) to the PCF for adjustment, or if the PCF updates the Mobility Restrictions itself due to some conditions (e.g. application in use, time and date), the PCF shall provide the updated Mobility Restrictions to the AMF. If the subscription information includes Tracing Requirements, the AMF provides the PCF with Tracing Requirements.

If the AMF supports DNN replacement, the AMF provides the PCF with the Allowed NSSAI and, if available, the Mapping Of Allowed NSSAI.

If the PCF supports DNN replacement, the PCF provides the AMF with triggers for DNN replacement.

17. [Conditional] AMF to SMF: Nsmf_PDUSession_UpdateSMContext ( )

For an Emergency Registered UE (see TS 23.501 [2]), this step is applied when the Registration Type is Mobility Registration Update.

The AMF invokes the Nsmf_PDUSession_UpdateSMContext (see clause 5.2.8.2.6) in the following scenario(s):
If the List Of PDU Sessions To Be Activated is included in the Registration Request in step 1, the AMF sends Nsmf_PDUSession_UpdateSMContext Request to SMF(s) associated with the PDU Session(s) in order to activate User Plane connections of these PDU Session(s). Steps from step 5 onwards described in clause 4.2.3.2 are executed to complete the User Plane connection activation without sending the RRC Inactive Assistance Information and without sending MM NAS Service Accept from the AMF to (R)AN described in step 12 of clause 4.2.3.2. When a User Plane connection for a PDU Session is activated, the AS layer in the UE indicates it to the NAS layer.
If the AMF has determined in step 3 that the UE is performing Inter-RAT mobility to or from NB-IoT, the AMF sends Nsmf_PDUSession_UpdateSMContext Request to SMF(s) associated with the UEs PDU Session(s), so the SMF(s) can update them according to the “PDU Session continuity at inter RAT mobility” subscription data. Steps from step 5 onwards described in clause 4.2.3.2 are executed without sending MM NAS Service Accept from the AMF to (R)AN described in step 12 of clause 4.2.3.2.

When the serving AMF has changed, the new serving AMF notifies the SMF for each PDU Session that it has taken over the responsibility of the signalling path towards the UE: the new serving AMF invokes the Nsmf_PDUSession_UpdateSMContext service operation using SMF information received from the old AMF at step 5. It also indicates whether the PDU Session is to be re-activated.

NOTE 13: If the UE moves into a different PLMN, the AMF in the serving PLMN can insert or change the V-SMF(s) in the serving PLMN for Home Routed PDU session(s). In this case, the same procedures described in clause 4.23.3 are applied for the V-SMF change as for the I-SMF change (i.e. by replacing the I-SMF with V-SMF). During inter-PLMN change, if the same SMF is used, session continuity can be supported depending on operator policies.

Steps from step 5 onwards described in clause 4.2.3.2 are executed. In the case that the intermediate UPF insertion, removal, or change is performed for the PDU Session(s) not included in “PDU Session(s) to be re-activated”, the procedure is performed without N11 and N2 interactions to update the N3 user plane between (R)AN and 5GC.

The AMF invokes the Nsmf_PDUSession_ReleaseSMContext service operation towards the SMF in the following scenario:
If any PDU Session status indicates that it is released at the UE, the AMF invokes the Nsmf_PDUSession_ReleaseSMContext service operation towards the SMF in order to release any network resources related to the PDU Session.

If the serving AMF is changed, the new AMF shall wait until step 18 is finished with all the SMFs associated with the UE. Otherwise, steps 19 to 22 can continue in parallel to this step.

18. [Conditional] If the new AMF and the old AMF are in the same PLMN, the new AMF sends a UE Context Modification Request to N3IWF/TNGF/W-AGF as specified in TS 29.413 [64].

If the AMF has changed and the old AMF has indicated that the UE is in CM-CONNECTED state via N3IWF, W-AGF or TNGF and if the new AMF and the old AMF are in the same PLMN, the new AMF creates an NGAP UE association towards the N3IWF/TNGF/W-AGF to which the UE is connected. This automatically releases the existing NGAP UE association between the old AMF and the N3IWF/TNGF/W-AGF.

19. N3IWF/TNGF/W-AGF sends a UE Context Modification Response to the new AMF.

19a. [Conditional] After the new AMF receives the response message from the N3IWF, W-AGF or TNGF in step 19, the new AMF registers with the UDM using Nudm_UECM_Registration as step 14a, but with the Access Type set to “non-3GPP access”. The UDM stores the associated Access Type together with the serving AMF and does not remove the AMF identity associated to the other Access Type if any. The UDM may store in UDR information provided at the AMF registration by Nudr_DM_Update.

19b. [Conditional] When the UDM stores the associated Access Type (i.e. non-3GPP) together with the serving AMF as indicated in step 19a, it will cause the UDM to initiate a Nudm_UECM_Deregistration Notification (see clause 5.2.3.2.2) to the old AMF corresponding to the same (i.e. non-3GPP) access. The old AMF removes the UE context for non-3GPP access.

19c. The Old AMF unsubscribes with the UDM for subscription data using Nudm_SDM_unsubscribe.

20a. Void.

21. New AMF to UE: Registration Accept (5G-GUTI, Registration Area, [Mobility restrictions], [PDU Session status], [Allowed NSSAI], [Mapping Of Allowed NSSAI], [Configured NSSAI for the Serving PLMN], [Mapping Of Configured NSSAI], [NSSRG Information], [rejected S-NSSAIs], [Pending NSSAI], [Mapping Of Pending NSSAI], [Periodic Registration Update timer], [Active Time], [Strictly Periodic Registration Timer Indication], [LADN Information], [accepted MICO mode], [IMS Voice over PS session supported Indication], [Emergency Service Support indicator], [Accepted DRX parameters for E-UTRA and NR], [Accepted DRX parameters for NB-IoT], [extended idle mode DRX parameters], [Paging Time Window], [Network support of Interworking without N26], [Access Stratum Connection Establishment NSSAI Inclusion Mode], [Network Slicing Subscription Change Indication], [Operator-defined access category definitions], [List of equivalent PLMNs], [Enhanced Coverage Restricted information], [Supported Network Behaviour], [Service Gap Time], [PLMN-assigned UE Radio Capability ID], [PLMN-assigned UE Radio Capability ID deletion], [WUS Assistance Information], [Truncated 5G-S-TMSI Configuration], [Connection Release Supported], [Paging Cause Indication for Voice Service Supported], [Paging Restriction Supported], [Reject Paging Request Supported]).

If the Requested NSSAI does not include S-NSSAIs which map to S-NSSAIs of the HPLMN subject to Network Slice-Specific Authentication and Authorization and the AMF determines that no S-NSSAI can be provided in the Allowed NSSAI for the UE in the current UE's Tracking Area and if no default S-NSSAI(s) not yet involved in the current UE Registration procedure could be further considered, the AMF shall reject the UE Registration and shall include in the rejection message the list of Rejected S-NSSAIs, each of them with the appropriate rejection cause value.

The Allowed NSSAI for the Access Type for the UE is included in the N2 message carrying the Registration Accept message. The Allowed NSSAI contains only S-NSSAIs that do not require, based on subscription information, Network Slice-Specific Authentication and Authorization and, based on the UE Context in the AMF, those S-NSSAIs for which Network Slice-Specific Authentication and Authorization previously succeeded, regardless of the Access Type. The Mapping Of Pending NSSAI is the mapping of each S-NSSAI of the Pending NSSAI for the Serving PLMN to the HPLMN S-NSSAIS.

If the UE has indicated its support of the Network Slice-Specific Authentication and Authorization procedure in the UE MM Core Network Capability in the Registration Request, AMF includes in the Pending NSSAI the S-NSSAIs that map to an S-NSSAI of the HPLMN which in the subscription information has indication that it is subject to Network Slice-Specific Authentication and Authorization, as described in clause 4.6.2.4 of TS 24.501 [25]. In such case, the AMF then shall trigger at step 25 the Network Slice-Specific Authentication and Authorization procedure, specified in clause 4.2.9.2, except, based on Network policies, for those S-NSSAIs for which Network Slice-Specific Authentication and Authorization have already been initiated on another Access Type for the same S-NSSAI(s). The UE shall not attempt re-registration with the S-NSSAIs included in the list of Pending NSSAIs until the Network Slice-Specific Authentication and Authorization procedure has been completed, regardless of the Access Type.

If the UE has not indicated its support of the Network Slice-Specific Authentication and Authorization procedure in the UE 5GMM Core Network Capability in the Registration Request, and the Requested NSSAI includes S-NSSAIs which map to HPLMN S-NSSAIs subject to Network Slice-Specific Authentication and Authorization, the AMF includes those S-NSSAIs in the Requested NSSAI in the Rejected S-NSSAIs.

If no S-NSSAI can be provided in the Allowed NSSAI because:
all the S-NSSAI(s) in the Requested NSSAI are to be subject to Network Slice-Specific Authentication and Authorization; or
no Requested NSSAI was provided or none of the S-NSSAIs in the Requested NSSAI matches any of the Subscribed S-NSSAIs, and all the S-NSSAI(s) marked as default in the Subscribed S-NSSAIs are to be subject to Network Slice-Specific Authentication and Authorization.

The AMF shall provide an empty Allowed NSSAI. Upon receiving an empty Allowed NSSAI and a Pending NSSAI, the UE is registered in the PLMN but shall wait for the completion of the Network Slice-Specific Authentication and Authorization procedure without attempting to use any service provided by the PLMN on any access, except e.g. emergency services (see TS 24.501 [25]), until the UE receives an Allowed NSSAI.

The AMF stores the NB-IoT Priority retrieved in Step 14 and associates it to the 5G-S-TMSI allocated to the UE.

If the Registration Request message received over 3GPP access does not include any Paging Restriction Information, the AMF shall delete any stored Paging Restriction Information for this UE and stop restricting paging accordingly.

If the Registration Request message received over 3GPP access includes a Release Request indication, then:
the AMF updates the UE context with any received Paging Restriction Information, then enforces it in the network triggered Service Request procedure as described in clause 4.2.3.3:
the AMF does not establish User Plane resources and triggers the AN release procedure as described in clause 4.2.6 after the completion of Registration procedure.

The AMF sends a Registration Accept message to the UE indicating that the Registration Request has been accepted. 5G-GUTI is included if the AMF allocates a new 5G-GUTI. Upon receiving a Registration Request message of type “Initial Registration”, “mobility registration update”, or “Disaster Roaming Registration” from the UE, the AMF shall include a new 5G-GUTI in the Registration Accept message. Upon receiving a Registration Request message of type “periodic registration update” from the UE, the AMF should include a new 5G-GUTI in the Registration Accept message. If the UE is already in RM-REGISTERED state via another access in the same PLMN, the UE shall use the 5G-GUTI received in the Registration Accept for both registrations. If no 5G-GUTI is included in the Registration Accept, then the UE uses the 5G-GUTI assigned for the existing registration also for the new registration. If the AMF allocates a new Registration area, it shall send the Registration area to the UE via Registration Accept message. For a Disaster Roaming Registration, the AMF allocates the Registration Area limited to the area with Disaster Condition as specified in clause 5.40 of TS 23.501 [2]. If there is no Registration area included in the Registration Accept message, the UE shall consider the old Registration Area as valid. Mobility Restrictions is included if mobility restrictions applies for the UE and Registration Type is not Emergency Registration. The AMF indicates the established PDU Sessions to the UE in the PDU Session status. The UE removes locally any internal resources related to PDU Sessions that are not marked as established in the received PDU Session status. If the AMF invokes the Nsmf_PDUSession_UpdateSMContext procedure for UP activation of PDU Session(s) in step 18 and receives rejection from the SMF, then the AMF indicates to the UE the PDU Session ID and the cause why the User Plane resources were not activated. When the UE is connected to the two AMFs belonging to different PLMN via 3GPP access and non-3GPP access then the UE removes locally any internal resources related to the PDU Session of the current PLMN that are not marked as established in received PDU Session status. If the PDU Session status information was in the Registration Request, the AMF shall indicate the PDU Session status to the UE.

If the RAT Type is NB-IoT and the network is configured to use the Control Plane Relocation Indication procedure then the AMF shall include in the Registration Accept message the Truncated 5G-S-TMSI Configuration that the UE using Control Plane CIOT 5GS Optimisation uses to create the Truncated 5G-S-TMSI, see clause 5.31.4.3 of TS 23.501 [2].

The Allowed NSSAI provided in the Registration Accept is valid in the Registration Area and it applies for all the PLMNs which have their Tracking Areas included in the Registration Area. The Mapping Of Allowed NSSAI is the mapping of each S-NSSAI of the Allowed NSSAI to the HPLMN S-NSSAIs. The Mapping Of Configured NSSAI is the mapping of each S-NSSAI of the Configured NSSAI for the Serving PLMN to the HPLMN S-NSSAIs.

If the UE has indicated its support of the subscription-based restrictions to simultaneous registration of network slices feature, the AMF includes, if available, the NSSRG Information, defined in clause 5.15.12 of TS 23.501 [2].

If the UE has not indicated its support of the subscription-based restrictions to simultaneous registration of network slices feature, and the subscription information for the UE includes SRG information, and the AMF is providing the Configured NSSAI to the UE, the Configured NSSAI shall include the S-NSSAIs according to clause 5.15.12 of TS 23.501 [2].

The AMF shall include in the Registration Accept message the LADN Information for the list of LADNs, described in clause 5.6.5 of TS 23.501 [2], that are available within the Registration area determined by the AMF for the UE. The AMF may include Operator-defined access category definitions to let the UE determine the applicable Operator-specific access category definitions as described in TS 24.501 [25].

If the UE included MICO mode in the Registration Request, then AMF responds in the Registration Accept message whether MICO mode should be used. When MICO mode is allowed for the UE, the AMF may include an Active Time value and/or Strictly Periodic Registration Timer Indication in the Registration Accept message. The AMF determines the Periodic Registration Update timer value, Active Time value and the Strictly Periodic Registration Timer Indication based on local configuration, Expected UE Behaviour if available, UE indicated preferences, UE capability, UE subscription information and network policies, or any combination of them so as to enable UE power saving, as described in clause 5.31.7 of TS 23.501 [2]. The AMF determines to apply the Strictly Periodic Registration Timer Indication to the UE if the UE indicates its capability of the Strictly Periodic Registration Timer Indication in the registration request message, as described in step 1. If the AMF provides the Periodic Registration Update timer value with the Strictly Periodic Registration Timer Indication to the UE, the UE and the AMF start the Periodic Registration Update timer after this step, as described in clause 5.31.7.5 of TS 23.501 [2].

In the case of registration over 3GPP access, the AMF Sets the IMS Voice over PS session supported Indication as described in clause 5.16.3.2 of TS 23.501 [2]. In order to set the IMS Voice over PS session supported Indication the AMF may need to perform the UE Capability Match Request procedure in clause 4.2.8a to check the compatibility of the UE and NG-RAN radio capabilities related to IMS Voice over PS. If the AMF hasn't received Voice Support Match Indicator from the NG-RAN on time then, based on implementation, AMF may set IMS Voice over PS session supported Indication and update it at a later stage.

In the case of registration over 3GPP access and the AMF has retrieved or determined according to local configuration a Target NSSAI and a corresponding RFSP Index for the purpose of allowing the NG-RAN to redirect the UE to a cell supporting network slices not available in the current TA as described in clause 5.3.4.3.3 of TS 23.501 [2], the AMF provides the Target NSSAI and the corresponding RFSP Index to the NG-RAN.

In the case of registration over non-3GPP access, the AMF Sets the IMS Voice over PS session supported Indication as described in clause 5.16.3.2a of TS 23.501 [2].

The Emergency Service Support indicator informs the UE that emergency services are supported, i.e. the UE is allowed to request PDU Session for emergency services. If the AMF received “MPS priority” from the UDM as part of Access and Mobility Subscription data, based on operator policy, “MPS priority” is included in the Registration Accept message to the UE to inform the UE whether configuration of Access Identity 1 is valid within the selected PLMN, as specified in TS 24.501 [25]. If the AMF received “MCX priority” from the UDM as part of Access and Mobility Subscription data, based on operator policy and UE subscription to MCX Services, “MCX priority” is included in the Registration Accept message to the UE to inform the UE whether configuration of Access Identity 2 is valid within the selected PLMN, as specified in TS 24.501 [25]. The Accepted DRX parameters are defined in clause 5.4.5 of TS 23.501 [2]. The AMF includes Accepted DRX parameters for NB-IoT, if the UE included Requested DRX parameters for NB-IoT in the Registration Request message. The AMF Sets the Network support of Interworking without N26 parameter as described in clause 5.17.2.3.1 of TS 23.501 [2]. If the AMF accepts the use of extended idle mode DRX, the AMF includes the extended idle mode DRX parameters and Paging Time Window as described in 5.31.7.2 of TS 23.501 [2].

If the UDM intends to indicate the UE that subscription has changed, the Network Slicing Subscription Change Indication is included. If the AMF includes Network Slicing Subscription Change Indication, then the UE shall locally erase all the network slicing configuration for all PLMNs and, if applicable, update the configuration for the current PLMN based on any received information.

The Access Stratum Connection Establishment NSSAI Inclusion Mode, as specified in clause 5.15.9 of TS 23.501 [2], is included to instruct the UE on what NSSAI, if any, to include in the Access Stratum connection establishment. The AMF can set the value to modes of operation a, b, c defined in clause 5.15.9 of TS 23.501 [2] in the 3GPP Access only if the Inclusion of NSSAI in RRC Connection Establishment Allowed indicates that it is allowed to do so.

For a UE registered in a PLMN, the AMF may provide a List of equivalent PLMNs which is handled as specified in TS 24.501 [25]. For a UE registered in an SNPN, the AMF shall not provide a list of equivalent PLMNs to the UE.

If the UE included support for restriction of use of Enhanced Coverage in step 1, the AMF sends the Enhanced Coverage Restricted information to the NG-RAN in N2 message. The AMF also sends Enhanced Coverage Restricted information to the UE in the Registration Accept message.

If the UE receives Enhanced Coverage Restricted information in the Registration Accept message, the UE shall store this information and shall use the value of Enhanced Coverage Restricted information to determine if Enhanced Coverage feature should be used or not.

If the UE and the AMF have negotiated to enable MICO mode and the AMF uses the Extended connected timer, then the AMF provides the Extended Connected time value to NG-RAN (see clause 5.31.7.3 of TS 23.501 [2]) in this step. The Extended Connected Time value indicates the minimum time the RAN should keep the UE in RRC-CONNECTED state regardless of inactivity.

The AMF indicates the CIOT 5GS Optimisations it supports and accepts in the Supported Network Behaviour information (see clause 5.31.2 of TS 23.501 [2]) if the UE included Preferred Network Behaviour in its Registration Request.

The AMF may steer the UE from 5GC by rejecting the Registration Request. The AMF should take into account the Preferred and Supported Network Behaviour (see clause 5.31.2 of TS 23.501 [2]) and availability of EPC to the UE before steering the UE from 5GC.

If the AMF accepts MICO mode and knows there may be mobile terminated data or signalling pending, the AMF maintains the N2 connection for at least the Extended Connected Time as described in clause 5.31.7.3 of TS 23.501 [2], and provides the Extended Connected Time value to the RAN.

The AMF includes Service Gap Time if Service Gap Time is present in the subscription information (steps 14a-c) or the Service Gap Time has been updated by the Subscriber Data Update Notification to AMF procedure (see clause 4.5.1) and the UE has indicated UE Service Gap Control Capability.

If the UE receives a Service Gap Time in the Registration Accept message, the UE shall store this parameter and apply Service Gap Control (see clause 5.31.16 of TS 23.501 [2]).

If the network supports WUS grouping (see TS 23.501 [2]), the AMF shall send the WUS Assistance Information to the UE. If the UE provided the UE paging probability information in Step 1, the AMF takes it into account to determine the WUS Assistance Information.

When the UE and the AMF supports RACS as defined in clause 5.4.4.1a of TS 23.501 [2], and the AMF needs to configure the UE with a UE Radio Capability ID, and the AMF already has the UE radio capabilities other than NB-IoT radio capabilities for the UE, the AMF may provide the UE with the UE Radio Capability ID for the UE radio capabilities the UCMF returns to the AMF in a Nucmf_assign service operation for this UE. Alternatively, when the UE and the AMF support RACS, the AMF may provide the UE with an indication to delete any PLMN-assigned UE Radio Capability ID in this PLMN (see clause 5.4.4.1a of TS 23.501 [2]).

If the UE is “CAG supported”, and the AMF needs to update the CAG information of the UE, the AMF may include the CAG information as part of the Mobility Restrictions in the Registration Accept message.

If the UE indicates support for the Paging Cause Indication for Voice Service feature in the Registration Request message and if the network supports and intends to apply the Paging Cause Indication for Voice Service feature for the UE, the AMF includes an indication that the UE supports the Paging Cause Indication for Voice Service feature in the N2 message carrying the Registration Accept message.

If the Multi-USIM UE has indicated support for one or more Multi-USIM Specific Capabilities in the UE 5GMM Core Network Capability in step 1, the AMF shall indicate to the Multi-USIM UE whether the corresponding one or more Multi-USIM specific features described in clause 5.38 of TS 23.501 [2] are supported, based on network capability and preference by the network (i.e. based on local network policy), by providing one or more of the Connection Release Supported, Paging Cause Indication for Voice Service Supported, Paging Restriction Supported and Reject Paging Request Supported indications. If the Multi-USIM UE has indicated support for the Paging Cause Indication for Voice Service feature, the AMF supporting the Paging Cause Indication for Voice Service shall include an indication in the N2 message that the UE supports the Paging Cause Indication for Voice Service feature. The AMF shall only indicate Paging Restriction Supported together with either Connection Release Supported or Reject Paging Request Supported. The UE shall only use Multi-USIM specific features that the AMF indicated as being supported.

21b. [Optional] The new AMF performs a UE Policy Association Establishment as defined in clause 4.16.11. For an Emergency Registration, this step is skipped.

The new AMF sends a Npcf_UEPolicy Control Create Request to PCF. PCF sends a Npcf_UEPolicy Control Create Response to the new AMF.

PCF triggers UE Configuration Update Procedure as defined in clause 4.2.4.3.

22. [Conditional] UE to new AMF: Registration Complete ( )

The UE sends a Registration Complete message to the AMF when it has successfully updated itself after receiving any of the [Configured NSSAI for the Serving PLMN], [Mapping Of Configured NSSAI], [NSSRG Information] and a Network Slicing Subscription Change Indication, or CAG information in step 21.

The UE sends a Registration Complete message to the AMF to acknowledge if a new 5G-GUTI was assigned.

If new 5G-GUTI was assigned, then the UE passes the new 5G-GUTI to its 3GPP access' lower layer when a lower layer (either 3GPP access or non-3GPP access) indicates to the UE's RM layer that the Registration Complete message has been successfully transferred across the radio interface.

NOTE 14: The above is needed because the NG-RAN may use the RRC Inactive state and a part of the 5G-GUTI is used to calculate the Paging Frame (see TS 38.304 and TS 36.304 [43]). It is assumed that the Registration Complete is reliably delivered to the AMF after the 5G-AN has acknowledged its receipt to the UE.

When the List Of PDU Sessions To Be Activated is not included in the Registration Request and the Registration procedure was not initiated in CM-CONNECTED state, the AMF releases the signalling connection with UE, according to clause 4.2.6.

When the Follow-on request is included in the Registration Request, the AMF should not release the signalling connection after the completion of the Registration procedure.

If the AMF is aware that some signalling is pending in the AMF or between the UE and the 5GC, the AMF should not release the signalling connection immediately after the completion of the Registration procedure.

If PLMN-assigned UE Radio Capability ID is included in step 21, the AMF stores the PLMN-assigned UE Radio Capability ID in UE context if receiving Registration Complete message.

If the UE receives PLMN-assigned UE Radio Capability ID deletion indication in step 21, the UE shall delete the PLMN-assigned UE Radio Capability ID(s) for this PLMN.

23. [Conditional] AMF to UDM: If the Access and Mobility Subscription data provided by UDM to AMF in 14b includes Steering of Roaming information with an indication that the UDM requests an acknowledgement of the reception of this information from the UE, the AMF provides the UE acknowledgement to UDM using Nudm_SDM_Info. For more details regarding the handling of Steering of Roaming information refer to TS 23.122 [22].

23a. For Registration over 3GPP Access, if the AMF does not release the signalling connection, the AMF sends the RRC Inactive Assistance Information to the NG-RAN.

For Registration over non-3GPP Access, if the UE is also in CM-CONNECTED state on 3GPP access, the AMF sends the RRC Inactive Assistance Information to the NG-RAN.

The AMF also uses the Nudm_SDM_Info service operation to provide an acknowledgment to UDM that the UE received CAG information, or the Network Slicing Subscription Change Indication (see step 21 and step 22) and acted upon it.

24. [Conditional] AMF to UDM: After step 14a, and in parallel to any of the preceding steps, the AMF shall send a “Homogeneous Support of IMS Voice over PS Sessions” indication to the UDM using Nudm_UECM_Update:

If the AMF has evaluated the support of IMS Voice over PS Sessions, see clause 5.16.3.2 of TS 23.501 [2], and

If the AMF determines that it needs to update the Homogeneous Support of IMS Voice over PS Sessions, see clause 5.16.3.3 of TS 23.501 [2].

25. [Conditional] If the UE indicates its support for Network Slice-Specific Authentication and Authorization procedure in the UE MM Core Network Capability in Registration Request, and any S-NSSAI of the HPLMN is subject to Network Slice-Specific Authentication and Authorization, the related procedure is executed at this step (see clause 4.2.9.1). Once the Network Slice-Specific Authentication and Authorization procedure is completed for all S-NSSAIs, the AMF shall trigger a UE Configuration Update procedure to deliver an Allowed NSSAI containing also the S-NSSAIs for which the Network Slice-Specific Authentication and Authorization was successful, and include any rejected NSSAIs with an appropriate rejection cause value.

The AMF shall remove the mobility restriction if the Tracking Areas of the Registration Area were previously assigned as a Non-Allowed Area due to pending Network Slice-Specific Authentication and Authorization.

The AMF stores an indication in the UE context for any S-NSSAI of the HPLMN subject to Network Slice-Specific Authentication and Authorization for which the Network Slice-Specific Authentication and Authorization succeeds.

Once completed the Network Slice-Specific Authentication and Authorization procedure, if the AMF determines that no S-NSSAI can be provided in the Allowed NSSAI for the UE, which is already authenticated and authorized successfully by a PLMN, and if no default S-NSSAI(s) could be further considered, the AMF shall execute the Network-initiated Deregistration procedure described in clause 4.2.2.3.3, and shall include in the explicit DeRegistration Request message the list of Rejected S-NSSAIs, each of them with the appropriate rejection cause value.

The mobility related event notifications towards the NF consumers are triggered at the end of this procedure for cases as described in clause 4.15.4.

### <4.2.2.2.2 General Registration>

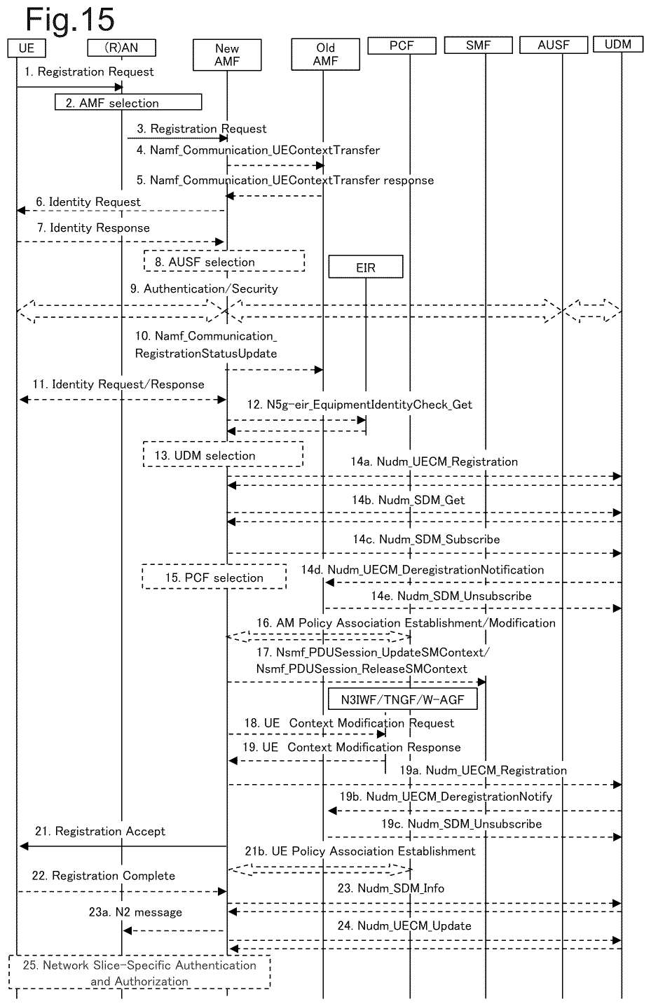

FIG. 4.2.2.2.2-1: Registration procedure (See FIG. 15)

1. UE to (R)AN: AN message (AN parameters, Registration Request (Registration type, SUCI or 5G-GUTI or PEI, [last visited TAI (if available)], Security parameters, [Requested NSSAI], [Mapping Of Requested NSSAI], [Default Configured NSSAI Indication], [UE Radio Capability Update], [UE MM Core Network Capability], [PDU Session status], [List Of PDU Sessions To Be Activated], [Follow-on request], [MICO mode preference], [Requested Active Time], [Requested DRX parameters for E-UTRA and NR], [Requested DRX parameters for NB-IoT], [extended idle mode DRX parameters], [LADN DNN(s) or Indicator Of Requesting LADN Information], [NAS message container], [Support for restriction of use of Enhanced Coverage], [Preferred Network Behaviour], [UE paging probability information], [UE Policy Container (the list of PSIs, indication of UE support for ANDSP and the operating system identifier)] and [UE Radio Capability ID], [Release Request indication], [Paging Restriction Information], PEI, [NSSRG handling support indication], [PLMN with Disaster Condition], the NAS connection identifier)).

NOTE 1: The UE Policy Container and its usage is defined in TS 23.503 [20].

In the case of NG-RAN, the AN parameters include e.g. 5G-S-TMSI or GUAMI, the Selected PLMN ID (or PLMN ID and NID, see clause 5.30 of TS 23.501 [2]) and NSSAI information, the AN parameters also include Establishment cause. The Establishment cause provides the reason for requesting the establishment of an RRC connection. Whether and how the UE includes the NSSAI information as part of the AN parameters is dependent on the value of the Access Stratum Connection Establishment NSSAI Inclusion Mode parameter, as specified in clause 5.15.9 of TS 23.501 [2].

The AN parameters shall also include an IAB-Indication if the UE is an IAB-node accessing 5GS.

The Registration type indicates if the UE wants to perform an Initial Registration (i.e. the UE is in RM-DEREGISTERED state), a Mobility Registration Update (i.e. the UE is in RM-REGISTERED state and initiates a Registration procedure due to mobility or due to the UE needs to update its capabilities or protocol parameters, or to request a change of the set of network slices it is allowed to use), a Periodic Registration Update (i.e. the UE is in RM-REGISTERED state and initiates a Registration procedure due to the Periodic Registration Update timer expiry, see clause 4.2.2.2.1), an Emergency Registration (i.e. the UE is in limited service state), or a Disaster Roaming Registration.

When the UE is using E-UTRA, the UE indicates its support of CIOT 5GS Optimisations, which is relevant for the AMF selection, in the RRC connection establishment signalling associated with the Registration Request.

When the UE is performing an Initial Registration or a Disaster Roaming Registration the UE shall indicate its UE identity in the Registration Request message as follows, listed in decreasing order of preference in the case of registration with a PLMN:
i) a 5G-GUTI mapped from an EPS GUTI, if the UE has a valid EPS GUTI.
ii) a native 5G-GUTI assigned by the PLMN to which the UE is attempting to register, if available;
iii) a native 5G-GUTI assigned by an equivalent PLMN to the PLMN to which the UE is attempting to register, if available;
iv) a native 5G-GUTI assigned by any other PLMN, if available.

NOTE 2: This can also be a 5G-GUTIs assigned via another access type.
v) Otherwise, the UE shall include its SUCI in the Registration Request as defined in TS 33.501 [15].

If the UE is registering with an SNPN, when the UE is performing an Initial Registration the UE shall indicate its UE identity in the Registration Request message as follows, listed in decreasing order of preference:
i) a native 5G-GUTI assigned by the same SNPN to which the UE is attempting to register, if available;
ii) a native 5G-GUTI assigned by any other SNPN along with the NID of the SNPN that assigned the 5G-GUTI, if available;
iii) Otherwise, the UE shall include its SUCI in the Registration Request as defined in TS 33.501 [15].

When the UE performing an Initial Registration has both a valid EPS GUTI and a native 5G-GUTI, the UE shall also indicate the native 5G-GUTI as Additional GUTI. If more than one native 5G-GUTIs are available, the UE shall select the 5G-GUTI in decreasing order of preference among items (ii)-(iv) in the list above.

The NAS message container shall be included if the UE is sending a Registration Request message as an Initial NAS message and the UE has a valid 5G NAS security context and the UE needs to send non-cleartext IEs, see clause 4.4.6 in TS 24.501 [25]. If the UE does not need to send non-cleartext IEs, the UE shall send a Registration Request message without including the NAS message container.

If the UE does not have a valid 5G NAS security context, the UE shall send the Registration Request message without including the NAS message container. The UE shall include the entire Registration Request message (i.e. containing cleartext IEs and non-cleartext IEs) in the NAS message container that is sent as part of the Security Mode Complete message in step 9b.

When the UE is performing an Initial Registration (i.e., the UE is in RM-DEREGISTERED state) with a native 5G-GUTI then the UE shall indicate the related GUAMI information in the AN parameters. When the UE is performing an Initial Registration with its SUCI, the UE shall not indicate any GUAMI information in the AN parameters.

When the UE is performing an Initial Registration or a Mobility Registration and if CIoT 5GS Optimisations are supported the UE shall indicate its Preferred Network Behaviour (see clause 5.31.2 of TS 23.501 [2]). If SI mode is supported the UE's EPC Preferred Network Behaviour is included in the SI UE network capabilities in the Registration Request message, see clause 8.2.6.1 of TS 24.501 [25].

For an Emergency Registration, the SUCI shall be included if the UE does not have a valid 5G-GUTI available; the PEI shall be included when the UE has no SUPI and no valid 5G-GUTI. In other cases, the 5G-GUTI is included and it indicates the last serving AMF.

The UE may provide the UE's usage setting based on its configuration as defined in clause 5.16.3.7 of TS 23.501 [2]. The UE provides Requested NSSAI (as described in clause 5.15.5.2.1 of TS 23.501 [2] and, if the UE supports the subscription-based restrictions to simultaneous registration of network slices, also taking into account the NSSRG Information constraints as described in clause 5.15.12 of TS 23.501 [2] and, in the case of Initial Registration or Mobility Registration Update, the UE includes the Mapping Of Requested NSSAI (if available), which is the mapping of each S-NSSAI of the Requested NSSAI to the HPLMN S-NSSAIs, to ensure that the network is able to verify whether the S-NSSAI(s) in the Requested NSSAI are permitted based on the Subscribed S-NSSAIs. In the case of inter PLMN mobility, if the serving PLMN S-NSSAI(s) corresponding to the established PDU Session(s) are not present in the UE, the associated HPLMN S-NSSAI(s) associated with the established PDU Session(s) shall be provided in the Mapping Of Requested NSSAI as described in clause 5.15.5.2.1 TS 23.501 [2].

The UE includes the Default Configured NSSAI Indication if the UE is using a Default Configured NSSAI, as defined in TS 23.501 [2].

The UE may include UE paging probability information if it supports the assignment of WUS Assistance Information from the AMF (see TS 23.501 [2]).

In the case of Mobility Registration Update, the UE includes in the List Of PDU Sessions To Be Activated the PDU Sessions for which there are pending uplink data. When the UE includes the List Of PDU Sessions To Be Activated, the UE shall indicate PDU Sessions only associated with the access the Registration Request is related to. As defined in TS 24.501 the UE shall include always-on PDU Sessions which are accepted by the network in the List Of PDU Sessions To Be Activated even if there are no pending uplink data for those PDU Sessions.

NOTE 3: A PDU Session corresponding to a LADN is not included in the List Of PDU Sessions To Be Activated when the UE is outside the area of availability of the LADN.

The UE MM Core Network Capability is provided by the UE and handled by AMF as defined in clause 5.4.4a of TS 23.501 [2]. The UE includes in the UE MM Core Network Capability an indication if it supports Request Type flag “handover” for PDN connectivity request during the attach procedure as defined in clause 5.17.2.3.1 of TS 23.501 [2]. If the UE supports ‘Strictly Periodic Registration Timer Indication’, the UE indicates its capability of ‘Strictly Periodic Registration Timer Indication’ in the UE MM Core Network Capability. If the UE supports CAG, the UE indicates its capability of “CAG supported” in the UE MM Core Network Capability. If the UE operating two or more USIMs, supports and intends to use one or more Multi-USIM feature(s), the UE indicates one or more Multi-USIM specific features described in clause 5.38 of TS 23.501 [2] in the UE MM Core Network Capability.

The UE may provide either the LADN DNN(s) or an Indication Of Requesting LADN Information as described in clause 5.6.5 of TS 23.501 [2].

If available, the last visited TAI shall be included in order to help the AMF produce Registration Area for the UE.

The Security parameters are used for Authentication and integrity protection, see TS 33.501 [15]. Requested NSSAI indicates the Network Slice Selection Assistance Information (as defined in clause 5.15 of TS 23.501 [2]). The PDU Session status indicates the previously established PDU Sessions in the UE. When the UE is connected to the two AMFs belonging to different PLMN via 3GPP access and non-3GPP access then the PDU Session status indicates the established PDU Session of the current PLMN in the UE.

The Follow-on request is included when the UE has pending uplink signalling and the UE doesn't include List Of PDU Sessions To Be Activated, or the Registration type indicates the UE wants to perform an Emergency Registration. In Initial Registration and Mobility Registration Update, UE provides the UE Requested DRX parameters, as defined in clause 5.4.5 of TS 23.501 [2]. The UE may provide the extended idle mode DRX parameters as defined in clause 5.31.7.2 of TS 23.501 [2] to request extended idle mode DRX.

The UE provides UE Radio Capability Update indication as described in TS 23.501 [2].

The UE includes the MICO mode preference and optionally a Requested Active Time value if the UE wants to use MICO Mode with Active Time.

The UE may indicate its Service Gap Control Capability in the UE MM Core Network Capability, see clause 5.31.16 of TS 23.501 [2].

For a UE with a running Service Gap timer in the UE, the UE shall not set Follow-on Request indication or Uplink data status in the Registration Request message (see clause 5.31.16 of TS 23.501 [2]), except for network access for regulatory prioritized services like Emergency services or exception reporting.

If UE supports RACS and has been assigned UE Radio Capability ID(s), the UE shall indicate a UE Radio Capability ID as defined in clause 5.4.4.1a of TS 23.501 [2] as non-cleartext IE.

The PEI may be retrieved in initial registration from the UE as described in clause 4.2.2.2.1.

If a UE supports the subscription-based restrictions to simultaneous registration of network slices feature, it includes the NSSRG handling support indication according to clause 5.15.12 of TS 23.501 [2]. The AMF stores whether the UE supports this feature in the UE context.

When a UE in MUSIM mode wants to enter CM-IDLE state immediately e.g. after having performed mobility or periodic registration, it includes the Release Request indication and optionally provides Paging Restriction Information.

When the UE is performing a Disaster Roaming Registration, the UE may indicate the PLMN with Disaster Condition if UE does not have valid 5G-GUTI indicating the PLMN with Disaster Condition and the PLMN with Disaster Condition is not the HPLMN of the UE or the PLMN with Disaster Condition is the HPLMN of the UE but the UE does not provide its SUCI.

The UE includes the NAS connection identifier with a value set to the 3GPP access if the 5G NAS security context corresponding to the 3GPP access is used to integrity protect the registration request message. This information element may be sent as a cleartext IE.

2. If a 5G-S-TMSI or GUAMI is not included or the 5G-S-TMSI or GUAMI does not indicate a valid AMF the (R)AN, based on (R) AT and Requested NSSAI, if available, selects an AMF

The (R)AN selects an AMF as described in clause 6.3.5 of TS 23.501 [2]. If UE is in CM-CONNECTED state, the (R)AN can forward the Registration Request message to the AMF based on the N2 connection of the UE.

If the (R)AN cannot select an appropriate AMF, it forwards the Registration Request to an AMF which has been configured, in (R)AN, to perform AMF selection.

3. (R)AN to new AMF: N2 message (N2 parameters, Registration Request (as described in step 1) and [LTE-M Indication].

When NG-RAN is used, the N2 parameters include the Selected PLMN ID (or PLMN ID and NID, see clause 5.30 of TS 23.501 [2]), Location Information and Cell Identity related to the cell in which the UE is camping, UE Context Request which indicates that a UE context including security information needs to be setup at the NG-RAN.

When NG-RAN is used, the N2 parameters shall also include the Establishment cause and IAB-Indication if the indication is received in AN parameters in step 1.

Mapping Of Requested NSSAI is provided only if available.

If the Registration type indicated by the UE is Periodic Registration Update, then steps 4 to 19 may be omitted.

When the Establishment cause is associated with priority services (e.g. MPS, MCS), the AMF includes a Message Priority header to indicate priority information. Other NFs relay the priority information by including the Message Priority header in service-based interfaces, as specified in TS 29.500 [17].

The RAT Type the UE is using is determined (see clause 4.2.2.2.1) and based on it the AMF determines whether the UE is performing Inter-RAT mobility to or from NB-IoT. If the AMF receives the LTE M indication, then it considers that the RAT Type is LTE-M and stores the LTE-M Indication in UE Context.

If a UE includes a Preferred Network Behaviour, this defines the Network Behaviour the UE supports and is expecting to be available in the network as defined in clause 5.31.2 of TS 23.501 [2].

If the UE has included the Preferred Network Behaviour, and what the UE indicated it supports in Preferred Network Behaviour is incompatible with the network support, the AMF shall reject the Registration Request with an appropriate cause value (e.g. one that avoids retries on this PLMN).

If there is a Service Gap timer running in the UE Context in AMF for the UE, and Follow-on Request indication or Uplink data status is included in the Registration Request message, the AMF shall ignore the Follow-on Request indication and Uplink data status and not perform any of the actions related to the status.

If the UE has included a UE Radio Capability ID in step 1 and the AMF supports RACS, the AMF stores the Radio Capability ID in UE context.

For NR satellite access, if the AMF can determine based on the Selected PLMN ID and ULI (including Cell ID) received from the gNB that the UE is attempting to register to a PLMN that is not allowed to operate at the present UE location, then the AMF should reject the Registration Request indicating a suitable Cause value and, if known in AMF, the country of the UE location. Otherwise, e.g. if the AMF is not aware of the UE location with sufficient accuracy to make a final decision, the AMF proceeds with the Registration procedure and may initiate UE location procedure as specified in clause 6.10.1 of TS 23.273 and be prepared to deregister the UE if the information received from LMF proves that the UE is registered to a PLMN that is not allowed to operate in the UE location.

NOTE 4: The location information cannot be guaranteed to be sufficiently accurate for the AMF to determine in all cases the country where UE is located.

NOTE 5: Some countries use multiple MCCs and some MCCs, such as 901, can be allowed in multiple countries and therefore the UE can register in a PLMN with MCC different from the one returned to the UE.

Upon receiving a Registration Reject with the country in which the UE is located, the UE shall attempt to register to a PLMN that is allowed to operate at the UE location as specified in TS 23.122 [22].

For a Disaster Roaming Registration, based on the ULI (including Cell ID) received from the NG-RAN, the PLMN with Disaster Condition derived from the UE's 5G-GUTI, derived from the UE's SUCI or indicated by the UE and the local configuration, the AMF determines if Disaster Roaming service can be provided. If the current location is not subject to Disaster Roaming service or the Disaster Roaming service is not provided to the PLMN with Disaster Condition derived from the UE's 5G-GUTI, derived from the UE's SUCI or indicated by UE, then the AMF should reject the Registration Request indicating a suitable Cause value.

4. [Conditional] new AMF to old AMF: Namf_Communication_UEContextTransfer (complete Registration Request, the NAS connection identifier) or new AMF to UDSF: Nudsf_Unstructured Data Management_Query ( )

The new AMF determines the old AMF using the UE's 5G-GUTI. If the new AMF received an NID in the Registration request, it determines that the 5G-GUTI was assigned by an SNPN and determines the old AMF using the 5G-GUTI and NID of the SNPN.

(With UDSF Deployment): If the UE's 5G-GUTI was included in the Registration Request and the serving AMF has changed since last Registration procedure, new AMF and old AMF are in the same AMF Set and UDSF is deployed, the new AMF retrieves the stored UE's SUPI and UE context directly from the UDSF using Nudsf_UnstructuredDataManagement_Query service operation or they can share stored UE context via implementation specific means if UDSF is not deployed. This includes also event subscription information by each NF consumer for the given UE. In this case, the new AMF uses integrity protected complete Registration request NAS message to perform and verify integrity protection.

(Without UDSF Deployment): If the UE's 5G-GUTI was included in the Registration Request and the serving AMF has changed since last Registration procedure, the new AMF may invoke the Namf_Communication_UEContextTransfer service operation on the old AMF including the complete Registration Request NAS message, which may be integrity protected, as well as the Access Type, to request the UE's SUPI and UE Context. The old AMF may include the NAS connection identifier as received in the complete registration request. See clause 5.2.2.2.2 for details of this service operation. In this case, the old AMF uses either 5G-GUTI and the integrity protected complete Registration request NAS message, or the SUPI and an indication that the UE is validated from the new AMF, to verify integrity protection if the context transfer service operation invocation corresponds to the UE requested. The old AMF also transfers the event subscriptions information by each NF consumer, for the UE, to the new AMF. If the old AMF has not yet reported a non-zero MO Exception Data Counter to the (H-) SMF, the Context Response also includes the MO Exception Data Counter.

If the old AMF has PDU Sessions for another access type (different from the Access Type indicated in this step) and if the old AMF determines that there is no possibility for relocating the N2 interface to the new AMF, the old AMF returns UE's SUPI and indicates that the Registration Request has been validated for integrity protection, but does not include the rest of the UE context.

For inter PLMN mobility, UE Context information includes HPLMN S-NSSAIs corresponding to the Allowed NSSAI for each Access Type, without Allowed NSSAI of old PLMN.

NOTE 6: The new AMF Sets the indication that the UE is validated according to step 9a, if the new AMF has performed successful UE authentication after previous integrity check failure in the old AMF.

NOTE 7: The NF consumers do not need to subscribe for the events once again with the new AMF after the UE is successfully registered with the new AMF.

If the new AMF has already received UE contexts from the old AMF during handover procedure, then step 4,5 and 10 shall be skipped.

For an Emergency Registration, if the UE identifies itself with a 5G-GUTI that is not known to the AMF, steps 4 and 5 are skipped and the AMF immediately requests the SUPI from the UE. If the UE identifies itself with PEI, the SUPI request shall be skipped. Allowing Emergency Registration without a user identity is dependent on local regulations.

5. [Conditional] old AMF to new AMF: Response to Namf_Communication_UEContextTransfer (SUPI, UE Context in AMF (as per Table 5.2.2.2.2-1)) or UDSF to new AMF: Nudsf_Unstructured Data Management_Query ( ) The old AMF may start an implementation specific (guard) timer for the UE context.

If the UDSF was queried in step 4, the UDSF responds to the new AMF for the Nudsf_Unstructured Data Management_Query invocation with the related contexts including established PDU Sessions, the old AMF includes SMF information DNN, S-NSSAI(s) and PDU Session ID, active NGAP UE-TNLA bindings to N3IWF/TNGF/W-AGF, the old AMF includes information about the NGAP UE-TNLA bindings. If the Old AMF was queried in step 4, Old AMF responds to the new AMF for the Namf_Communication_UEContextTransfer invocation by including the UE's SUPI and UE Context.

If old AMF holds information about established PDU Session(s) and it is not an Initial Registration, the old AMF includes SMF information, DNN(s), S-NSSAI(s) and PDU Session ID(s).

If old AMF holds UE context established via N3IWF, W-AGF or TNGF, the old AMF includes the CM state via N3IWF, W-AGF or TNGF. If the UE is in CM-CONNECTED state via N3IWF, W-AGF or TNGF, the old AMF includes information about the NGAP UE-TNLA bindings.

The old AMF uses the 5G NAS security context corresponding to the NAS connection identifier to perform integrity check of the complete registration request.

If old AMF fails the integrity check of the Registration Request NAS message, the old AMF shall indicate the integrity check failure. If the new AMF is configured to allow emergency services for unauthenticated UE, the new AMF behaves as follows:
If the UE has only an emergency PDU Session, the AMF either skips the authentication and security procedure or accepts that the authentication may fail and continues the Mobility Registration Update procedure; or
If the UE has both emergency and non emergency PDU Sessions and authentication fails, the AMF continues the Mobility Registration Update procedure and deactivates all the non-emergency PDU Sessions as specified in clause 4.3.4.2.

NOTE 8: The new AMF can determine if a PDU Session is used for emergency service by checking whether the DNN matches the emergency DNN.

If old AMF holds information about AM Policy Association and the information about UE Policy Association (i.e. the Policy Control Request Trigger for updating UE Policy as defined in TS 23.503 [20]), the old AMF includes the information about the AM Policy Association, the UE Policy Association and PCF ID. In the roaming case, V-PCF ID and H-PCF ID are included.

If old AMF was a consumer of UE related NWDAF services, the old AMF includes information about active analytics subscriptions, i.e. the Subscription Correlation ID, NWDAF identifier (i.e. Instance ID or Set ID), Analytics ID(s) and associated Analytics specific data in the Namf_Communication_UEContextTransfer response. Usage of the analytics information by the new AMF is specified in TS 23.288 [50].

During inter PLMN mobility, the handling of the UE Radio Capability ID in the new AMF is as defined in TS 23.501 [2].

NOTE 9: When new AMF uses UDSF for context retrieval, interactions between old AMF, new AMF and UDSF due to UE signalling on old AMF at the same time is implementation issue.

6. [Conditional] new AMF to UE: Identity Request ( )

If the SUCI is not provided by the UE nor retrieved from the old AMF the Identity Request procedure is initiated by AMF sending an Identity Request message to the UE requesting the SUCI.

7. [Conditional] UE to new AMF: Identity Response ( )

The UE responds with an Identity Response message including the SUCI. The UE derives the SUCI by using the provisioned public key of the HPLMN, as specified in TS 33.501 [15].

8. The AMF may decide to initiate UE authentication by invoking an AUSF. In that case, the AMF selects an AUSF based on SUPI or SUCI, as described in clause 6.3.4 of TS 23.501 [2].

If the AMF is configured to support Emergency Registration for unauthenticated SUPIs and the UE indicated Registration type Emergency Registration, the AMF skips the authentication or the AMF accepts that the authentication may fail and continues the Registration procedure.

9a. If authentication is required, the AMF requests it from the AUSF; if Tracing Requirements about the UE are available at the AMF, the AMF provides Tracing Requirements in its request to AUSF. Upon request from the AMF, the AUSF shall execute authentication of the UE. The authentication is performed as described in TS 33.501 [15]. The AUSF selects a UDM as described in clause 6.3.8 of TS 23.501 [2] and gets the authentication data from UDM.

Editor's note: It is FFS how the AUSF executes authentication of the UE, in the case of Disaster Roaming Registration.

Once the UE has been authenticated the AUSF provides relevant security related information to the AMF. If the AMF provided a SUCI to AUSF, the AUSF shall return the SUPI to AMF only after the authentication is successful.

After successful authentication in new AMF, which is triggered by the integrity check failure in old AMF at step 5, the new AMF invokes step 4 above again and indicates that the UE is validated (i.e. through the reason parameter as specified in clause 5.2.2.2.2).

9 b If NAS security context does not exist, the NAS security initiation is performed as described in TS 33.501 [15]. If the UE had no NAS security context in step 1, the UE includes the full Registration Request message as defined in TS 24.501 [25].

The AMF decides if the Registration Request needs to be rerouted as described in clause 4.2.2.2.3, where the initial AMF refers to the AMF.

9c. The AMF initiates NGAP procedure to provide the 5G-AN with security context as specified in TS 38.413 if the 5G-AN had requested for UE Context. Also, if the AMF decides that EPS fallback is supported (e.g. based on UE capability to support Request Type flag “handover” for PDN connectivity request during the attach procedure as defined in clause 5.17.2.3.1 of TS 23.501 [2], subscription data and local policy), the AMF shall send an indication “Redirection for EPS fallback for voice is possible” towards 5G-AN as specified in TS 38.413 [10]. Otherwise, the AMF indicates “Redirection for EPS fallback for voice is not possible”. In addition, if Tracing Requirements about the UE are available at the AMF, the AMF provides the 5G-AN with Tracing Requirements in the NGAP procedure.

9d. The 5G-AN stores the security context and acknowledges to the AMF. The 5G-AN uses the security context to protect the messages exchanged with the UE as described in TS 33.501 [15].

10. [Conditional] new AMF to old AMF: Namf_Communication_RegistrationStatus Update (PDU Session ID(s) to be released e.g. due to slice not supported).

If the AMF has changed the new AMF informs the old AMF that the registration of the UE in the new AMF is completed by invoking the Namf_Communication_RegistrationStatus Update service operation.

If the authentication/security procedure fails, then the Registration shall be rejected, and the new AMF invokes the Namf_Communication_RegistrationStatusUpdate service operation with a reject indication towards the old AMF. The old AMF continues as if the UE context transfer service operation was never received.

If one or more of the S-NSSAIs used in the old Registration Area cannot be served in the target Registration Area, the new AMF determines which PDU Session cannot be supported in the new Registration Area. The new AMF invokes the Namf_Communication_RegistrationStatusUpdate service operation including the rejected PDU Session ID towards the old AMF. Then the new AMF modifies the PDU Session Status correspondingly. The old AMF informs the corresponding SMF(s) to locally release the UE's SM context by invoking the Nsmf_PDUSession_ReleaseSMContext service operation.

If new AMF received in the UE context transfer in step 5 the information about the AM Policy Association and the UE Policy Association and decides, based on local policies, not to use the PCF(s) identified by the PCF ID(s) for the AM Policy Association and the UE Policy Association, then it will inform the old AMF that the AM Policy Association and the UE Policy Association in the UE context is not used any longer and then the PCF selection is performed in step 15.

If the new AMF received in the UE context transfer in step 5 the information about UE related analytics subscription(s), the new AMF may take over the analytics subscription(s) from the old AMF. Otherwise, if the new AMF instead determines to create new analytics subscription(s), it informs the old AMF about the analytics subscriptions (identified by their Subscription Correlation ID) that are not needed any longer and the old AMF may now unsubscribe those NWDAF analytics subscriptions for the UE according to TS 23.288 [50].

11. [Conditional] new AMF to UE: Identity Request/Response (PEI).

If the PEI was not provided by the UE nor retrieved from the old AMF the Identity Request procedure is initiated by AMF sending an Identity Request message to the UE to retrieve the PEI. The PEI shall be transferred encrypted unless the UE performs Emergency Registration and cannot be authenticated.

For an Emergency Registration, the UE may have included the PEI in the Registration Request. If so, the PEI retrieval is skipped.

If the UE supports RACS as indicated in UE MM Core Network Capability, the AMF shall use the PEI of the UE to obtain the IMEI/TAC for the purpose of RACS operation.

12. Optionally the new AMF initiates ME identity check by invoking the N5g-eir_EquipmentIdentity Check_Get service operation (see clause 5.2.4.2.2).

The PEI check is performed as described in clause 4.7. For an Emergency Registration, if the PEI is blocked, operator policies determine whether the Emergency Registration procedure continues or is stopped.

13. If step 14 is to be performed, the new AMF, based on the SUPI, selects a UDM, then UDM may select a UDR instance. See clause 6.3.9 of TS 23.501 [2].

The AMF selects a UDM as described in clause 6.3.8 of TS 23.501 [2].

14a-c. If the AMF has changed since the last Registration procedure, or if the UE provides a SUPI which doesn't refer to a valid context in the AMF, or if the UE registers to the same AMF it has already registered to a non-3GPP access (i.e. the UE is registered over a non-3GPP access and initiates this Registration procedure to add a 3GPP access), the new AMF registers with the UDM using Nudm_UECM_Registration for the access to be registered (and subscribes to be notified when the UDM deregisters this AMF). In this case, if the AMF does not have event exposure subscription information for this UE, the AMF indicates it to UDM. Then, if the UDM has existing applicable event exposure subscriptions for events detected in AMF for this UE or for any of the groups this UE belongs to (possibly retrieved from UDR), UDM invokes the Namf_EventExposure_Subscribe service for recreating the event exposure subscriptions.

The AMF provides the “Homogenous Support of IMS Voice over PS Sessions” indication (see clause 5.16.3.3 of TS 23.501 [2]) to the UDM. The “Homogenous Support of IMS Voice over PS Sessions” indication shall not be included unless the AMF has completed its evaluation of the support of “IMS Voice over PS Session” as specified in clause 5.16.3.2 of TS 23.501 [2].

During initial Registration, if the AMF and UE supports SRVCC from NG-RAN to UTRAN the AMF provides UDM with the UE SRVCC capability.

If the AMF determines that only the UE SRVCC capability has changed, the AMF sends UE SRVCC capability to the UDM.

NOTE 10: At this step, it is possible that the AMF does not have all the information needed to determine the setting of the IMS Voice over PS Session Supported indication for this UE (see clause 5.16.3.2 of TS 23.501 [2]). Hence the AMF can send the “Homogenous Support of IMS Voice over PS Sessions” later on in this procedure.

If the AMF does not have subscription data for the UE, the AMF retrieves the Access and Mobility Subscription data, SMF Selection Subscription data, UE context in SMF data and LCS mobile origination using Nudm_SDM_Get. If the AMF already has subscription data for the UE but the SoR Update Indicator in the UE context requires the AMF to retrieve SoR information depending on the NAS Registration Type (“Initial Registration” or “Emergency Registration”) (see Annex C of TS 23.122 [22]), the AMF retrieves the Steering of Roaming information using Nudm_SDM_Get. This requires that UDM may retrieve this information from UDR by Nudr_DM_Query. After a successful response is received, the AMF subscribes to be notified using Nudm_SDM_Subscribe when the data requested is modified, UDM may subscribe to UDR by Nudr_DM_Subscribe. The GPSI is provided to the AMF in the Access and Mobility Subscription data from the UDM if the GPSI is available in the UE subscription data. The UDM may provide indication that the subscription data for network slicing is updated for the UE. If the UE is subscribed to MPS in the serving PLMN, “MPS priority” is included in the Access and Mobility Subscription data provided to the AMF. If the UE is subscribed to MCX in the serving PLMN, “MCX priority” is included in the Access and Mobility Subscription data provided to the AMF. The UDM also provides the IAB-Operation allowed indication to AMF as part of the Access and Mobility Subscription data. The AMF shall trigger the setup of the UE context in NG-RAN, or modification of the UE context in NG-RAN if the initial setup is at step 9c, including an indication that the IAB-node is authorized.

Editor's note: It is FFS how the UDM provides applicable subscription data for Disaster Roaming service to the AMF, in the case of Disaster Roaming Registration.

The new AMF provides the Access Type it serves for the UE to the UDM and the Access Type is set to “3GPP access”. The UDM stores the associated Access Type together with the serving AMF and does not remove the AMF identity associated to the other Access Type if any. The UDM may store in UDR information provided at the AMF registration by Nudr_DM_Update.

If the UE was registered in the old AMF for an access, and the old and the new AMFs are in the same PLMN, the new AMF sends a separate/independent Nudm_UECM_Registration to update UDM with Access Type set to access used in the old AMF, after the old AMF relocation is successfully completed.

The new AMF creates an UE context for the UE after getting the Access and Mobility Subscription data from the UDM. The Access and Mobility Subscription data includes whether the UE is allowed to include NSSAI in the 3GPP access RRC Connection Establishment in clear text. The Access and Mobility Subscription data may include Enhanced Coverage Restricted information. If received from the UDM and the UE included support for restriction of use of Enhanced Coverage in step 1, the AMF determines whether Enhanced Coverage is restricted or not for the UE as specified in clause 5.31.12 of TS 23.501 [2] and stores the updated Enhanced Coverage Restricted information in the UE context.

The Access and Mobility Subscription data may include the NB-IoT UE Priority.

The subscription data may contain Service Gap Time parameter. If received from the UDM, the AMF stores this Service Gap Time in the UE Context in AMF for the UE.

For an Emergency Registration in which the UE was not successfully authenticated, the AMF shall not register with the UDM.

The AMF enforces the Mobility Restrictions as specified in clause 5.3.4.1.1 of TS 23.501 [2]. For an Emergency Registration, the AMF shall not check for Mobility Restrictions, access restrictions, regional restrictions or subscription restrictions. For an Emergency Registration, the AMF shall ignore any unsuccessful registration response from UDM and continue with the Registration procedure.

NOTE 11: The AMF can, instead of the Nudm_SDM_Get service operation, use the Nudm_SDM_Subscribe service operation with an Immediate Report Indication that triggers the UDM to immediately return the subscribed data if the corresponding feature is supported by both the AMF and the UDM.

14d. When the UDM stores the associated Access Type (e.g. 3GPP) together with the serving AMF as indicated in step 14a, it will cause the UDM to initiate a Nudm_UECM_DeregistrationNotification (see clause 5.2.3.2.2) to the old AMF corresponding to the same (e.g. 3GPP) access, if one exists. If the timer started in step 5 is not running, the old AMF may remove the UE context for the same Access Type. Otherwise, the AMF may remove UE context for the same Access Type when the timer expires. If the serving NF removal reason indicated by the UDM is Initial Registration, then, as described in clause 4.2.2.3.2, the old AMF invokes the Nsmf_PDUSession_ReleaseSMContext (SM Context ID) service operation towards all the associated SMF(s) of the UE to notify that the UE is deregistered from old AMF for the same Access Type. The SMF(s) shall release the PDU Session on getting this notification.

If the old AMF has established an AM Policy Association and a UE Policy Association with the PCF(s), and the old AMF did not transfer the PCF ID(s) to the new AMF (e.g. new AMF is in different PLMN), the old AMF performs an AMF-initiated Policy Association Termination procedure, as defined in clause 4.16.3.2, and performs an AMF-initiated UE Policy Association Termination procedure, as defined in clause 4.16.13.1. In addition, if the old AMF transferred the PCF ID(s) in the UE context but the new AMF informed in step 10 that the AM Policy Association information and UE Policy Association information in the UE context will not be used then the old AMF performs an AMF-initiated Policy Association Termination procedure, as defined in clause 4.16.3.2, and performs an AMF-initiated UE Policy Association Termination procedure, as defined in clause 4.16.13.1.

If the old AMF has an N2 connection for that UE (e.g. because the UE was in RRC Inactive state but has now moved to E-UTRAN or moved to an area not served by the old AMF), the old AMF shall perform AN Release (see clause 4.2.6) with a cause value that indicates that the UE has already locally released the NG-RAN's RRC Connection.

If the UE context in the old AMF contains an Allowed NSSAI including one or more S-NSSAI(s) subject to NSAC, the old AMF upon receipt of the Nudm_UECM_Deregistration Notification from the UDM, sends an update request message for each S-NSSAI subject to NSAC to the corresponding NSACF(s) with update flag parameter set to decrease (see clause 4.2.11.2).

At the end of registration procedure, the AMF may initiate synchronization of event exposure subscriptions with the UDM if the AMF does not indicate unavailability of event exposure subscription in step 14a.

NOTE 12: The AMF can initiate synchronization with UDM even if events are available in the UE context (e.g. as received from old AMF) at any given time and based on local policy. This can be done during subscription change related event.

14e. [Conditional] If old AMF does not have UE context for another access type (i.e. non-3GPP access), the Old AMF unsubscribes with the UDM for subscription data using Nudm_SDM_unsubscribe.

15. If the AMF decides to initiate PCF communication, the AMF acts as follows.

If the new AMF decides to use the (V-) PCF identified by the (V-) PCF ID included in UE context from the old AMF in step 5, the AMF contacts the (V-) PCF identified by the (V-) PCF ID to obtain policy. If the AMF decides to perform PCF discovery and selection and the AMF selects a (V)-PCF and may select an H-PCF (for roaming scenario) as described in clause 6.3.7.1 of TS 23.501 [2] and according to the V-NRF to H-NRF interaction described in clause 4.3.2.2.3.3.

16. [Optional] new AMF performs an AM Policy Association Establishment/Modification. For an Emergency Registration, this step is skipped.

If the new AMF selects a new (V-) PCF in step 15, the new AMF performs AM Policy Association Establishment with the selected (V-) PCF as defined in clause 4.16.1.2.

If the (V-) PCF identified by the (V-) PCF ID included in UE context from the old AMF is used, the new AMF performs AM Policy Association Modification with the (V-) PCF as defined in clause 4.16.2.1.2.

If the AMF notifies the Mobility Restrictions (e.g. UE location) to the PCF for adjustment, or if the PCF updates the Mobility Restrictions itself due to some conditions (e.g. application in use, time and date), the PCF shall provide the updated Mobility Restrictions to the AMF. If the subscription information includes Tracing Requirements, the AMF provides the PCF with Tracing Requirements.

If the AMF supports DNN replacement, the AMF provides the PCF with the Allowed NSSAI and, if available, the Mapping Of Allowed NSSAI.

If the PCF supports DNN replacement, the PCF provides the AMF with triggers for DNN replacement.

17. [Conditional] AMF to SMF: Nsmf_PDUSession_UpdateSMContext ( )

For an Emergency Registered UE (see TS 23.501 [2]), this step is applied when the Registration Type is Mobility Registration Update.

The AMF invokes the Nsmf_PDUSession_UpdateSMContext (see clause 5.2.8.2.6) in the following scenario(s):

If the List Of PDU Sessions To Be Activated is included in the Registration Request in step 1, the AMF sends Nsmf_PDUSession_UpdateSMContext Request to SMF(s) associated with the PDU Session(s) in order to activate User Plane connections of these PDU Session(s). Steps from step 5 onwards described in clause 4.2.3.2 are executed to complete the User Plane connection activation without sending the RRC Inactive Assistance Information and without sending MM NAS Service Accept from the AMF to (R)AN described in step 12 of clause 4.2.3.2. When a User Plane connection for a PDU Session is activated, the AS layer in the UE indicates it to the NAS layer.

If the AMF has determined in step 3 that the UE is performing Inter-RAT mobility to or from NB-IoT, the AMF sends Nsmf_PDUSession_UpdateSMContext Request to SMF(s) associated with the UEs PDU Session(s), so the SMF(s) can update them according to the “PDU Session continuity at inter RAT mobility” subscription data. Steps from step 5 onwards described in clause 4.2.3.2 are executed without sending MM NAS Service Accept from the AMF to (R)AN described in step 12 of clause 4.2.3.2.

When the serving AMF has changed, the new serving AMF notifies the SMF for each PDU Session that it has taken over the responsibility of the signalling path towards the UE: the new serving AMF invokes the Nsmf_PDUSession_UpdateSMContext service operation using SMF information received from the old AMF at step 5. It also indicates whether the PDU Session is to be re-activated.

NOTE 13: If the UE moves into a different PLMN, the AMF in the serving PLMN can insert or change the V-SMF(s) in the serving PLMN for Home Routed PDU session(s). In this case, the same procedures described in clause 4.23.3 are applied for the V-SMF change as for the I-SMF change (i.e. by replacing the I-SMF with V-SMF). During inter-PLMN change, if the same SMF is used, session continuity can be supported depending on operator policies.

Steps from step 5 onwards described in clause 4.2.3.2 are executed. In the case that the intermediate UPF insertion, removal, or change is performed for the PDU Session(s) not included in “PDU Session(s) to be re-activated”, the procedure is performed without N11 and N2 interactions to update the N3 user plane between (R)AN and 5GC.

The AMF invokes the Nsmf_PDUSession_ReleaseSMContext service operation towards the SMF in the following scenario: If any PDU Session status indicates that it is released at the UE, the AMF invokes the Nsmf_PDUSession_ReleaseSMContext service operation towards the SMF in order to release any network resources related to the PDU Session.

If the serving AMF is changed, the new AMF shall wait until step 18 is finished with all the SMFs associated with the UE. Otherwise, steps 19 to 22 can continue in parallel to this step.

18. [Conditional] If the new AMF and the old AMF are in the same PLMN, the new AMF sends a UE Context Modification Request to N3IWF/TNGF/W-AGF as specified in TS 29.413 [64].

If the AMF has changed and the old AMF has indicated that the UE is in CM-CONNECTED state via N3IWF, W-AGF or TNGF and if the new AMF and the old AMF are in the same PLMN, the new AMF creates an NGAP UE association towards the N3IWF/TNGF/W-AGF to which the UE is connected. This automatically releases the existing NGAP UE association between the old AMF and the N3IWF/TNGF/W-AGF.

19. N3IWF/TNGF/W-AGF sends a UE Context Modification Response to the new AMF.

19a. [Conditional] After the new AMF receives the response message from the N3IWF, W-AGF or TNGF in step 19, the new AMF registers with the UDM using Nudm_UECM_Registration as step 14a, but with the Access Type set to “non-3GPP access”. The UDM stores the associated Access Type together with the serving AMF and does not remove the AMF identity associated to the other Access Type if any. The UDM may store in UDR information provided at the AMF registration by Nudr_DM_Update.

19b. [Conditional] When the UDM stores the associated Access Type (i.e. non-3GPP) together with the serving AMF as indicated in step 19a, it will cause the UDM to initiate a Nudm_UECM_DeregistrationNotification (see clause 5.2.3.2.2) to the old AMF corresponding to the same (i.e. non-3GPP) access. The old AMF removes the UE context for non-3GPP access.

19c. The Old AMF unsubscribes with the UDM for subscription data using Nudm_SDM_unsubscribe.

20a. Void.

21. New AMF to UE: Registration Accept (5G-GUTI, Registration Area, [Mobility restrictions], [PDU Session status], [Allowed NSSAI], [Mapping Of Allowed NSSAI], [Configured NSSAI for the Serving PLMN], [Mapping Of Configured NSSAI], [NSSRG Information], [rejected S-NSSAIs], [Pending NSSAI], [Mapping Of Pending NSSAI], [Periodic Registration Update timer], [Active Time], [Strictly Periodic Registration Timer Indication], [LADN Information], [accepted MICO mode], [IMS Voice over PS session supported Indication], [Emergency Service Support indicator], [Accepted DRX parameters for E-UTRA and NR], [Accepted DRX parameters for NB-IoT], [extended idle mode DRX parameters], [Paging Time Window], [Network support of Interworking without N26], [Access Stratum Connection Establishment NSSAI Inclusion Mode], [Network Slicing Subscription Change Indication], [Operator-defined access category definitions], [List of equivalent PLMNs], [Enhanced Coverage Restricted information], [Supported Network Behaviour], [Service Gap Time], [PLMN-assigned UE Radio Capability ID], [PLMN-assigned UE Radio Capability ID deletion], [WUS Assistance Information], [Truncated 5G-S-TMSI Configuration], [Connection Release Supported], [Paging Cause Indication for Voice Service Supported], [Paging Restriction Supported], [Reject Paging Request Supported]).

If the Requested NSSAI does not include S-NSSAIs which map to S-NSSAIs of the HPLMN subject to Network Slice-Specific Authentication and Authorization and the AMF determines that no S-NSSAI can be provided in the Allowed NSSAI for the UE in the current UE's Tracking Area and if no default S-NSSAI(s) not yet involved in the current UE Registration procedure could be further considered, the AMF shall reject the UE Registration and shall include in the rejection message the list of Rejected S-NSSAIs, each of them with the appropriate rejection cause value.

The Allowed NSSAI for the Access Type for the UE is included in the N2 message carrying the Registration Accept message. The Allowed NSSAI contains only S-NSSAIs that do not require, based on subscription information, Network Slice-Specific Authentication and Authorization and, based on the UE Context in the AMF, those S-NSSAIs for which Network Slice-Specific Authentication and Authorization previously succeeded, regardless of the Access Type. The Mapping Of Pending NSSAI is the mapping of each S-NSSAI of the Pending NSSAI for the Serving PLMN to the HPLMN S-NSSAIS.

If the UE has indicated its support of the Network Slice-Specific Authentication and Authorization procedure in the UE MM Core Network Capability in the Registration Request, AMF includes in the Pending NSSAI the S-NSSAIs that map to an S-NSSAI of the HPLMN which in the subscription information has indication that it is subject to Network Slice-Specific Authentication and Authorization, as described in clause 4.6.2.4 of TS 24.501 [25]. In such case, the AMF then shall trigger at step 25 the Network Slice-Specific Authentication and Authorization procedure, specified in clause 4.2.9.2, except, based on Network policies, for those S-NSSAIs for which Network Slice-Specific Authentication and Authorization have already been initiated on another Access Type for the same S-NSSAI(s). The UE shall not attempt re-registration with the S-NSSAIs included in the list of Pending NSSAIs until the Network Slice-Specific Authentication and Authorization procedure has been completed, regardless of the Access Type.

If the UE has not indicated its support of the Network Slice-Specific Authentication and Authorization procedure in the UE 5GMM Core Network Capability in the Registration Request, and the Requested NSSAI includes S-NSSAIs which map to HPLMN S-NSSAIs subject to Network Slice-Specific Authentication and Authorization, the AMF includes those S-NSSAIs in the Requested NSSAI in the Rejected S-NSSAIs.

If no S-NSSAI can be provided in the Allowed NSSAI because:
all the S-NSSAI(s) in the Requested NSSAI are to be subject to Network Slice-Specific Authentication and Authorization; or
no Requested NSSAI was provided or none of the S-NSSAIs in the Requested NSSAI matches any of the Subscribed S-NSSAIs, and all the S-NSSAI(s) marked as default in the Subscribed S-NSSAIs are to be subject to Network Slice-Specific Authentication and Authorization.

The AMF shall provide an empty Allowed NSSAI. Upon receiving an empty Allowed NSSAI and a Pending NSSAI, the UE is registered in the PLMN but shall wait for the completion of the Network Slice-Specific Authentication and Authorization procedure without attempting to use any service provided by the PLMN on any access, except e.g. emergency services (see TS 24.501 [25]), until the UE receives an Allowed NSSAI.

The AMF stores the NB-IoT Priority retrieved in Step 14 and associates it to the 5G-S-TMSI allocated to the UE.

If the Registration Request message received over 3GPP access does not include any Paging Restriction Information, the AMF shall delete any stored Paging Restriction Information for this UE and stop restricting paging accordingly.

If the Registration Request message received over 3GPP access includes a Release Request indication, then:
the AMF updates the UE context with any received Paging Restriction Information, then enforces it in the network triggered Service Request procedure as described in clause 4.2.3.3;
the AMF does not establish User Plane resources and triggers the AN release procedure as described in clause 4.2.6 after the completion of Registration procedure.

The AMF sends a Registration Accept message to the UE indicating that the Registration Request has been accepted. 5G-GUTI is included if the AMF allocates a new 5G-GUTI. Upon receiving a Registration Request message of type “Initial Registration”, “mobility registration update”, or “Disaster Roaming Registration” from the UE, the AMF shall include a new 5G-GUTI in the Registration Accept message. Upon receiving a Registration Request message of type “periodic registration update” from the UE, the AMF should include a new 5G-GUTI in the Registration Accept message. If the UE is already in RM-REGISTERED state via another access in the same PLMN, the UE shall use the 5G-GUTI received in the Registration Accept for both registrations. If no 5G-GUTI is included in the Registration Accept, then the UE uses the 5G-GUTI assigned for the existing registration also for the new registration. If the AMF allocates a new Registration area, it shall send the Registration area to the UE via Registration Accept message. For a Disaster Roaming Registration, the AMF allocates the Registration Area limited to the area with Disaster Condition as specified in clause 5.40 of TS 23.501 [2]. If there is no Registration area included in the Registration Accept message, the UE shall consider the old Registration Area as valid. Mobility Restrictions is included if mobility restrictions applies for the UE and Registration Type is not Emergency Registration. The AMF indicates the established

PDU Sessions to the UE in the PDU Session status. The UE removes locally any internal resources related to PDU Sessions that are not marked as established in the received PDU Session status. If the AMF invokes the Nsmf_PDUSession_UpdateSMContext procedure for UP activation of PDU Session(s) in step 18 and receives rejection from the SMF, then the AMF indicates to the UE the PDU Session ID and the cause why the User Plane resources were not activated. When the UE is connected to the two AMFs belonging to different PLMN via 3GPP access and non-3GPP access then the UE removes locally any internal resources related to the PDU Session of the current PLMN that are not marked as established in received PDU Session status. If the PDU Session status information was in the Registration Request, the AMF shall indicate the PDU Session status to the UE.

If the RAT Type is NB-IoT and the network is configured to use the Control Plane Relocation Indication procedure then the AMF shall include in the Registration Accept message the Truncated 5G-S-TMSI Configuration that the UE using Control Plane CIOT 5GS Optimisation uses to create the Truncated 5G-S-TMSI, see clause 5.31.4.3 of TS 23.501 [2].

The Allowed NSSAI provided in the Registration Accept is valid in the Registration Area and it applies for all the PLMNs which have their Tracking Areas included in the Registration Area. The Mapping Of Allowed NSSAI is the mapping of each S-NSSAI of the Allowed NSSAI to the HPLMN S-NSSAIs. The Mapping Of Configured NSSAI is the mapping of each S-NSSAI of the Configured NSSAI for the Serving PLMN to the HPLMN S-NSSAIs.

If the UE has indicated its support of the subscription-based restrictions to simultaneous registration of network slices feature, the AMF includes, if available, the NSSRG Information, defined in clause 5.15.12 of TS 23.501 [2].

If the UE has not indicated its support of the subscription-based restrictions to simultaneous registration of network slices feature, and the subscription information for the UE includes SRG information, and the AMF is providing the Configured NSSAI to the UE, the Configured NSSAI shall include the S-NSSAIs according to clause 5.15.12 of TS 23.501 [2].

The AMF shall include in the Registration Accept message the LADN Information for the list of LADNs, described in clause 5.6.5 of TS 23.501 [2], that are available within the Registration area determined by the AMF for the UE. The AMF may include Operator-defined access category definitions to let the UE determinine the applicable Operator-specific access category definitions as described in TS 24.501 [25].

If the UE included MICO mode in the Registration Request, then AMF responds in the Registration Accept message whether MICO mode should be used. When MICO mode is allowed for the UE, the AMF may include an Active Time value and/or Strictly Periodic Registration Timer Indication in the Registration Accept message. The AMF determines the Periodic Registration Update timer value, Active Time value and the Strictly Periodic Registration Timer Indication based on local configuration, Expected UE Behaviour if available, UE indicated preferences, UE capability, UE subscription information and network policies, or any combination of them so as to enable UE power saving, as described in clause 5.31.7 of TS 23.501 [2]. The AMF determines to apply the Strictly Periodic Registration Timer Indication to the UE if the UE indicates its capability of the Strictly Periodic Registration Timer Indication in the registration request message, as described in step 1. If the AMF provides the Periodic Registration Update timer value with the Strictly Periodic Registration Timer Indication to the UE, the UE and the AMF start the Periodic Registration Update timer after this step, as described in clause 5.31.7.5 of TS 23.501 [2].

In the case of registration over 3GPP access, the AMF Sets the IMS Voice over PS session supported Indication as described in clause 5.16.3.2 of TS 23.501 [2]. In order to set the IMS Voice over PS session supported Indication the AMF may need to perform the UE Capability Match Request procedure in clause 4.2.8a to check the compatibility of the UE and NG-RAN radio capabilities related to IMS Voice over PS. If the AMF hasn't received Voice Support Match Indicator from the NG-RAN on time then, based on implementation, AMF may set IMS Voice over PS session supported Indication and update it at a later stage.

In the case of registration over 3GPP access and the AMF has retrieved or determined according to local configuration a Target NSSAI and a corresponding RFSP Index for the purpose of allowing the NG-RAN to redirect the UE to a cell supporting network slices not available in the current TA as described in clause 5.3.4.3.3 of TS 23.501 [2], the AMF provides the Target NSSAI and the corresponding RFSP Index to the NG-RAN.

In the case of registration over non-3GPP access, the AMF Sets the IMS Voice over PS session supported Indication as described in clause 5.16.3.2a of TS 23.501 [2].

The Emergency Service Support indicator informs the UE that emergency services are supported, i.e. the UE is allowed to request PDU Session for emergency services. If the AMF received “MPS priority” from the UDM as part of Access and Mobility Subscription data, based on operator policy, “MPS priority” is included in the Registration Accept message to the UE to inform the UE whether configuration of Access Identity 1 is valid within the selected PLMN, as specified in TS 24.501 [25]. If the AMF received “MCX priority” from the UDM as part of Access and Mobility Subscription data, based on operator policy and UE subscription to MCX Services, “MCX priority” is included in the Registration Accept message to the UE to inform the UE whether configuration of Access Identity 2 is valid within the selected PLMN, as specified in TS 24.501 [25]. The Accepted DRX parameters are defined in clause 5.4.5 of TS 23.501 [2]. The AMF includes Accepted DRX parameters for NB-IoT, if the UE included Requested DRX parameters for NB-IoT in the Registration Request message. The AMF Sets the Network support of Interworking without N26 parameter as described in clause 5.17.2.3.1 of TS 23.501 [2]. If the AMF accepts the use of extended idle mode DRX, the AMF includes the extended idle mode DRX parameters and Paging Time Window as described in 5.31.7.2 of TS 23.501 [2].

If the UDM intends to indicate the UE that subscription has changed, the Network Slicing Subscription Change Indication is included. If the AMF includes Network Slicing Subscription Change Indication, then the UE shall locally erase all the network slicing configuration for all PLMNs and, if applicable, update the configuration for the current PLMN based on any received information.

The Access Stratum Connection Establishment NSSAI Inclusion Mode, as specified in clause 5.15.9 of TS 23.501 [2], is included to instruct the UE on what NSSAI, if any, to include in the Access Stratum connection establishment. The AMF can set the value to modes of operation a, b, c defined in clause 5.15.9 of TS 23.501 [2] in the 3GPP Access only if the Inclusion of NSSAI in RRC Connection Establishment Allowed indicates that it is allowed to do so.

For a UE registered in a PLMN, the AMF may provide a List of equivalent PLMNs which is handled as specified in TS 24.501 [25]. For a UE registered in an SNPN, the AMF shall not provide a list of equivalent PLMNs to the UE.

If the UE included support for restriction of use of Enhanced Coverage in step 1, the AMF sends the Enhanced Coverage Restricted information to the NG-RAN in N2 message. The AMF also sends Enhanced Coverage Restricted information to the UE in the Registration Accept message.

If the UE receives Enhanced Coverage Restricted information in the Registration Accept message, the UE shall store this information and shall use the value of Enhanced Coverage Restricted information to determine if Enhanced Coverage feature should be used or not.

If the UE and the AMF have negotiated to enable MICO mode and the AMF uses the Extended connected timer, then the AMF provides the Extended Connected time value to NG-RAN (see clause 5.31.7.3 of TS 23.501 [2]) in this step. The Extended Connected Time value indicates the minimum time the RAN should keep the UE in RRC-CONNECTED state regardless of inactivity.

The AMF indicates the CIOT 5GS Optimisations it supports and accepts in the Supported Network Behaviour information (see clause 5.31.2 of TS 23.501 [2]) if the UE included Preferred Network Behaviour in its Registration Request.

The AMF may steer the UE from 5GC by rejecting the Registration Request. The AMF should take into account the Preferred and Supported Network Behaviour (see clause 5.31.2 of TS 23.501 [2]) and availability of EPC to the UE before steering the UE from 5GC.

If the AMF accepts MICO mode and knows there may be mobile terminated data or signalling pending, the AMF maintains the N2 connection for at least the Extended Connected Time as described in clause 5.31.7.3 of TS 23.501 [2], and provides the Extended Connected Time value to the RAN.

The AMF includes Service Gap Time if Service Gap Time is present in the subscription information (steps 14a-c) or the Service Gap Time has been updated by the Subscriber Data Update Notification to AMF procedure (see clause 4.5.1) and the UE has indicated UE Service Gap Control Capability.

If the UE receives a Service Gap Time in the Registration Accept message, the UE shall store this parameter and apply Service Gap Control (see clause 5.31.16 of TS 23.501 [2]).

If the network supports WUS grouping (see TS 23.501 [2]), the AMF shall send the WUS Assistance Information to the UE. If the UE provided the UE paging probability information in Step 1, the AMF takes it into account to determine the WUS Assistance Information.

When the UE and the AMF supports RACS as defined in clause 5.4.4.1a of TS 23.501 [2], and the AMF needs to configure the UE with a UE Radio Capability ID, and the AMF already has the UE radio capabilities other than NB-IoT radio capabilities for the UE, the AMF may provide the UE with the UE Radio Capability ID for the UE radio capabilities the UCMF returns to the AMF in a Nucmf_assign service operation for this UE. Alternatively, when the UE and the AMF support RACS, the AMF may provide the UE with an indication to delete any PLMN-assigned UE Radio Capability ID in this PLMN (see clause 5.4.4.1a of TS 23.501 [2]).

If the UE is “CAG supported”, and the AMF needs to update the CAG information of the UE, the AMF may include the CAG information as part of the Mobility Restrictions in the Registration Accept message.

If the UE indicates support for the Paging Cause Indication for Voice Service feature in the Registration Request message and if the network supports and intends to apply the Paging Cause Indication for Voice Service feature for the UE, the AMF includes an indication that the UE supports the Paging Cause Indication for Voice Service feature in the N2 message carrying the Registration Accept message.

If the Multi-USIM UE has indicated support for one or more Multi-USIM Specific Capabilities in the UE 5GMM Core Network Capability in step 1, the AMF shall indicate to the Multi-USIM UE whether the corresponding one or more Multi-USIM specific features described in clause 5.38 of TS 23.501 [2] are supported, based on network capability and preference by the network (i.e. based on local network policy), by providing one or more of the Connection Release Supported, Paging Cause Indication for Voice Service Supported, Paging Restriction Supported and Reject Paging Request Supported indications. If the Multi-USIM UE has indicated support for the Paging Cause Indication for Voice Service feature, the AMF supporting the Paging Cause Indication for Voice Service shall include an indication in the N2 message that the UE supports the Paging Cause Indication for Voice Service feature. The AMF shall only indicate Paging Restriction Supported together with either Connection Release Supported or Reject Paging Request Supported. The UE shall only use Multi-USIM specific features that the AMF indicated as being supported.

21b. [Optional] The new AMF performs a UE Policy Association Establishment as defined in clause 4.16.11. For an Emergency Registration, this step is skipped.

The new AMF sends a Npcf_UEPolicy Control Create Request to PCF. PCF sends a Npcf_UEPolicy Control Create Response to the new AMF.

PCF triggers UE Configuration Update Procedure as defined in clause 4.2.4.3.

22. [Conditional] UE to new AMF: Registration Complete ( ).

The UE sends a Registration Complete message to the AMF when it has successfully updated itself after receiving any of the [Configured NSSAI for the Serving PLMN], [Mapping Of Configured NSSAI], [NSSRG Information] and a Network Slicing Subscription Change Indication, or CAG information in step 21.

The UE sends a Registration Complete message to the AMF to acknowledge if a new 5G-GUTI was assigned.

If new 5G-GUTI was assigned, then the UE passes the new 5G-GUTI to its 3GPP access' lower layer when a lower layer (either 3GPP access or non-3GPP access) indicates to the UE's RM layer that the Registration Complete message has been successfully transferred across the radio interface.

NOTE 14: The above is needed because the NG-RAN may use the RRC Inactive state and a part of the 5G-GUTI is used to calculate the Paging Frame (see TS 38.304 and TS 36.304 [43]). It is assumed that the Registration Complete is reliably delivered to the AMF after the 5G-AN has acknowledged its receipt to the UE.

When the List Of PDU Sessions To Be Activated is not included in the Registration Request and the Registration procedure was not initiated in CM-CONNECTED state, the AMF releases the signalling connection with UE, according to clause 4.2.6.

When the Follow-on request is included in the Registration Request, the AMF should not release the signalling connection after the completion of the Registration procedure.

If the AMF is aware that some signalling is pending in the AMF or between the UE and the 5GC, the AMF should not release the signalling connection immediately after the completion of the Registration procedure.

If PLMN-assigned UE Radio Capability ID is included in step 21, the AMF stores the PLMN-assigned UE Radio Capability ID in UE context if receiving Registration Complete message.

If the UE receives PLMN-assigned UE Radio Capability ID deletion indication in step 21, the UE shall delete the PLMN-assigned UE Radio Capability ID(s) for this PLMN.

23. [Conditional] AMF to UDM: If the Access and Mobility Subscription data provided by UDM to AMF in 14b includes Steering of Roaming information with an indication that the UDM requests an acknowledgement of the reception of this information from the UE, the AMF provides the UE acknowledgement to UDM using Nudm_SDM_Info. For more details regarding the handling of Steering of Roaming information refer to TS 23.122 [22].

23a. For Registration over 3GPP Access, if the AMF does not release the signalling connection, the AMF sends the RRC Inactive Assistance Information to the NG-RAN.

For Registration over non-3GPP Access, if the UE is also in CM-CONNECTED state on 3GPP access, the AMF sends the RRC Inactive Assistance Information to the NG-RAN.

The AMF also uses the Nudm_SDM_Info service operation to provide an acknowledgment to UDM that the UE received CAG information, or the Network Slicing Subscription Change Indication (see step 21 and step 22) and acted upon it.

24. [Conditional] AMF to UDM: After step 14a, and in parallel to any of the preceding steps, the AMF shall send a “Homogeneous Support of IMS Voice over PS Sessions” indication to the UDM using Nudm_UECM_Update:
If the AMF has evaluated the support of IMS Voice over PS Sessions, see clause 5.16.3.2 of TS 23.501 [2], and
If the AMF determines that it needs to update the Homogeneous Support of IMS Voice over PS Sessions, see clause 5.16.3.3 of TS 23.501 [2].

25. [Conditional] If the UE indicates its support for Network Slice-Specific Authentication and Authorization procedure in the UE MM Core Network Capability in Registration Request, and any S-NSSAI of the HPLMN is subject to Network Slice-Specific Authentication and Authorization, the related procedure is executed at this step (see clause 4.2.9.1). Once the Network Slice-Specific Authentication and Authorization procedure is completed for all S-NSSAIs, the AMF shall trigger a UE Configuration Update procedure to deliver an Allowed NSSAI containing also the S-NSSAIs for which the Network Slice-Specific Authentication and Authorization was successful, and include any rejected NSSAIs with an appropriate rejection cause value.

The AMF shall remove the mobility restriction if the Tracking Areas of the Registration Area were previously assigned as a Non-Allowed Area due to pending Network Slice-Specific Authentication and Authorization.

The AMF stores an indication in the UE context for any S-NSSAI of the HPLMN subject to Network Slice-Specific Authentication and Authorization for which the Network Slice-Specific Authentication and Authorization succeeds.

Once completed the Network Slice-Specific Authentication and Authorization procedure, if the AMF determines that no S-NSSAI can be provided in the Allowed NSSAI for the UE, which is already authenticated and authorized successfully by a PLMN, and if no default S-NSSAI(s) could be further considered, the AMF shall execute the Network-initiated Deregistration procedure described in clause 4.2.2.3.3, and shall include in the explicit DeRegistration Request message the list of Rejected S-NSSAIs, each of them with the appropriate rejection cause value.

The mobility related event notifications towards the NF consumers are triggered at the end of this procedure for cases as described in clause 4.15.4.

<4.2.2.2.3 Registration with AMF re-allocation>

When an AMF receives a Registration request, the AMF may need to reroute the Registration request to another AMF, e.g. when the initial AMF is not the appropriate AMF to serve the UE. The Registration with AMF re-allocation procedure, described in FIG. 4.2.2.2.3-1, is used to reroute the NAS message of the UE to the target AMF during a Registration procedure.

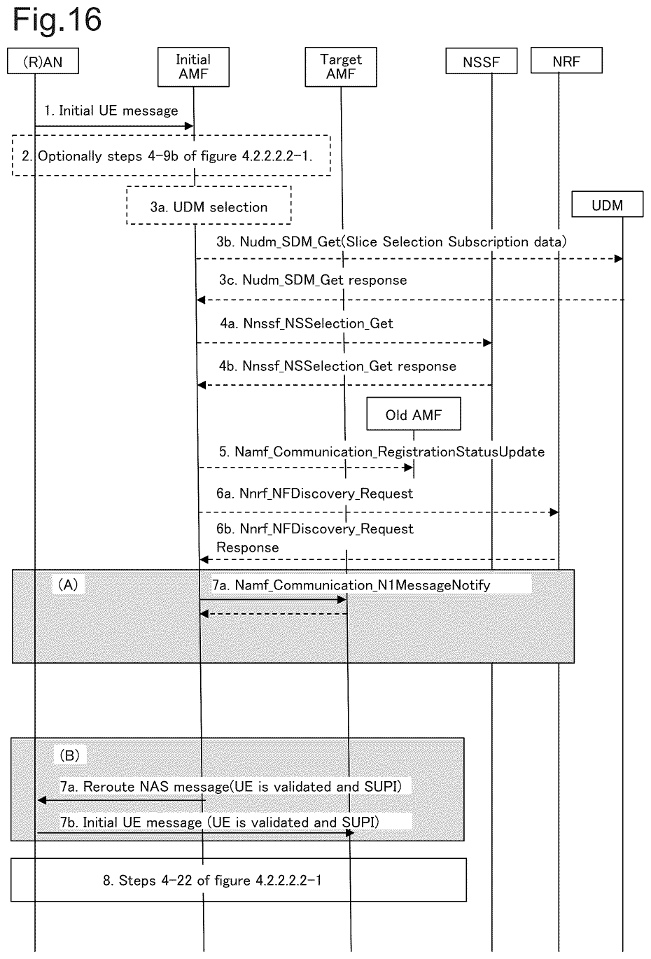

FIG. 4.2.2.2.3-1: Registration with AMF re-allocation procedure (See FIG. 16)

The initial AMF and the target AMF register their capability at the NRF.

1. Steps 1 and 2 of FIG. 4.2.2.2.2-1 have occurred, and the (R)AN sends the Registration request message within an Initial UE message to the initial AMF.

2. If the AMF needs the SUPI and/or UE's subscription information to decide whether to reroute the Registration Request or if the Registration Request was not sent integrity protected or integrity protection is indicated as failed, then AMF performs steps 4 to 9a or to 9b of FIG. 4.2.2.2.2-1.

3 a. [Conditional] If the initial AMF needs UE's subscription information to decide whether to reroute the Registration Request and UE's slice selection subscription information was not provided by old AMF, the AMF selects a UDM as described in clause 6.3.8 of TS 23.501 [2].

3 b. Initial AMF to UDM: Nudm_SDM_Get (SUPI, Slice Selection Subscription data).

The initial AMF request UE's Slice Selection Subscription data from UDM by invoking the Nudm_SDM_Get (see clause 5.2.3.3.1) service operation. UDM may get this information from UDR by Nudr_DM_Query (SUPI, Slice Selection Subscription data).

3c. UDM to initial AMF: Response to Nudm_SDM_Get. The AMF gets the Slice Selection Subscription data including Subscribed S-NSSAIs.

UDM responds with slice selection data to initial AMF.

Editor's note: It is FFS how the UDM provides applicable slice selection subscription data for Disaster Roaming service to the AMF, in the case of Disaster Roaming Registration.

4 a. [Conditional] Initial AMF to NSSF: Nnssf_NSSelection_Get (Requested NSSAI, [Mapping Of Requested NSSAI], Subscribed S-NSSAI(s) with the default S-NSSAI indication, [NSSRG Information], TAI, Allowed NSSAI for the other access type (if any), [Mapping of Allowed NSSAI], PLMN ID of the SUPI).

If there is a need for slice selection, (see clause 5.15.5.2.1 of TS 23.501 [2]), e.g. the initial AMF cannot serve all the S-NSSAI(s) from the Requested NSSAI permitted by the subscription information, the initial AMF invokes the Nnssf_NSSelection_Get service operation from the NSSF by including Requested NSSAI, optionally Mapping Of Requested NSSAI, Subscribed S-NSSAIs with the default S-NSSAI indication, [NSSRG Information], Allowed NSSAI for the other access type (if any), Mapping of Allowed NSSAI, PLMN ID of the SUPI and the TAI of the UE.

The AMF includes, if available, the NSSRG Information for the S-NSSAIs of the HPLMN, defined in clause 5.15.12 of TS 23.501 [2], including information whether the UE has indicated support of the subscription-based restrictions to simultaneous registration of network slices, and whether the UDM has indicated to provide all subscribed S-NSSAIs for non-supporting UEs.

4b. [Conditional] NSSF to Initial AMF: Response to Nnssf_NSSelection_Get (AMF Set or list of AMF addresses, Allowed NSSAI for the first access type, [Mapping Of Allowed NSSAI], [Allowed NSSAI for the second access type], [Mapping of Allowed NSSAI], [NSI ID(s)], [NRF(s)], [List of rejected (S-NSSAI(s), cause value(s))], [Configured NSSAI for the Serving PLMN], [Mapping Of Configured NSSAI]).

The NSSF performs the steps specified in point (B) in clause 5.15.5.2.1 of TS 23.501 [2]. The NSSF returns to initial AMF the Allowed NSSAI for the first access type, optionally the Mapping Of Allowed NSSAI, the Allowed NSSAI for the second access type (if any), optionally the Mapping of Allowed NSSAI and the target AMF Set or, based on configuration, the list of candidate AMF(s). The NSSF may return NSI ID(s) associated to the Network Slice instance(s) corresponding to certain S-NSSAI(s). The NSSF may return the NRF(s) to be used to select NFs/services within the selected Network Slice instance(s). It may return also information regarding rejection causes for S-NSSAI(s) not included in the Allowed NSSAI. The NSSF may return Configured NSSAI for the Serving PLMN, and possibly the associated mapping of the Configured NSSAI. If the NSSRG information was included in the request, the NSSF provides the Configured NSSAI as described in clause 5.15.12 of TS 23.501 [2].

NOTE 1: The NRF(s) returned by the NSSF, if any, belong to any level of NRF (see clause 6.2.6 of TS 23.501 [2]) according to the deployment decision of the operator.

5. [Conditional] Initial AMF to old AMF: Namf_Communication_RegistrationStatus Update (failure cause).

If another AMF is selected, the initial AMF sends a reject indication to the old AMF telling that the UE Registration procedure did not fully complete at the initial AMF. The old AMF continues as if the Namf_Communication_UEContextTransfer had never been received.

6a. [Conditional] Initial AMF to NRF: Nnrf_NFDiscovery_Request (NF type, AMF Set).

If the initial AMF does not locally store the target AMF address, and if the initial AMF intends to use direct reroute to target AMF or the reroute via (NG-R) AN message needs to include AMF address, then the initial AMF invokes the Nnrf_NFDiscovery_Request service operation from the NRF to find a proper target AMF which has required NF capabilities to serve the UE. The NF type is set to AMF. The AMF Set is included in the Nnrf_NFDiscovery_Request.

6b. [Conditional] NRF to AMF: Response to Nnrf_NFDiscovery_Request (list of (AMF pointer, AMF address, plus additional selection rules and NF capabilities)).

The NRF replies with the list of potential target AMF(s). The NRF may also provide the details of the services offered by the candidate AMF(s) along with the notification end-point for each type of notification service that the selected AMF had registered with the NRF, if available. As an alternative, it provides a list of potential target AMFs and their capabilities, and optionally, additional selection rules. Based on the information about registered NFs and required capabilities, a target AMF is selected by the initial AMF.

If the security association has been established between the UE and initial AMF, to avoid a registration failure, the initial AMF shall forward the NAS message to the target AMF by executing step 7 (A).

NOTE 2: The security context in the initial AMF is not transferred to the target AMF if initial AMF forward the NAS message to the target AMF via (R)AN. In this case the UE rejects the NAS message sent from target AMF as the security context in the UE and target AMF are not synchronized.

NOTE 3: Network slice isolation cannot be completely maintained in case the AMF reallocation is executed by step 7 (A).

If the initial AMF is not part of the target AMF Set, and is not able to get a list of candidate AMF(s) by querying the NRF with the target AMF Set (e.g. the NRF locally pre-configured on AMF does not provide the requested information, the query to the appropriate NRF provided by the NSSF is not successful, or the initial AMF has knowledge that the initial AMF is not authorized as serving AMF etc.) then the initial AMF shall forward the NAS message to the target AMF via (R)AN executing step 7 (B) unless the security association has been established between the UE and initial AMF: the Allowed NSSAI and the AMF Set are included to enable the (R)AN to select the target AMF as described in clause 6.3.5 of TS 23.501 [2].

7 (A). If the initial AMF, based on local policy and subscription information, decides to forward the NAS message to the target AMF directly, the initial AMF invokes the Namf_Communication_NIMessageNotify to the target AMF, carrying the rerouted NAS message. The Namf_Communication_NlMessageNotify service operation includes AN access information (e.g. the information enabling (R)AN to identify the N2 terminating point, CAG Identifier(s) of the CAG cell) and the full Registration Request message, and the UE's SUPI, information element indicating the UE is validated and MM Context if available. If the initial AMF has obtained the information from the NSSF as described at step 4b, that information except the AMF Set or list of AMF addresses is included. The target AMF then updates the (R)AN with a new updated N2 termination point for the UE in the first message from target AMF to RAN in step 8.

7 (B). If the initial AMF, based on local policy and subscription information, decides to forward the NAS message to the target AMF via (R)AN unless the target AMF(s) are returned from the NSSF and identified by a list of candidate AMF(s), the initial AMF sends a Reroute NAS message to the (R)AN (step 7a). The Reroute NAS message includes the information about the target AMF, and the full Registration Request message. If the initial AMF has received the MM context from the old AMF or SUPI without MM context, in step 2 as the old AMF successfully checked the integrity of the registration request message or the authentication procedure is successfully performed in step 2, the initial AMF includes SUPI and an information element indicating the UE is validated If the initial AMF has obtained the information as described at step 4b. If the initial AMF has obtained the information as described at step 4b, that information is included. The (R)AN sends the Initial UE message to the target AMF (step 7b) indicating reroute due to slicing including the information from step 4b that the NSSF provided. The (R)AN also includes SUPI and the information element indicating the UE is validated and other received information elements in the reroute NAS message to the initial NAS message.

8. If the target AMF receives the SUPI and the information element indicating the UE is validated, the target AMF sends SUPI and the information element indicating the UE is validated to the old AMF in the Namf_Communication_UEContextTransfer message. Upon receiving the Namf_Communication_UEContextTransfer message with SUPI and the information element indicating the UE is validated the old AMF sends the UE context to the target AMF in the Namf_Communication_UEContextTransfer.response message without performing the integrity check If the target AMF does not receive SUPI and the information element indicating the UE is validated thenAfter receiving the Registration Request message transmitted at step 7 (A) a or step 7 (B) b, the target AMF continues with the Registration procedure from step 4 until 22 of FIG. 4.2.2.2. 2-1 (with the target AMF corresponding to the new AMF), which includes the UE context retrieved from old AMF. If the 5G security context is received from the initial AMF, the target AMF continue using that one instead of the 5G security context retrieved from old AMF. If the initial AMF decides to forward the NAS message to the target AMF (step 7 (A), the first message from the target AMF to (R)AN (either Initial Context Setup Request, or Downlink NAS Transport) contain the AMF name of the initial AMF and target AMF UE NGAP ID.

As will be appreciated by one of skill in the art, the present disclosure may be embodied as a method, and system. Accordingly, the present disclosure may take the form of an entirely hardware embodiment, a software embodiment or an embodiment combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

The whole or part of the example Aspects disclosed above can be described as, but not limited to, the following supplementary notes.

supplementary note 1. A method of a non-geographically selected Access and Mobility Management Function (AMF) apparatus, the method comprising:
receiving an Namf_Communication_UEContextTransfer message from a geographically selected AMF apparatus,
wherein the Namf_Communication_UEContextTransfer message includes a registration request message and information indicating access type which is set to 3rd Generation Partnership Project (3GPP) access; and
performing an integrity check for the registration request message based on a Non-Access-Stratum (NAS) security context for non-3GPP access in a case where the Namf_Communication_UEContextTransfer message includes the information.
supplementary note 2. The method according to supplementary note 1, further comprising:
sending an Namf_Communication_UEContextTransfer response message to the geographically selected AMF in a case where the non-geographically selected AMF apparatus performs the integrity check successfully.
supplementary note 3. A method of a geographically selected Access and Mobility Management Function (AMF) apparatus, the method comprising:
receiving a registration request message,
wherein the registration request message includes information indicating that the registration request message is integrity protected based on a Non-Access-Stratum (NAS) security context for non-3rd Generation Partnership Project (3GPP) access; and
sending an Namf_Communication_UEContextTransfer message to a non-geographically selected AMF apparatus,
wherein the Namf_Communication_UEContextTransfer message includes the information.
supplementary note 4. A method of a geographically selected Access and Mobility Management Function (AMF) apparatus, the method comprising:
receiving a registration request message,
wherein the registration request message includes first information indicating that the registration request message is integrity protected based on a Non-Access-Stratum (NAS) security context for non-3rd Generation Partnership Project (3GPP) access and second information indicating whether registration over 3GPP access is preferred or a registration over the non-3GPP access is preferred;
sending an Namf_Communication_UEContextTransfer message to a non-geographically selected AMF apparatus;
receiving an Namf_Communication_UEContextTransfer response message from the non-geographically selected AMF apparatus,
wherein the Namf_Communication_UEContextTransfer response message includes third information indicating that a User Equipment (UE) context related to the non-3GPP access cannot be transferred or a Non-3GPP Inter Working Function (N3IWF) can only establish a connection with the non-geographically selected AMF apparatus;
sending a registration accept message in a case where the second information indicates that the registration over the 3GPP access is preferred,
wherein the registration accept message includes fourth information indicating that the geographically selected AMF apparatus is unable to simultaneously register a UE for the 3GPP access and the non-3GPP access; and
sending a registration reject message in a case where the second information indicates that the registration over the non-3GPP access is preferred,
wherein the registration reject message includes the fourth information.
supplementary note 5. A method of a user equipment (UE), the method comprising:
initiating a registration procedure; and
sending a registration request message,
wherein the registration request message includes first information indicating that the registration request message is integrity protected based on a Non-Access-Stratum (NAS) security context for non-3rd Generation Partnership Project (3GPP) access.
supplementary note 6. The method according to supplementary note 5, wherein the registration request message includes second information indicating whether registration over 3GPP access is preferred or a registration over the non-3GPP access is preferred.
supplementary note 7. The method according to supplementary note 6, further comprising:
receiving a registration accept message in a case where the second information indicates that the registration over the 3GPP access is preferred,
wherein the registration accept message includes third information indicating that a geographically selected AMF apparatus is unable to simultaneously register a UE for the 3GPP access and the non-3GPP access; and
receiving a registration reject message in a case where the second information indicates that the registration over the non-3GPP access is preferred,
wherein the registration reject message includes third information.
supplementary note 8. A method of a non-geographically selected Access and Mobility Management Function (AMF) apparatus, the method comprising:
receiving an Namf_Communication_UEContextTransfer message from a geographically selected AMF apparatus,
wherein the Namf_Communication_UEContextTransfer message includes a registration request message and information indicating access type which is set to 3rd Generation Partnership Project (3GPP) access:
performing an integrity check for the registration request message based on a Non-Access-Stratum (NAS) security context for non-3GPP access in a case where the Namf_Communication_UEContextTransfer message includes the information; and
sending an Namf_Communication_UEContextTransfer response message to the geographically selected AMF apparatus in a case where the non-geographically selected AMF apparatus performs the integrity check successfully and the non-geographically selected AMF apparatus determines that a Non-3GPP InterWorking Function (N3IWF) is connected to the non-geographically selected AMF apparatus only,
wherein the Namf_Communication_UEContextTransfer response message includes information indicating that a User Equipment (UE) context related to the non-3GPP access cannot be transferred or the N3IWF can only establish a connection with the non-geographically selected AMF apparatus.
supplementary note 9. A non-geographically selected Access and Mobility Management Function (AMF) apparatus comprising:
means for receiving an message from a Namf_Communication_UEContextTransfer geographically selected AMF apparatus,
wherein the Namf_Communication_UEContextTransfer message includes a registration request message and information indicating access type which is set to 3rd Generation Partnership Project (3GPP) access; and
means for performing an integrity check for the registration request message based on a Non-Access-Stratum (NAS) security context for non-3GPP in access a case where the Namf_Communication_UEContextTransfer message includes the information.
supplementary note 10. The non-geographically selected AMF apparatus according to supplementary note 9, further comprising:
means for sending an Namf_Communication_UEContextTransfer response message to the geographically selected AMF in a case where the non-geographically selected AMF apparatus performs the integrity check successfully.
supplementary note 11. A geographically selected Access and Mobility Management Function (AMF) apparatus comprising:
means for receiving a registration request message,
wherein the registration request message includes information indicating that the registration request message is integrity protected based on a Non-Access-Stratum (NAS) security context for non-3rd Generation Partnership Project (3GPP) access; and
means for sending an Namf_Communication_UEContextTransfer message to a non-geographically selected AMF apparatus,
wherein the Namf_Communication_UEContextTransfer message includes the information.
supplementary note 12. A geographically selected Access and Mobility Management Function (AMF) apparatus comprising:
means for receiving a registration request message,
wherein the registration request message includes first information indicating that the registration request message is integrity protected based on a Non-Access-Stratum (NAS) security context for non-3rd Generation Partnership Project (3GPP) access and second information indicating whether registration over 3GPP access is preferred or a registration over the non-3GPP access is preferred;
means for sending an Namf_Communication_UEContextTransfer message to a non-geographically selected AMF apparatus;
means for receiving an Namf_Communication_UEContextTransfer response message from the non-geographically selected AMF apparatus,
wherein the Namf_Communication_UEContextTransfer response message includes third information indicating that a User Equipment (UE) context related to the non-3GPP access cannot be transferred or a Non-3GPP Inter Working Function (N3IWF) can only establish a connection with the non-geographically selected AMF apparatus;
means for sending a registration accept message in a case where the second information indicates that the registration over the 3GPP access is preferred,
wherein the registration accept message includes fourth information indicating that the geographically selected AMF apparatus is unable to simultaneously register a UE for the 3GPP access and the non-3GPP access; and
means for sending a registration reject message in a case where the second information indicates that the registration over the non-3GPP access is preferred,
wherein the registration reject message includes the fourth information.
supplementary note 13. A user equipment (UE) comprising:
means for initiating a registration procedure; and
means for sending a registration request message,
wherein the registration request message includes first information indicating that the registration request message is integrity protected based on a Non-Access-Stratum (NAS) security context for non-3rd Generation Partnership Project (3GPP) access.
supplementary note 14. The UE according to supplementary note 13,
wherein the registration request message includes second information indicating whether registration over 3GPP access is preferred or a registration over the non-3GPP access is preferred.
supplementary note 15. The UE according to supplementary note 14, further comprising:
means for receiving a registration accept message in a case where the second information indicates that the registration over the 3GPP access is preferred,
wherein the registration accept message includes third information indicating that a geographically selected AMF apparatus is unable to simultaneously register a UE for the 3GPP access and the non-3GPP access; and
means for receiving a registration reject message in a case where the second information indicates that the registration over the non-3GPP access is preferred,
wherein the registration reject message includes third information.
supplementary note 16. A non-geographically selected Access and Mobility Management Function (AMF) apparatus comprising:
means for receiving an Namf_Communication_UEContextTransfer message from a geographically selected AMF apparatus,
wherein the Namf_Communication_UEContextTransfer message includes a registration request message and information indicating access type which is set to 3rd Generation Partnership Project (3GPP) access;
means for performing an integrity check for the registration request message based on a Non-Access-Stratum (NAS) security context for the non-3GPP access in a case where the Namf_Communication_UEContextTransfer message includes the information; and
means for sending an Namf_Communication_UEContextTransfer response message to the geographically selected AMF apparatus in a case where the non-geographically selected AMF apparatus performs the integrity check successfully and the non-geographically selected AMF apparatus determines that a Non-3GPP InterWorking Function (N3IWF) is connected to the non-geographically selected AMF apparatus only,
wherein the Namf_Communication_UEContextTransfer response message includes information indicating that a User Equipment (UE) context related to the non-3GPP access cannot be transferred or the N3IWF can only establish a connection with the non-geographically selected AMF apparatus.
supplementary note 17. A method of a non-geographically selected core network apparatus comprising:
receiving, from a geographically selected core network apparatus, a first message including access type information indicating first access:
performing, an integrity check by using Network Access Stratum (NAS) security context for the first access; and
sending, to the geographically selected core network apparatus, a second message corresponds to the first message, wherein the access type information indicating the first access is sent, from a communication terminal registered to the non-geographically selected core network apparatus over second access, to a base station.
supplementary note 18. A method of a geographically selected core network apparatus comprising:
communicating with a communication terminal which initiates, over first access, a registration procedure:
receiving, from the communication terminal, a third message indicating priority of access type between the first access type and second access type used by the communication terminal:
sending, to a non-geographically selected core network apparatus, a fourth message indicating the first access type to initiate integrity check related to the first access:
receiving, from the non-geographically selected core network apparatus, a fifth message indicating the geographically selected core network apparatus cannot be connected with an interface for the non-geographically selected core network apparatus or a second access context cannot be transferred; and
performing at least one of registration procedure over the first access and registration procedure over the second access based on at least one of operator-policy, user subscription, and information related to the third message.
supplementary note 19. The method according to supplementary note 18 comprising:
sending, to the communication terminal, sixth message indicating the communication terminal cannot be registered for the first access and the second access simultaneously, wherein the communication terminal considers the communication terminal is registered to the first access based on the sixth message.
supplementary note 20. The method according to supplementary note 18 comprising:
sending, to the communication terminal, a seventh message indicating the communication terminal cannot be registered for the first access and the second access simultaneously, wherein the communication terminal considers the communication terminal is registered to the second access based on the seventh message.
supplementary note 21. A method of a core network apparatus comprising:
communicating with a communication terminal; and
sending, to a base station, eighth message indicating the communication terminal is validated to send a ninth message from the communication terminal to another core network apparatus.
supplementary note 22. A method of a core network apparatus comprising:
sending an Namf_Communication_UEContextTransfer message;
receiving an Namf_Communication_UEContextTransfer response message; and
sending a message,
wherein the message includes information indicating that a User Equipment is validated.
supplementary note 23. A method of a first core network apparatus comprising:
receiving a message from a second core network apparatus,
wherein the message includes information indicating that a User Equipment is validated; and
sending the information to third core network apparatus.
supplementary note 24. A method of a first core network apparatus comprising:
receiving information indicating that a User Equipment (UE) is validated; and
sending a UE context for the UE without performing an integrity check of a registration request message for the UE.
supplementary note 25. A method of a User Equipment (UE), the method comprising:
initiating registration procedure; and
sending a registration request message,
wherein the registration request message includes first 5G Globally Unique Temporary Identifier (5G-GUTI), a first Non-Access-Stratum (NAS) container, second 5G-GUTI, and a second NAS container,
wherein the first NAS container includes a first integrity protected registration request message,
wherein the first integrity protected registration request message is the registration request message which is integrity protected based on a first NAS security context,
wherein the second NAS container includes a second integrity protected registration request message, and
wherein the second integrity protected registration request message is the registration request message which is integrity protected based on a second NAS security context.
supplementary note 26. A method of a geographically selected Access and Mobility Management Function (AMF) apparatus, the method comprising:
receiving a registration request message,
wherein the registration request message includes first 5G Globally Unique Temporary Identifier (5G-GUTI), a first Non-Access-Stratum (NAS) container, second 5G-GUTI, and a second NAS container,
wherein the first NAS container includes a first integrity protected registration request message which is integrity protected based on a first NAS security context, and
wherein the second NAS container includes a second integrity protected registration request message which is integrity protected based on a second NAS security context;
sending a first Namf_Communication_UEContextTransfer message,
wherein the first Namf_Communication_UEContextTransfer message includes the first 5G-GUTI and the first integrity protected registration request message;
receiving a first Namf_Communication_UEContextTransfer response message,
wherein the first Namf_Communication_UEContextTransfer response message includes a first User Equipment (UE) context related to the first 5G-GUTI;
sending a second Namf_Communication_UEContextTransfer message,
wherein the second Namf_Communication_UEContextTransfer message includes the second 5G-GUTI and the second integrity protected registration request message; and
receiving a second Namf_Communication_UEContextTransfer response message,
wherein the second Namf_Communication_UEContextTransfer response message includes a second UE context related to the second 5G-GUTI.
supplementary note 27. A User Equipment (UE) comprising:
means for initiating registration procedure; and
means for sending a registration request message,
wherein the registration request message includes first 5G Globally Unique Temporary Identifier (5G-GUTI), a first Non-Access-Stratum (NAS) container, second 5G-GUTI, and a second NAS container,
wherein the first NAS container includes a first integrity protected registration request message,
wherein the first integrity protected registration request message is the registration request message which is integrity protected based on a first NAS security context,
wherein the second NAS container includes a second integrity protected registration request message, and
wherein the second integrity protected registration request message is the registration request message which is integrity protected based on a second NAS security context.
supplementary note 28. A geographically selected Access and Mobility Management Function (AMF) apparatus comprising:
means for receiving a registration request message,
wherein the registration request message includes first 5G Globally Unique Temporary Identifier (5G-GUTI), a first Non-Access-Stratum (NAS) container, second 5G-GUTI, and a second NAS container,
wherein the first NAS container includes a first integrity protected registration request message which is integrity protected based on a first NAS security context, and
wherein the second NAS container includes a second integrity protected registration request message which is integrity protected based on a second NAS security context;
means for sending a first Namf_Communication_UEContextTransfer message,
wherein the first Namf_Communication_UEContextTransfer message includes the first 5G-GUTI and the first integrity protected registration request message;
means for receiving a first Namf_Communication_UEContextTransfer response message,
wherein the first Namf_Communication_UEContextTransfer response message includes a first User Equipment (UE) context related to the first 5G-GUTI;
means for sending a second Namf_Communication_UEContextTransfer message,
wherein the second Namf_Communication_UEContextTransfer message includes the second 5G-GUTI and the second integrity protected registration request message; and
means for receiving a second Namf_Communication_UEContextTransfer response message,
wherein the second Namf_Communication_UEContextTransfer response message includes a second UE context related to the second 5G-GUTI.
supplementary note 29. A method of a communication terminal comprising:
registering to first access in a first Public Land Mobile Network (PLMN);
storing a first temporary identifier and a first Network Access Stratum (NAS) container for the first access related to a first core network apparatus in the first PLMN;
registering to a second PLMN over second access;
registering to the second PLMN over first access after the registration to the second PLMN over the second access,
storing a second temporary identifier and a second NAS container for the second access related to a geographically selected core network apparatus in the second PLMN; and
sending, to the geographically selected core network apparatus, the first temporary identifier, the first NAS container, the second temporary identifier, and the second NAS container.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Indian provisional patent application No. 20/211,1048128, filed on Oct. 22, 2021, the disclosure of which is incorporated herein in its entirety by reference.

### REFERENCE SIGNS LIST

1 telecommunication system
3 UE
5 (R)AN node
7 core network
20 data network
31 transceiver circuit
32 antenna
33 controller
34 user interface
35 USIM
36 memory
51 transceiver circuit
52 antenna
53 network interface
54 controller
55 memory
60 RU
61 DU
62 CU
70 AMF
71 SMF
72 UPF
73 PCF
74 NEF
75 UDM
76 NWDAF
361 operating system
362 communications control module
551 operating system
552 communications control module
601 transceiver circuit
602 antenna
603 network interface
604 controller
605 memory
611 transceiver circuit
612 network interface
613 controller
614 memory
621 transceiver circuit
622 network interface
623 controller
624 memory
701 transceiver circuit
702 network interface
703 controller
704 memory
751 transceiver circuit
752 network interface
753 controller
754 memory
3621 transceiver control module
5521 transceiver control module
6051 operating system
6052 communications control module
6141 operating system
6142 communications control module
6241 operating system
6242 communications control module
7041 operating system
7042 communications control module
7541 operating system
7542 communications control module
60521 transceiver control module
61421 transceiver control module
62421 transceiver control module
70421 transceiver control module
75421 transceiver control module

1. A method of a User Equipment (UE), the method comprising:
initiating registration procedure; and
sending a registration request message,
wherein the registration request message includes first 5G Globally Unique Temporary Identifier (5G-GUTI), a first Non-Access-Stratum (NAS) container, second 5G-GUTI, and a second NAS container,
wherein the first NAS container includes a first integrity protected registration request message,
wherein the first integrity protected registration request message is the registration request message which is integrity protected based on a first NAS security context,
wherein the second NAS container includes a second integrity protected registration request message, and
wherein the second integrity protected registration request message is the registration request message which is integrity protected based on a second NAS security context.

2. A method of a geographically selected Access and Mobility Management Function (AMF) apparatus, the method comprising:
receiving a registration request message,
wherein the registration request message includes first 5G Globally Unique Temporary Identifier (5G-GUTI), a first Non-Access-Stratum (NAS) container, second 5G-GUTI, and a second NAS container,
wherein the first NAS container includes a first integrity protected registration request message which is integrity protected based on a first NAS security context, and
wherein the second NAS container includes a second integrity protected registration request message which is integrity protected based on a second NAS security context;
sending a first Namf_Communication_UEContextTransfer message,
wherein the first Namf_Communication_UEContextTransfer message includes the first 5G-GUTI and the first integrity protected registration request message;
receiving a first Namf_Communication_UEContextTransfer response message,
wherein the first Namf_Communication_UEContextTransfer response message includes a first User Equipment (UE) context related to the first 5G-GUTI;
sending a second Namf_Communication_UEContextTransfer message,
wherein the second Namf_Communication_UEContextTransfer message includes the second 5G-GUTI and the second integrity protected registration request message; and
receiving a second Namf_Communication_UEContextTransfer response message,
wherein the second Namf_Communication_UEContextTransfer response message includes a second UE context related to the second 5G-GUTI.

3. A User Equipment (UE) comprising:
means for initiating registration procedure; and
means for sending a registration request message,
wherein the registration request message includes first 5G Globally Unique Temporary Identifier (5G-GUTI), a first Non-Access-Stratum (NAS) container, second 5G-GUTI, and a second NAS container,
wherein the first NAS container includes a first integrity protected registration request message,
wherein the first integrity protected registration request message is the registration request message which is integrity protected based on a first NAS security context,
wherein the second NAS container includes a second integrity protected registration request message, and
wherein the second integrity protected registration request message is the registration request message which is integrity protected based on a second NAS security context.

4. A geographically selected Access and Mobility Management Function (AMF) apparatus comprising:
means for receiving a registration request message,
wherein the registration request message includes first 5G Globally Unique Temporary Identifier (5G-GUTI), a first Non-Access-Stratum (NAS) container, second 5G-GUTI, and a second NAS container,
wherein the first NAS container includes a first integrity protected registration request message which is integrity protected based on a first NAS security context, and
wherein the second NAS container includes a second integrity protected registration request message which is integrity protected based on a second NAS security context;
means for sending a first Namf_Communication_UEContextTransfer message,
wherein the first Namf_Communication_UEContextTransfer message includes the first 5G-GUTI and the first integrity protected registration request message;
means for receiving a first Namf_Communication_UEContextTransfer response message,
wherein the first Namf_Communication_UEContextTransfer response message includes a first User Equipment (UE) context related to the first 5G-GUTI;
means for sending a second Namf_Communication_UEContextTransfer message,
wherein the second Namf_Communication_UEContextTransfer message includes the second 5G-GUTI and the second integrity protected registration request message; and
means for receiving a second Namf_Communication_UEContextTransfer response message,
wherein the second Namf_Communication_UEContextTransfer response message includes a second UE context related to the second 5G-GUTI.

5. A method of a communication terminal comprising:
registering to first access in a first Public Land Mobile Network (PLMN);
storing a first temporary identifier and a first Network Access Stratum (NAS) container for the first access related to a first core network apparatus in the first PLMN;
registering to a second PLMN over second access;
registering to the second PLMN over first access after the registration to the second PLMN over the second access;
storing a second temporary identifier and a second NAS container for the second access related to a geographically selected core network apparatus in the second PLMN; and
sending, to the geographically selected core network apparatus, the first temporary identifier, the first NAS container, the second temporary identifier, and the second NAS container.
